(19) United States
(12) Patent Application Publication
(10) Pub. No.: US 2012/0288322 A1
(43) Pub. Date: Nov. 15, 2012

(54) BINDING DEVICE

(75) Inventors: Kanji Tanaka, Osaka (JP); Yoshiteru Arimoto, Osaka (JP); Hiroyuki Yamashita, Osaka (JP)

(73) Assignee: Lihit Lab, Inc., Osaka-shi (JP)

(21) Appl. No.: 13/513,571

(22) PCT Filed: Aug. 24, 2011
(86) PCT No.: PCT/JP2011/069080

§ 371 Date: Jun. 1, 2012

(30) Foreign Application Priority Data
Feb. 21, 2011 (JP) 2011-034960

(51) Int. Cl. B42F 13/26

(52) U.S. Cl. 402/30

(57) ABSTRACT

[Object] To provide a binding device having binding rods easily opened and closed for easy leaf replacement.

[Means for Settlement] A binding device 10 according to the present invention comprising: a plurality of binding rod portions 12, a connecting region for connecting the plurality of binding rod portions, and an pivot coupling portion 16 serving as the center for opening/closing of binding rods 20 and 30 composing the binding rod portions; wherein the binding rods composing the binding rod portions are provided to project from the pair of connecting regions with an appropriate interval therebetween in a longitudinal direction thereof so that the binding rods of each pair are opposed to each other; a pressing portion(s) 140 is provided to project from the region(s) of one end or both ends of the extending direction of the center for opening/closing the binding rods; and the pressing portion is configured to displace the plurality of opposed binding rods of one side among the binding rods to the extending direction of the center in order to disengage the binding rods of the one side from latching portions of the plurality of opposing binding rods of another side.

### TECHNICAL FIELD

The present invention relates to a binding device for filing, and in particular to a binding device used as, for example, a plastic ring type notebook or a file, a binder, or the like for binding a leaf with binding holes.

### BACKGROUND ART

Conventionally, a notebook that binds a leaf with holes by using a ring-shaped member can, along its ring shape, spread the leaf through 360 degrees, in other words, not only open the leaf but also flip over the leaf to lay its front side and its reverse side on each other, thus utilizing half a space utilized by a notebook openable through only 180 degrees. However, the plastic ring type notebook has a disadvantage that it does not permit leaf replacement.

On the other hand, a notebook with binding devices of Japanese Patent No. 3440356 and Japanese Utility Model Application Laid-Open Publication No. H7-17578, in other words, a notebook with openable/closable binding rod portions that bind a leaf permits leaf replacement.

### PATENT DOCUMENTS

Patent Document 1: Japanese Patent No. 3440356
Patent Document 2: Japanese Utility Model Application Laid-Open Publication No. H7-17578

### DISCLOSURE OF INVENTION

### Problems to be Solved by the Invention

However, the binding device of the patent document 1 (Japanese Patent No. 3440356) is a binding device composed of two main members (1) having a plurality of comb portions (2), wherein a slidable ring member (4) is provided at an end of the main member (1a) and inside of this ring member (4) has almost the same shape as or a slightly smaller shape than an outer shape obtained by integrating the main member (1a) and the main member (1b). For the leaf replacement, this binding device, upon fitting of fitting means provided at tips of the plurality of the comb portions after separating the two main members from each other, requires relatively many man-hours for fitting the many comb portions.

Moreover, the binding device of the patent document 2 (Japanese Utility Model Application Laid-Open Publication No. H7-17578) has a first member and a second member with a plurality of uprising binding loops, pivotably fitted together by a common axis line. Therefore, although the first member and the second member do not separate from each other, a bar-type coupling portion for coupling the plurality of binding loops is formed at base portions of the binding loops 15 and 17, and a protruding portion 23 is provided in such a manner as to project from an inner side surface of this coupling portion. Accordingly, for example, even upon attempt to place the binding device on a desk to open it, outsides of the base portions of the binding loops hit a desk surface and thus the binding loops are not fully opened, thus making it relatively difficult to take-in and take-out the leaf. Additionally, integral molding with synthetic resin is difficult since it results in a complicated structure of a manufacturing die.

Therefore, it is a main object of the present invention to provide a binding device easily manufactured and having binding rods easily opened and closed for easy leaf replacement.

### Means Adapted to Solve the Problems

A binding device according to the present invention is a binding device A binding device comprising: a plurality of binding rod portions, a connecting region for connecting the plurality of binding rod portions, and an pivot coupling region serving as the center for opening/closing of binding rods composing the binding rod portions; wherein the binding rods composing the binding rod portions are provided to project from the pair of connecting regions with an appropriate interval therebetween in a longitudinal direction thereof so that the binding rods of each pair are opposed to each other; a pressing portion(s) is provided to project from the region(s) of one end or both ends of the extending direction of the center for opening/closing the binding rods; and the pressing portion is configured to displace the plurality of opposed binding rods of one side among the binding rods to the extending direction of the center in order to disengage the binding rods of the one side from latching portions of the plurality of opposing binding rods of another side.

The binding device according to claim 2 of the present invention is the binding device according to claim 1, in which: the pressing portion is composed of: a push rod provided to project from a first binding rod and/or a second binding rod; a first connecting portion and/or a second connecting portion; a first bridge portion and/or a second bridge portion; or a region of an end portion of the pivot coupling region, the end portion being an end with respect to the center extending direction.

The binding device according to claim 3 of the present invention is the binding device according to claim 1 or claim 2, in which: the binding rod portion has the binding rod latching portion for latching when the binding rods are closed, the binding rod latching portion being formed at a free end of the binding rod in a side opposite to a base portion provided continuously to the connecting region and/or the pivot coupling region; the binding rod latching portions are formed so as to relatively move the binding rods, which are to be latched in a direction intersecting with a turning direction of the binding rods to be latched, and latch or disengage the binding rods; and the pressing portion(s) are provided to project from the binding rod and/or the connecting region and/or the pivot coupling region toward a side opposite to the direction of disengagement in the side opposite to the direction of relatively moving the binding rods and disengaging the binding rods.

The binding device according to claim 4 of the present invention is the binding device according to any of claim 1 to claim 3, in which: the pressing portion is configured to be pressed directly or indirectly with finger.

The binding device according to claim 5 of the present invention is the binding device according to any of claim 1 to claim 4, in which: the pivot coupling region has a shaft portion and a receiving portion of the shaft portion; the shaft portion extends in the longitudinal direction of the connecting region and couple the pair of connecting regions; the receiving portion extends in the longitudinal direction of the connecting region, is provided continuously to the binding rod portion and/or the connecting region, and has an aperture portion to be filled with the shaft portion, the aperture portion being formed in a side surface of the receiving portion; and the pressing portion(s) is provided to project from the region(s) of one end or both ends of the extending direction of the pivot coupling region.

The binding device according to claim 6 of the present invention is the binding device according to any of claim 1 to claim 4, in which: the connecting region is composed of the pivot coupling region and a bridge portion; the pivot coupling region includes a bearing portion coupling the binding rod portions and includes an pivot portion coupling the binding rod portions and serving as the center for opening/closing the binding rods composing the binding rod portion; the binding rods composing the binding rod portion project from outer portions or upper portions of the bearing portions and the pivot portions with appropriate intervals in the longitudinal direction of the bearing portions coupling the binding rod portions and the pivot portion so that the binding rods of each pair face each other; the bearing portion has a length extending in the direction orthogonal to the extending direction of the binding rod and a thickness continued in the extending direction of the binding rod, is bridged between the plurality of binding rods so as to be continued to the base portions of the binding rods and couple the plurality of binding rods, includes a side surface in which an aperture portion to be filled with the pivot portion is formed, and includes a bearing recess continued to the aperture portion and having an arc-shaped inner surface; the pivot portion has a length extending in the direction orthogonal to the extending direction of the binding rod and a thickness continued in the extending direction of the binding rod, has a longitudinally-continued outline which is partially arc-shaped, is bridged between the plurality of biding rods so as to be continued to the base portions of the binding rods and continued to the plurality of binding rods, and, in a region of the arc shape, swingably fits in a longitudinally-extending bearing recess of which inner surface from the aperture portion to the bearing portion is arc shaped; the pivot coupling region is configured to serve as the center of turning when tips of the binding rods are caused to meet with each other and closed and when the tips of the binding rods are separated from each other; and the pressing portion(s) is provided to project from the region(s) of one end or both ends of the extending direction of the pivot coupling region.

The binding device according to claim 7 of the present invention is the binding device according to claim 5, in which: a elastic member that applies tensile force or compressive force in the longitudinal direction of the shaft portion is fitted between a housing portion of the first receiving portion and the receiving portion of a second receiving portion and/or between the housing portion of the second receiving portion and the receiving portion of the first receiving portion.

The binding device according to claim 8 of the present invention is the binding device according to claim 6, in which: a elastic member that is compressed in and applies spring force in the longitudinal direction of the pivot coupling region is fitted between the housing portion of a first receiving portion provided to be continued to the base portion of the binding rod portion and a housing portion of a second receiving portion provided to be continued to the base portion of the binding rod portion; and the first receiving portion, the second receiving portion, and the elastic member are configured so as to serve as the center of turning when tips of the binding rods are caused to meet with each other and closed and when the tips of the binding rods are separated from each other.

The binding device according to claim 9 of the present invention is the binding device according to claim 7 or claim 8, in which: the elastic member is composed of a torsion coil spring and includes a coil portion, a linear first fixing tip portion, and a linear second fixing tip portion, the tip portions continuously provided to extend from both ends of the coil portion to a direction orthogonal to or intersecting with a central axis of the coil portion, the first fixing tip portion and the second fixing tip portion project to outside of the coil portion in an original state free from torsion moment; the first fixing tip portion of one side is supported by a support portion of the first connecting portion; the second fixing tip portion of another side is supported by a support portion of the second connecting portion so as to face the first fixing tip portion; and, when the binding rod latching portion of the first binding rod and the binding rod latching portion of the second binding rod latched with each other are to be disengaged from each other by pressing the pressing portion with finger, the first fixing tip portion is supported by the support portion of the first connecting portion in the side opposite to a moving direction, and the second fixing tip portion of the other side is supported by the support portion of the second connecting portion in the side opposite to the moving direction.

The binding device according to claim 10 of the present invention is the binding device according to claim 1 or claim 2, in which: the elastic member fits in the connecting region for connecting the plurality of binding rod portions; and the elastic member includes a coil portion.

The binding device according to claim 11 of the present invention is the binding device according to any of claim 1 to claim 10, in which: an attachment portion for attachment to a cover is provided to be continued to the binding rod and/or the connecting region and/or the receiving portion and/or the bearing portion.

### Effect of the Invention

According to claim 1 of the present invention, a binding device comprising: a plurality of binding rod portions, a connecting region for connecting the plurality of binding rod portions, and an pivot coupling region serving as the center for opening/closing of binding rods composing the binding rod portions; wherein the binding rods composing the binding rod portions are provided to project from the pair of connecting regions with an appropriate interval therebetween in a longitudinal direction thereof so that the binding rods of each pair are opposed to each other; a pressing portion(s) is provided to project from the region(s) of one end or both ends of the extending direction of the center for opening/closing the binding rods; and the pressing portion is configured to displace the plurality of opposed binding rods of one side among the binding rods to the extending direction of the center in order to disengage the binding rods of the one side from latching portions of the plurality of opposing binding rods of another side. Therefore, a binding device having binding rods easily opened and closed for easy leaf replacement can be provided.

According to claim 2 of the present invention, the pressing portion is composed of: a push rod provided to project from a first binding rod and/or a second binding rod; a first connecting portion and/or a first connecting portion; a first bridge portion and/or a second bridge portion; or a region of an end portion of the pivot coupling region, the end portion being an end with respect to the center extending direction. Therefore, the plurality of opposed binding rods of one side among the binding rods can disengage from latching portions of the plurality of opposing binding rods of another side by pressing the pressing portion with finger.

According to claim 3 of the present invention, the binding rod portion has the binding rod latching portion for latching when the binding rods are closed, the binding rod latching portion being formed at a free end of the binding rod in a side opposite to a base portion provided continuously to the connecting region and/or the pivot coupling region; the binding rod latching portions are formed so as to relatively move the binding rods, which are to be latched in a direction intersecting with a turning direction of the binding rods to be latched, and latch or disengage the binding rods; and the pressing portion(s) are provided to project from the binding rod and/or the connecting region and/or the pivot coupling region toward a side opposite to the direction of disengagement in the side opposite to the direction of relatively moving the binding rods and disengaging the binding rods. Therefore, the plurality of opposed binding rods of one side among the binding rods can disengage from latching portions of the plurality of opposing binding rods of another side by pressing the pressing portion with finger.

According to claim 4 of the present invention, the pressing portion is configured to be pressed directly or indirectly with finger. Therefore, the plurality of opposed binding rods of one side among the binding rods can disengage from latching portions of the plurality of opposing binding rods of another side by pressing the pressing portion with finger.

According to claim 5 of the present invention, the pivot coupling region has a shaft portion and a receiving portion of the shaft portion; the shaft portion extends in the longitudinal direction of the connecting region and couple the pair of connecting regions; the receiving portion extends in the longitudinal direction of the connecting region, is provided continuously to the binding rod portion and/or the connecting region, and has an aperture portion to be filled with the shaft portion, the aperture portion being formed in a side surface of the receiving portion; and the pressing portion(s) is provided to project from the region(s) of one end or both ends of the extending direction of the pivot coupling region. Therefore, the plurality of opposed binding rods of one side among the binding rods can disengage from latching portions of the plurality of opposing binding rods of another side by pressing the pressing portion with finger.

According to claim 6 of the present invention, the connecting region is composed of the pivot coupling region and a bridge portion; the pivot coupling region includes a bearing portion coupling the binding rod portions and includes an pivot portion coupling the binding rod portions and serving as the center for opening/closing the binding rods composing the binding rod portion; the binding rods composing the binding rod portion project from outer portions or upper portions of the bearing portions and the pivot portions with appropriate intervals in the longitudinal direction of the bearing portions coupling the binding rod portions and the pivot portion so that the binding rods of each pair face each other; the bearing portion has a length extending in the direction orthogonal to the extending direction of the binding rod and a thickness continued in the extending direction of the binding rod, is bridged between the plurality of binding rods so as to be continued to the base portions of the binding rods and couple the plurality of binding rods, includes a side surface in which an aperture portion to be filled with the pivot portion is formed, and includes a bearing recess continued to the aperture portion and having an arc-shaped inner surface; the pivot portion has a length extending in the direction orthogonal to the extending direction of the binding rod and a thickness continued in the extending direction of the binding rod, has a longitudinally-continued outline which is partially arc-shaped, is bridged between the plurality of biding rods so as to be continued to the base portions of the binding rods and continued to the plurality of binding rods, and, in a region of the arc shape, swingably fits in a longitudinally-extending bearing recess of which inner surface from the aperture portion to the bearing portion is arc shaped; the pivot coupling region is configured to serve as the center of turning when tips of the binding rods are caused to meet with each other and closed and when the tips of the binding rods are separated from each other; and the pressing portion(s) is provided to project from the region(s) of one end or both ends of the extending direction of the pivot coupling region. Therefore, the plurality of opposed binding rods of one side among the binding rods can disengage from latching portions of the plurality of opposing binding rods of another side by pressing the pressing portion with finger.

According to claim 7 of the present invention, a elastic member that applies tensile force or compressive force in the longitudinal direction of the shaft portion is fitted between a housing portion of the first receiving portion and the receiving portion of a second receiving portion and/or between the housing portion of the second receiving portion and the receiving portion of the first receiving portion. Therefore, the plurality of opposed binding rods of one side among the binding rods can disengage from latching portions of the plurality of opposing binding rods of another side by pressing the pressing portion with finger.

According to claim 8 of the present invention, a elastic member that is compressed in and applies spring force in the longitudinal direction of the pivot coupling region is fitted between the housing portion of a first receiving portion provided to be continued to the base portion of the binding rod portion and a housing portion of a second receiving portion provided to be continued to the base portion of the binding rod portion; and the first receiving portion, the second receiving portion, and the elastic member are configured so as to serve as the center of turning when tips of the binding rods are caused to meet with each other and closed and when the tips of the binding rods are separated from each other. Therefore, the binding rods can be opened and closed relatively easily and the binding rods can be closed surely.

According to claim 9 of the present invention, the elastic member is composed of a torsion coil spring and includes a coil portion, a linear first fixing tip portion, and a linear second fixing tip portion, the tip portions continuously provided to extend from both ends of the coil portion to a direction orthogonal to or intersecting with a central axis of the coil portion, the first fixing tip portion and the second fixing tip portion project to outside of the coil portion in an original state free from torsion moment; the first fixing tip portion of one side is supported by a support portion of the first connecting portion; the second fixing tip portion of another side is supported by a support portion of the second connecting portion so as to face the first fixing tip portion; and, when the binding rod latching portion of the first binding rod and the binding rod latching portion of the second binding rod latched with each other are to be disengaged from each other by pressing the pressing portion with finger, the first fixing tip portion is supported by the support portion of the first connecting portion in the side opposite to a moving direction, and the second fixing tip portion of the other side is supported by the support portion of the second connecting portion in the side opposite to the moving direction. Therefore, the binding rods can be opened and closed relatively easily and the binding rods can be closed surely.

According to claim 10 of the present invention, the elastic member fits in the connecting region for connecting the plurality of binding rod portions; and the elastic member includes a coil portion. Therefore, the binding rods can be opened and closed relatively easily and the binding rods can be closed surely.

According to claim 11 of the present invention, an attachment portion for attachment to a cover is provided to be continued to the binding rod and/or the connecting region and/or the receiving portion and/or the bearing portion. Therefore, a datebook, a file, binder, or the like, fixing the binding device to a front cover can be obtained.

The aforementioned object, other objects, features and advantages of the present invention will be more clarified from description of best modes for carrying out the invention provided below with reference to the drawings.

In this specification and a scope of claims, the leaf is a general term of bound objects, such as a sheet, a pocket of synthetic resin, a front cover, and the like.

### BRIEF DESCRIPTION OF DRAWINGS

FIG. 1 is a schematic perspective view of a notebook with a binding device according to the present invention.

FIG. 2 is a schematic perspective view of the binding device according to the present invention.

FIG. 3 is a schematic perspective view of the binding device according to the present invention, wherein (A) is an overall view, (B) is a partially enlarged view, and (C) and (D) are views of half rods.

FIG. 4 is a schematic perspective view of a first binding device member, wherein (A) is a right-side view, and (B) is a left-side view.

FIG. 5 is a schematic perspective view of a second binding device member, wherein (A) is a right-side view, and (B) is a left-side view.

FIG. 6A is a schematic perspective view of the binding device according to the present invention in a disassembled state.

FIG. 6B is a schematic perspective view showing another spring member in the state in which the spring member is attached to the first and second binding device members.

FIG. 6C is a schematic cross-sectional view of the binding device shown in FIG. 6B, wherein (A) is a schematic cross-sectional view showing a closed state, and (B) is a schematic cross-sectional view showing an opened state.

FIG. 6D is a schematic elevation view of further another elastic member.

FIG. 7 is a schematic elevation view of the binding device in a closed state.

FIG. 8 is a schematic back view of the binding device in the closed state.

FIG. 9 is a schematic cross-sectional view taken along line A-A of FIG. 7.

FIG. 10 is a schematic cross-sectional view taken along line B-B of FIG. 7.

FIG. 11 is a schematic elevation view of the binding device in an opening start state.

FIG. 12 is a schematic back view of the binding device in an opening start state.

FIG. 13 is a schematic elevation view of the binding device in an opened state.

FIG. 14 is a schematic back view of the binding device in the opened state.

FIG. 15 is a schematic cross-sectional view taken along line A-A of FIG. 13.

FIG. 16 is a schematic cross-sectional view taken along line B-B of FIG. 13.

FIG. 17 is a schematic plan view showing how to open leaves of a notebook, wherein (A) is a view in a closed state, (B) is a view in a half-flipped state, and (C) is a view in a 360-degree-flipped state.

FIG. 18 is a schematic perspective view showing a manner of opening the binding device according to the present invention.

FIG. 19 is a schematic plan view showing the manner of opening the binding device with a notebook using the binding device according to the present invention.

FIG. 20 is a schematic plan view showing the manner of opening the binding device with a notebook using the binding device according to the present invention.

FIG. 21 is a schematic perspective view of a notebook with a binding device according to the present invention.

FIG. 22 is a schematic perspective view of the binding device according to the present invention, wherein (A) is an overall view, and (B) is a partially enlarged view.

FIG. 23 is a schematic perspective view of the binding device according to the present invention, wherein (A) is an overall view, (B) is a partially enlarged view, and (C) and (D) are views of half rods.

FIG. 24 is a schematic perspective view of the binding device according to the present invention in a disassembled state.

FIG. 25 is a schematic cross-sectional view taken along line A-A of FIG. 7.

FIG. 26 is a schematic plan view showing how to open leaves of a notebook,

wherein (A) is a view in a closed state, (B) is a view in a half-flipped state, and (C) is a view in a 360-degree-flipped state.

FIG. 27 is a schematic perspective view of a disassembled state of a binding device of a modification example.

FIG. 28 is a schematic back view of the binding device in a closed state of the binding device shown in FIG. 27.

FIG. 29 is a schematic cross-sectional view of the binding device shown in FIG. 19, wherein (A) is a schematic cross-sectional view of a closed state, and (B) is a schematic cross-sectional view of an opened state.

FIG. 30 is a schematic perspective view of a datebook using a binding device according to the present invention.

FIG. 31A is a schematic perspective view of the entire binding device according to the present invention.

FIG. 31B is a schematic perspective view of the entire binding device according to the present invention.

FIG. 32 is a schematic perspective view of the binding device according to the present invention, wherein (A) is an overall view, and (B) and (C) are views of half rods.

FIG. 33 is a schematic perspective view of a first binding device member, wherein (A) is a right-side view, and (B) is a left-side view.

FIG. 34 is a schematic perspective view of a second binding device member, wherein (A) is a right-side view, and (B) is a left-side view.

FIG. 35 is a schematic perspective view of the binding device according to the present invention in a disassembled state.

FIG. 36 is a schematic perspective view showing a method of coupling the first binding device member and the second binding device member.

FIG. 37 is a schematic elevation view of the binding device in a closed state.

FIG. 38 is a schematic back view of the binding device in the closed state.

FIG. 39A is a partial schematic cross-sectional view taken along line A-A of FIG. 37.

FIG. 39B is a schematic cross-sectional view taken along line B-B of FIG. 37.

FIG. 39C is a schematic cross-sectional view taken along line C-C of FIG. 37.

FIG. 40 is a schematic elevation view of the binding device in an opening start state.

FIG. 41 is a schematic back view of the binding device in an opening start state.

FIG. 42A is a partial schematic cross-sectional view of A-A of FIG. 40.

FIG. 42B is a schematic cross-sectional view of B-B of FIG. 40.

FIG. 42C is a schematic cross-sectional view of C-C of FIG. 40.

FIG. 43 is a schematic plan view showing a manner of opening leaves of the datebook, wherein (A) is a view of a closed state, (B) is a view of a half-flipped state, and (C) is a view of 360-degree-flipped state.

FIG. 44A is a schematic view of a binding device which is a modification example of the embodiment shown in FIG. 1, wherein (1) is a schematic plan view, and (2) is a partially-cross-sectional schematic front view.

FIG. 44B is a schematic view of a binding device which is a modification example of the embodiment shown in FIG. 1, wherein (1) is a schematic plan view, and (2) is a partially-cross-sectional schematic front view.

FIG. 44C is a schematic view of a binding device which is a modification example of the embodiment shown in FIG. 1, wherein (1) is a schematic plan view, and (2) is a partially-cross-sectional schematic front view.

FIG. 44D is a schematic view of a binding device which is a modification example of the embodiment shown in FIG. 1, wherein (1) is a schematic plan view, and (2) is a partially-cross-sectional schematic front view.

FIG. 45 is a schematic view of the binding device which is the modification example of the embodiment shown in FIG. 1, wherein (A) is a schematic perspective view, and (B) is a schematic bottom surface view.

FIG. 46 is a schematic perspective view of a binding device which is a modification example of the binding device which is the embodiment shown in FIG. 21.

FIG. 47 is a schematic plan view of the binding device which is the modification example of the binding device which is the embodiment shown in FIG. 21.

FIG. 48 is a schematic plan view of the binding device which is the modification example of the binding device which is the embodiment shown in FIG. 21, wherein (A) is a view of the state in which binding rods are closed, and (B) is a view of the state in which the binding rods start opening.

FIG. 49 is a schematic elevation view of the binding device which is the modification example of the binding device which is the embodiment shown in FIG. 21.

FIG. 50 is a schematic elevation view of a binding device which is a modification example of the binding device which is the embodiment shown in FIG. 30.

FIG. 51 is an explanatory view of a binding device.

FIG. 52 is an explanatory view of a notebook, wherein (A) is an overall view, and (B) is a view of a leaf.

### DESCRIPTION OF REFERENCE NUMERALS

10 Binding device
12 Binding rod portion
14 Connecting portion
16 Pivot coupling portion
18A First binding device member
18B Second binding device member
20 First binding rod
30 Second binding rod
20a, 30a Base portion
20b, 30b Free end
20A, 30A Half rod
20h Fixing hole
22 Binding rod latching portion of the first binding rod
32 Binding rod latching portion of the second binding rod
24 First binding rod projection
34 Second binding rod projection
26 First binding rod recess
36 Second binding rod recess
28, 38 Disengagement preventing portion
28a, 38a Latching projection
28b, 38b Latching recess
50 First connecting portion
60 Second connecting portion
50a, 60a Support portion
56, 66 Opposing portion
56a, 66a Projection
52 First connecting portion outer portion
62 Second connecting portion outer portion
54 First connecting portion upper portion
64 Second connecting portion upper portion
56 First connecting portion opposing portion
66 Second connecting portion opposing portion
58 First connecting portion lower portion
68 Second connecting portion lower portion
70, 72 Aperture angle restricting portion
70a, 72a Contact surface
80 First receiving portion
90 Second receiving portion
82 First housing portion
92 Second housing portion
84, 94 Aperture portion
86, 96 Arc portion
100 Shaft portion
102 Elastic member
102a Coil portion
102b First fixing tip portion
102c Second fixing tip portion
110 Leaf
110a Leaf front side
110b Leaf reverse side
112 Binding hole
114 Binding margin side edge
140 Pressing portion
140p Fixing projection
142 First pressing portion
144 Second pressing portion
210 Binding device
212 Binding rod portion
214 Connecting portion
216 Pivot coupling portion
218A First binding device member
218B Second binding device member
220 First binding rod
230 Second binding rod
220a, 230a Base portion
220b, 230b Free end
220A, 230A Half rod
222 Binding rod latching portion of first binding rod
232 Binding rod latching portion of second binding rod
224 First binding rod projection
234 Second binding rod projection
226 First binding rod recess
236 Second binding rod recess
250a, 260a Support portion
228, 238 Disengagement preventing portion
228a, 238a Latching projection
228b, 238b Latching recess
250 First connecting portion
260 Second connecting portion
252 First connecting portion outer portion
262 Second connecting portion outer portion
254 First connecting portion upper portion
264 Second connecting portion upper portion
256 First connecting portion opposing portion
266 Second connecting portion opposing portion
258 First connecting portion lower portion
268 Second connecting portion lower portion
270, 272 Aperture angle restricting portion
270a, 272a Contact surface
280 First receiving portion
290 Second receiving portion
282 First housing portion
292 Second housing portion
284, 294 Aperture portion
286, 296 Arc portion
300 Shaft portion
302 Elastic member
302a Coil portion
302b First fixing tip portion
302c Second fixing tip portion
310 Leaf
310a Leaf front side
310b Leaf reverse side
312 Binding hole
314 Binding margin side edge
340 Pressing portion
342 First pressing portion
346 Operating portion
360 Attachment portion
362 Through hole
364 Grommet
410 Binding device
420A, 430A Half rod
412 Binding rod portion
414 Bearing portion
416 Pivot portion
418A First binding device member
418B Second binding device member
420 First binding rod
420a, 430a Base portion
420b Free end
422 Binding rod latching portion of first binding rod
424 First binding rod projection
426 First binding rod recess
428 Disengagement preventing portion
428a, 438a Latching projection
428b, 438b Latching recess
430 Second binding rod
430b Free end
432 Binding rod latching portion of second binding rod
434 Second binding rod projection
436 Second binding rod recess
438 Disengagement preventing portion
442 First bridge portion
442a, 444a Opposing portion
442b, 444b Contact surface
444 Second bridge portion
450 First bearing portion
450a Near-side first bearing portion
450b Intermediate first bearing portion
452, 462 Aperture portion
452a, 462a Contact surface
454, 464 Bearing recess
456, 466 Restricting recess
460 Second bearing portion
460a Far-side second bearing portion
460b Intermediate second bearing portion
470 First aperture angle restricting portion
472 Second aperture angle restricting portion
474 Shaft-portion turning restricting portion
476, 478 Projecting portion
480 First receiving portion
482 Housing portion
490 Second receiving portion
502 Elastic member
510 Leaf
512 Binding hole
520 First shaft portion
520a Far-side first shaft portion
520b Intermediate first shaft portion
530 Second shaft portion
530a Near-side second shaft portion
530b Intermediate second shaft portion
540 Pressing portion
542 First pressing portion
544 Second pressing portion
560 Attachment portion

### DESCRIPTION OF EMBODIMENTS

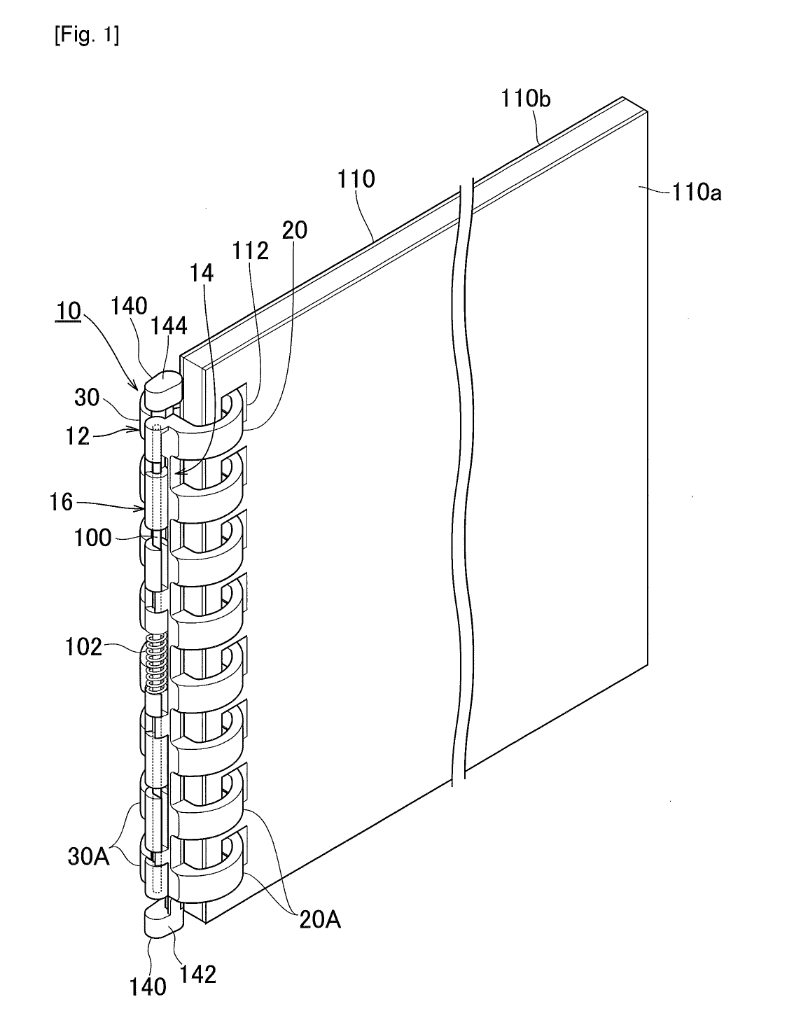

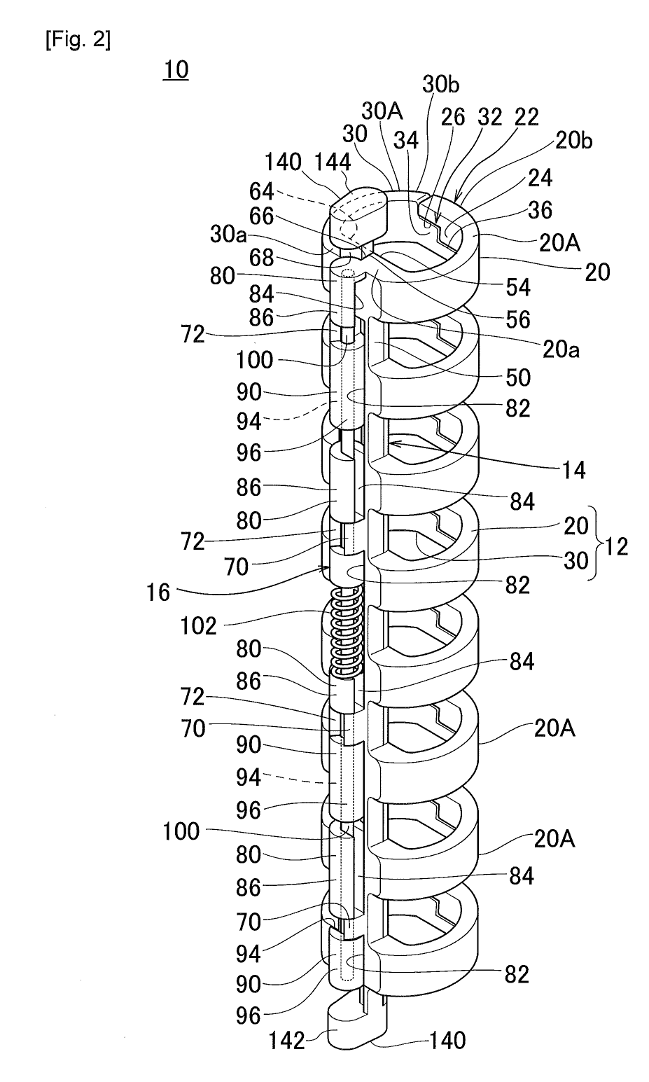

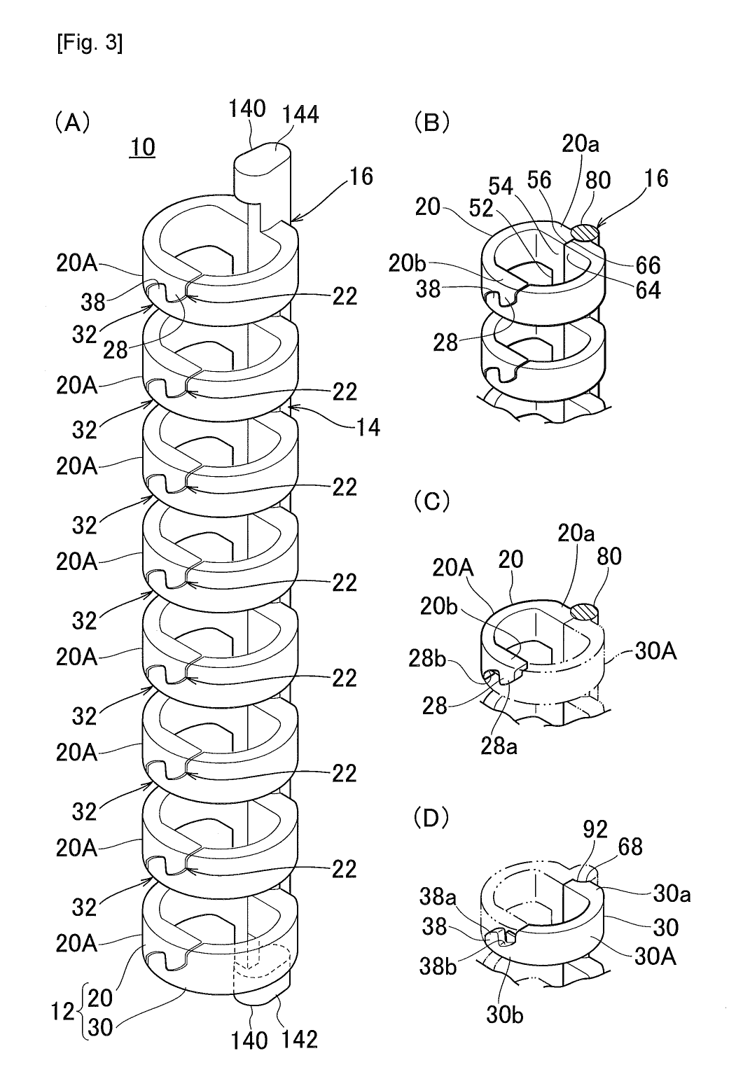

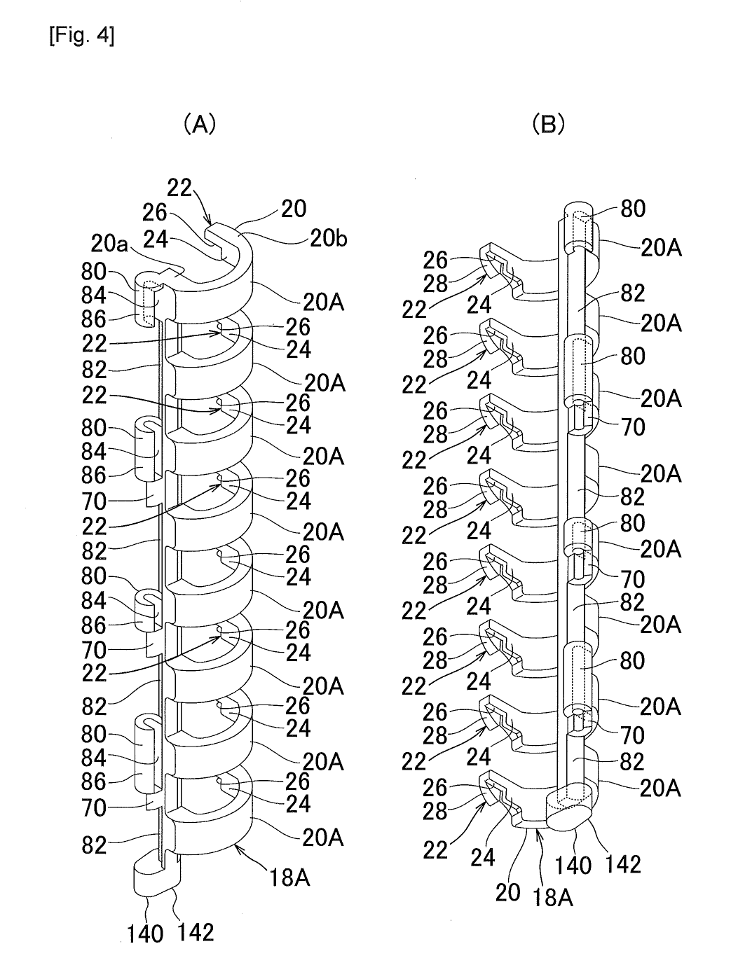

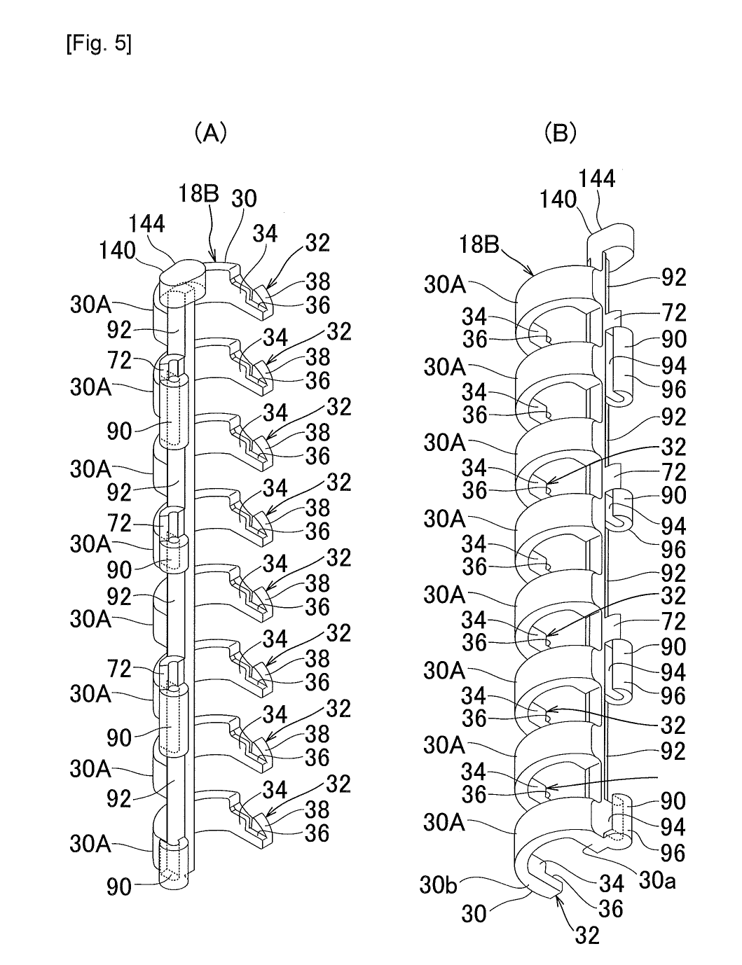

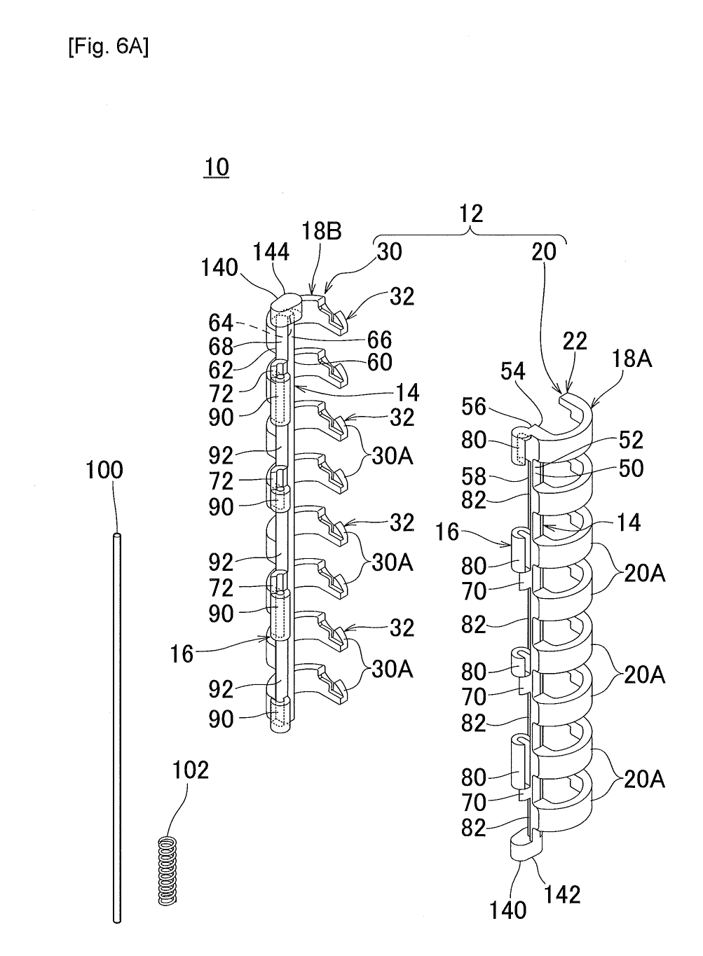

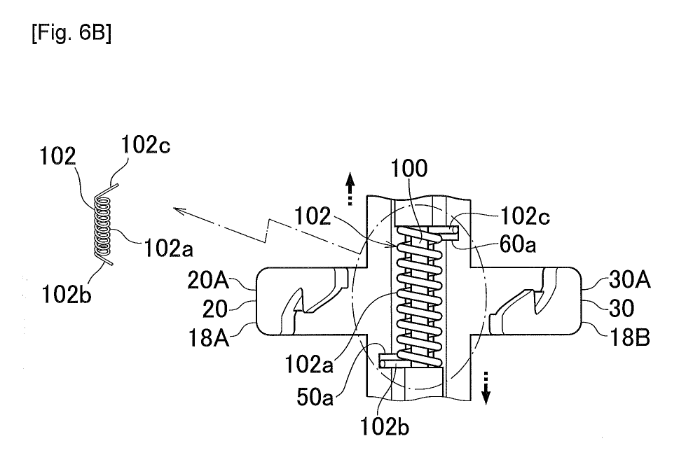

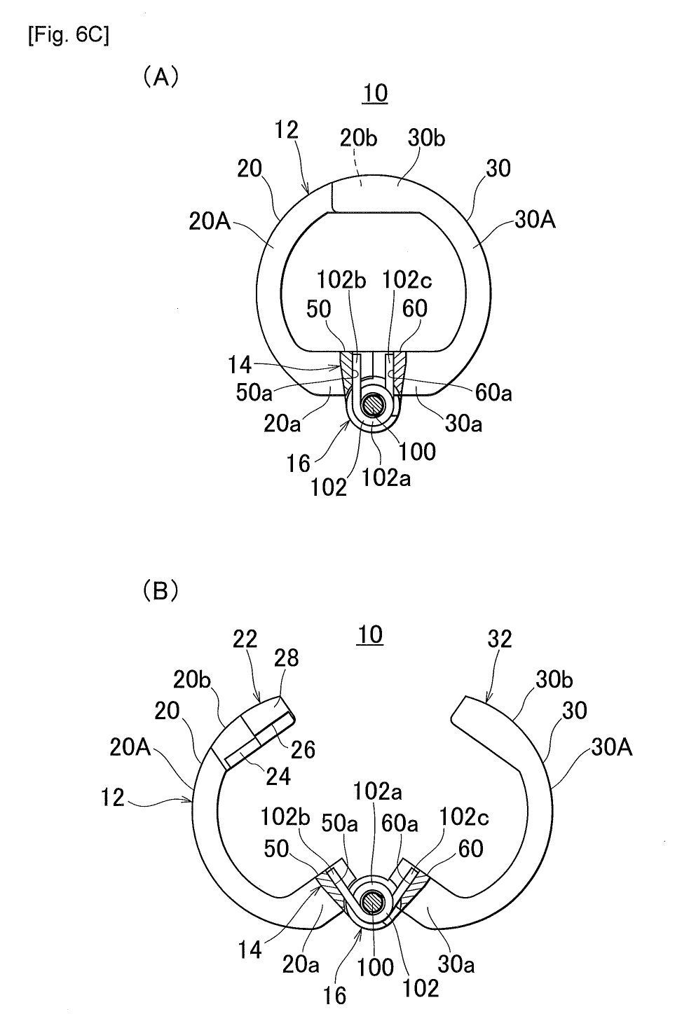

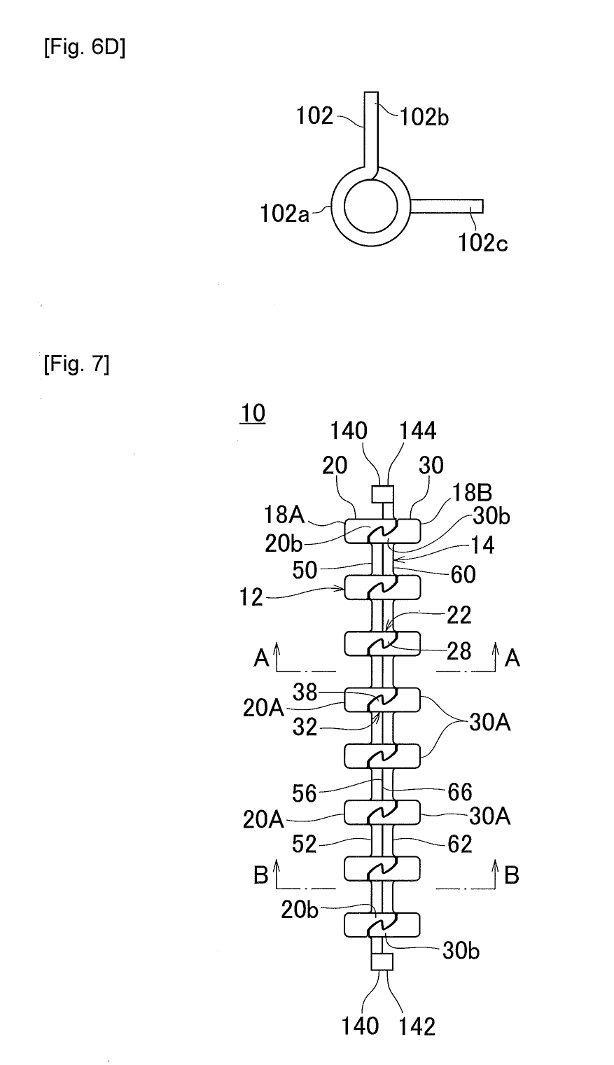

FIG. 1 is a schematic perspective view of a notebook with a binding device according to the present invention. FIG. 2 is a schematic perspective view of the binding device according to the present invention. FIG. 3 is a schematic perspective view of the binding device according to the present invention, wherein (A) is an overall view, (B) is a partially enlarged view, and (C) and (D) are views of half rods. FIG. 4 is a schematic perspective view of a first binding device member, wherein (A) is a right-side view, and (B) is a left-side view. FIG. 5 is a schematic perspective view of a second binding device member, wherein (A) is a right-side view, and (B) is a left-side view. FIG. 6A is a schematic perspective view of the binding device according to the present invention in a disassembled state. FIG. 6B is a schematic perspective view showing another spring member in the state in which the spring member is attached to the first and second binding device members. FIG. 6C is a schematic cross-sectional view of the binding device shown in FIG. 6B, wherein (A) is a schematic cross-sectional view showing a closed state, and (B) is a schematic cross-sectional view showing an opened state. FIG. 6D is a schematic elevation view of further another elastic member.

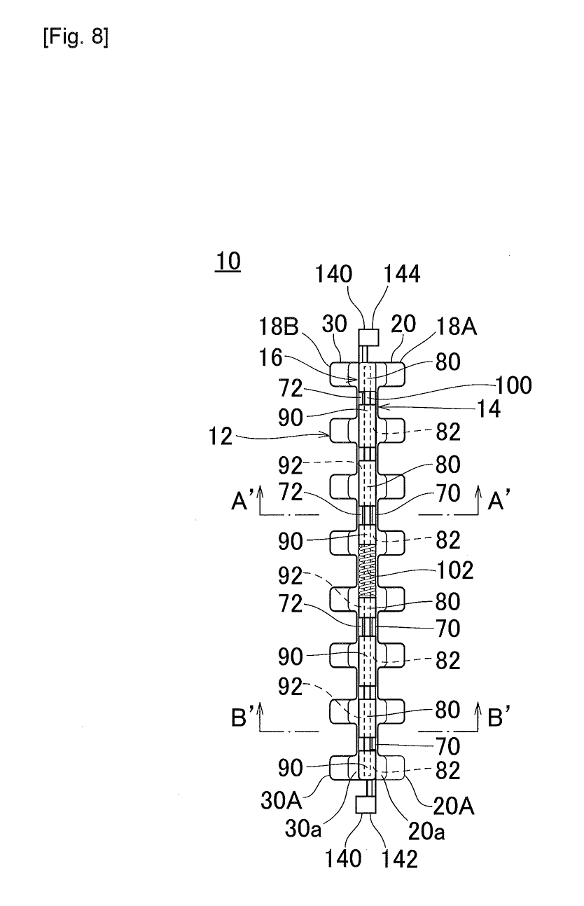

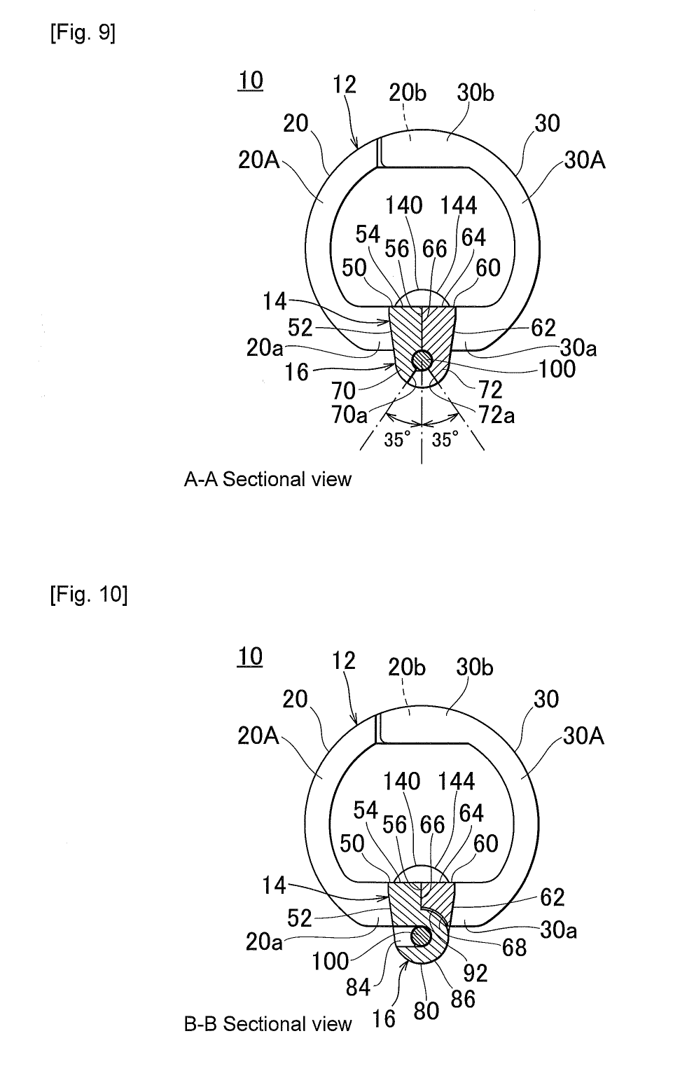

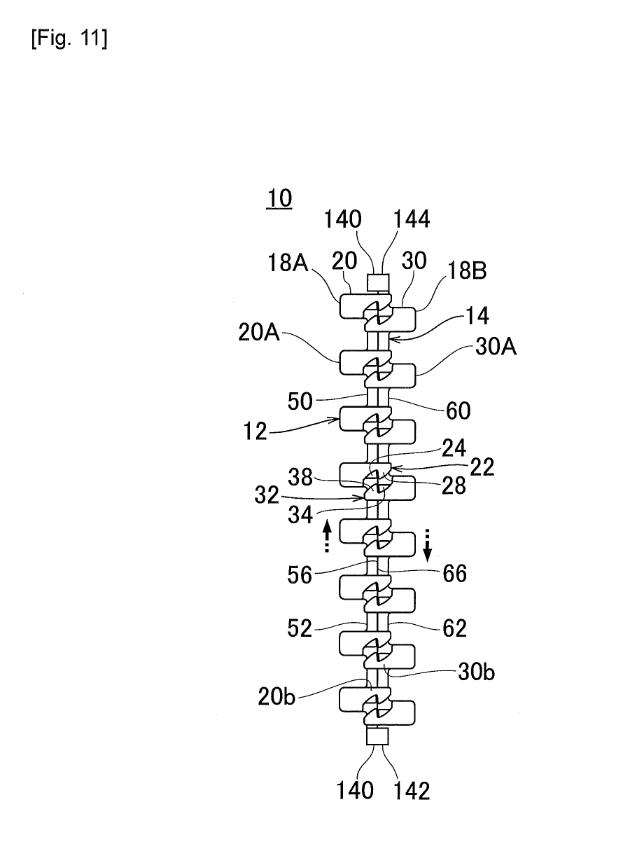

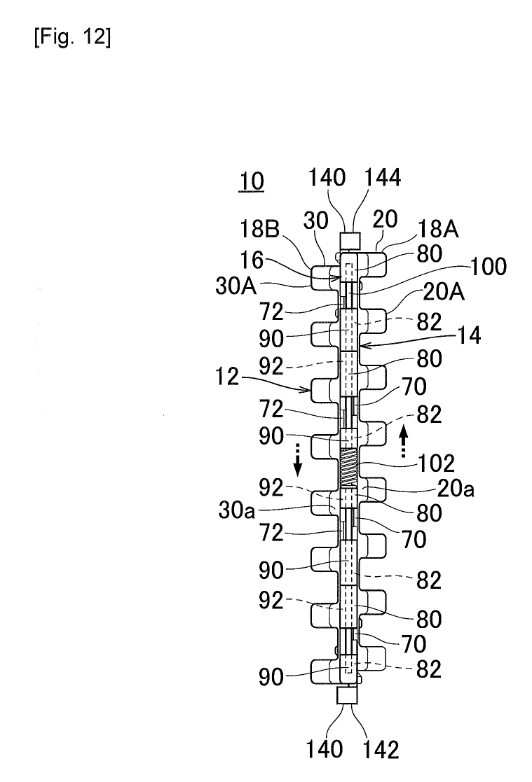

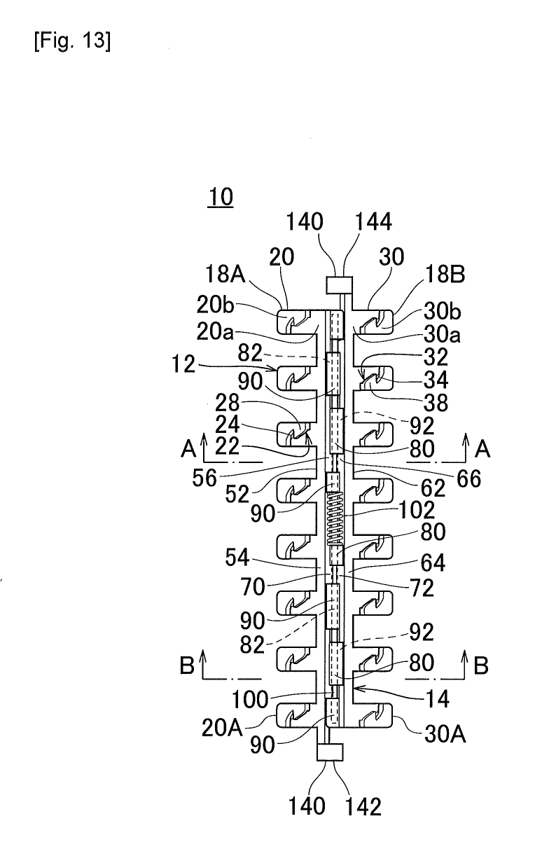

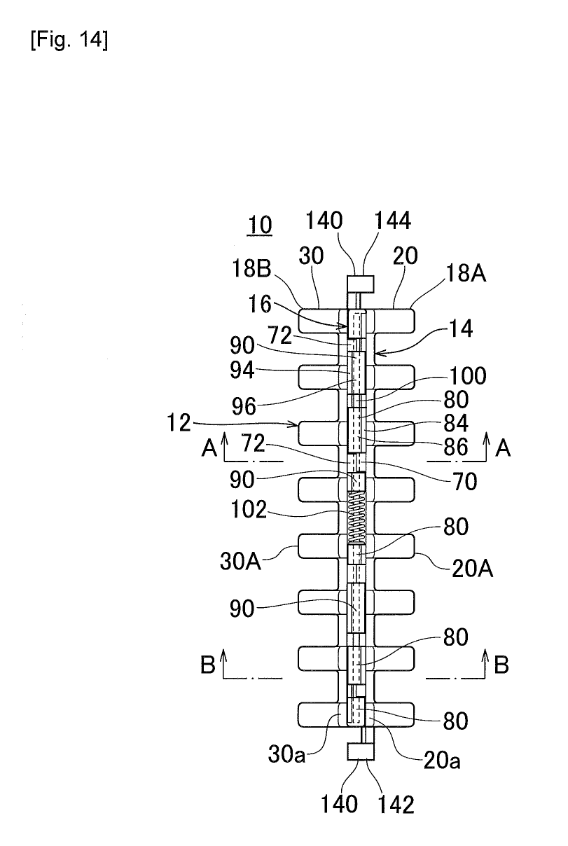

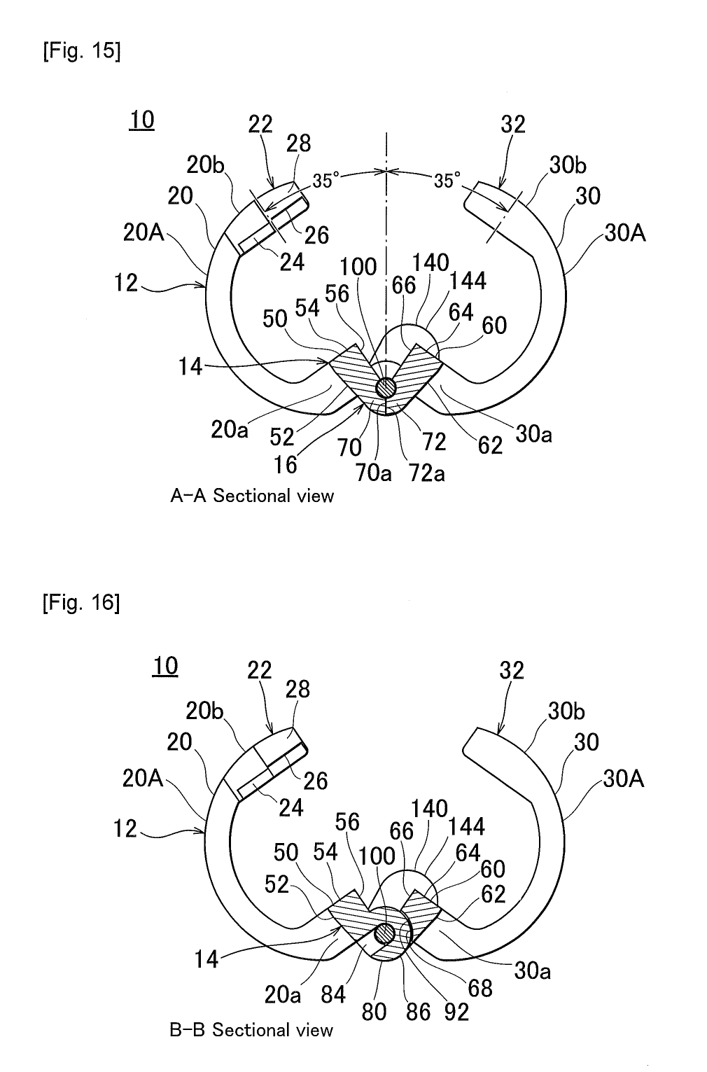

FIG. 7 is a schematic elevation view of the binding device in a closed state. FIG. 8 is a schematic back view of the binding device in the closed state. FIG. 9 is a schematic cross-sectional view taken along line A-A of FIG. 7. FIG. 10 is a schematic cross-sectional view taken along line B-B of FIG. 7. FIG. 11 is a schematic elevation view of the binding device in an opening start state. FIG. 12 is a schematic back view of the binding device in the opening start state. FIG. 13 is a schematic elevation view of the binding device in an opened state. FIG. 14 is a schematic back view of the binding device in the opened state. FIG. 15 is a schematic cross-sectional view taken along line A-A of FIG. 13. and FIG. 16 is a schematic cross-sectional view taken along line B-B of FIG. 13.

A binding device 10 of the present invention includes: a plurality of binding rod portions 12, connecting portions 14 composing a connecting region for connecting the binding rod portions 12, and an pivot coupling portion 16 composing an pivotally coupling region serving as a center upon opening and closing of binding rods composing the binding rod portions 12. The binding device 10 is configured such that the closed binding rod portions 12 can be opened by displacing the binding rod portions 12 in the length direction of the connecting portions 14.

This binding device 10 is mainly designed for a datebook or a notebook similar to a notebook typically referred to as a plastic ring type notebook and is configured so that leaves 110 can be turned along the binding rod portions 12 of the binding device 10 to be spread through 360 degrees, in other words, when the leaf 110 bound at the binding rod portions 12 is flipped along the binding rods and flipped over through 360 degrees for closing, the front side and the reverse side of the leaves 110 located at both ends can make contact with each other with the pivot coupling portion 16 sandwiched therebetween.

Usually, on a front side and a reverse side of writing sheets with binding holes, covers relatively harder than the aforementioned sheets are laid. In the scope of the present specification and claims, the front side and the reverse side of the leaf 110 include the front side of a front cover on the front side and the reverse side of a back cover on the reverse side of a sheet, a pocket of synthetic resin, or the like.

The binding rods composing the binding rod portions 12 are respectively provided at pairs of connecting portions 14 composing the connecting portions 14 at appropriate intervals in a longitudinal direction thereof in such a manner as to project from outer portions or upper portions of the connecting portions 14 so that pairs of the binding rods face each other. Each of the binding rod portions 12 includes the first binding rod 20 and the second binding rod 30 in a symmetric form separated to the left and right with respect to the pivot coupling portion 16 as a center.

The coupling region is formed over half rods 20A and half rods 30A so that the half rod 20A and the half rod 30A composing the first binding rod 20 and the second binding rod 30 are formed in parallel with appropriate intervals between the mutually adjacent half rod 20A and the half rod 20A and between the half rod 30A and the half rod 30A.

The connecting portions 14 include a first connecting portion 50 and a second connecting portion 60 in a symmetric form separated to the left and the right with respect to the pivot coupling portion 16 as a center. The first connecting portion 50 and the second connecting portion 60 are of a substantially columnar shape linearly extending in a longitudinal direction continuously from a far side to a near side.

In the region(s) of one end or both ends in the direction in which the center for opening/closing the binding rods are extending, a pressing portion(s) 140, which simultaneously displaces, in the direction in which the center is extending, the plurality of binding rods in opposing one side among the binding rods composing the binding rod portions 12 in order to disengage them from latching portions of the plurality of binding rods in the opposing other side, is projecting.

In this embodiment, the first binding rods 20 and the first connecting portion 50 are formed in a first binding device member 18A, the second binding rods 30 and the second connecting portion 60 are formed in a second binding device member 18B, and the first binding device member 18A and the second binding device member 18B are formed in a symmetric form.

In the pivot coupling region, the first binding device member 18A and the second binding device member 18B are coupled to each other with the pivot coupling portion 16 serving as the center, and the pivot coupling region is formed as a region that serves as the center of rotation upon opening/closing of the binding rod portions 12.

The connecting portions 14 have lower portions to which the pivot coupling portion 16 is provided continuously at a position close to base portions of the first binding rod 20 and the second binding rod 30 in such a manner that when the leaf 110 bound at the binding rod portions 12 is flipped along the first binding rods 20 and the second binding rods 30 and flipped over through 360 degrees for closing, the front side and the reverse side of the leaf 110 located at the both ends can make contact with each other with the pivot coupling portion 16 sandwiched therebetween.

The pivot coupling portion 16 extends in the longitudinal direction of the connecting portions 14 (the first connecting portion 50 and the second connecting portion 60) to couple the pair of the connecting portions 14 (the f first connecting portion 50 and the second connecting portion 60), and is configured to serve as a rotation center upon closing with free ends 20b of the first binding rods 20 and free ends 30b of the second binding rods 30 brought into contact with each other and upon separation of the free ends 20b of the first binding rods 20 and the free ends 30b of the second binding rods 30 from each other so that the leaf 110 bound at the binding rod portions 12 can be flipped along the first binding rods 20 and the second binding rods 30 and flipped over through 360 degrees.

The binding rod portion 12 has, at the free end 20b and the free end 30b on a side opposite to the base portion 20a and the base portion 30a of the first binding rod 20 and the second binding rod 30 provided continuously to the connecting portions 14, binding rod latching portions formed for latching the first binding rod 20 and the second binding rod 30 when they are closed. In other words, the first binding rod 20 has the binding rod latching portion 22 of the first binding rod formed at the free end 20b as a top portion on the side opposite to the base portion 20a, and the second binding rod 30 has the binding rod latching portion 32 of the second binding rod formed at the free end 30b as a top portion on the side opposite to the base portion 30a.

The binding rod portion 12 includes a height direction (perpendicular direction) from the base portion 20a and the base portion 30a to the top portions and a width direction (horizontal direction) from an outer periphery portion (outer portion) of the first binding rod 20 to an outer periphery portion (outer portion) of the second binding rod 30. The binding rod portion 12 is of a cross-sectionally rectangular shape with a width of the first binding rod 20 and the second binding rod 30 in a longitudinal direction of the binding device, the width being longer than a thickness of the first binding rod 20 and the second binding rod 30 (a length between the outer periphery portions and inner periphery portions). Moreover, the first binding rod 20 and the second binding rod 30 are formed into a shape inserted through binding holes 112 of the leaf 110 from the base portion 20a and the base portion 30a to the top portions thereof so that the leaf 110 can be flipped.

The binding rod latching portion 22 of the first binding rod and the binding rod latching portion 32 of the second binding rod are formed in such a manner as to be latched upon closing with tips of the first binding rod 20 and the second binding rod 30 brought into contact with each other or disengaged upon separation of the tips of these first binding rod 20 and the second binding rod 30 from each other by relatively moving the first binding rod 20 and the second binding rod 30, which are to be latched, in a direction crossing turning directions of the first binding rod 20 and the second binding rod 30, in other words, a longitudinal direction of the pivot coupling portion 16.

The first binding rod 20 is composed of a semicircular-arc half rod 20A in such a manner as to be a substantially annular binding rod when closed, the second binding rod 30 is composed of a semicircular-arc half rod 30A in such a manner as to be a substantially annular binding rod when closed.

Moreover, the binding rod latching portions 22 and 32 are formed at the tips of the half rod 20A and the half rod 30A, in other words, at the top portions of the first binding rod 20 and the second binding rod 30 in such a manner as to penetrate through the binding holes 112 previously punched in the leaves 110 to thereby bind the leaves 110.

The half rod 20A composing the first binding rod 20 and the half rod 30A composing the second binding rod 30 are coupled together into a substantially annular form by latching the binding rod latching portion 22 of the first binding rod of the half rod 20A and the binding rod latching portion 32 of the second binding rod of the half rod 30A.

The first-binding-rod binding rod latching portion 22 of the first binding rod 20 and the second-binding-rod binding rod latching portion 32 of the second binding rod 30 are configured to be latched with each other and be substantially annular upon closing of the binding rod portion 12.

The first binding rod 20 and the second binding rod 30 displace the first binding rod 20 or the second binding rod 30 in the length direction of the connecting portions 14 upon opening of the binding rod portion 12. In other words, the first binding rod 20 and the second binding rod 30 are configured so that a first pressing portion 142 and a second pressing portion 144 are relatively moved in mutually opposite directions in the length direction of the connecting portions 14 by pressing the first pressing portion 142 and the second pressing portion 144, which are for disengaging the binding rod latching portion 22 of the first binding rod and the binding rod latching portion 32 of the second binding rod, by fingers and that the binding rod latching portion 22 of the first binding rod and the binding rod latching portion 32 of the second binding rod, which are latched, can be detached from each other by further turning the first pressing portion 142 and the second pressing portion 144 in the mutually opposite directions.

A first binding rod projection 24 at a tip composing the binding rod latching portion 22 of the first binding rod formed at the tip of the half rod 20A composing the first binding rod 20 and a first binding rod recess 26 continuing to this first binding rod projection 24, and a second binding rod projection 34 at a tip composing the binding rod latching portion 32 of the second binding rod formed at the tip of the half rod 30A composing the second binding rod 30 and a second binding rod recess 36 continuing to the second binding rod projection 34 are formed to project or be recessed in opposite directions so that the first binding rod 20 and the second binding rod 30 engage with each other when closed.

Specifically, the first binding rod projection 24 composing the binding rod latching portion 22 of the first binding rod formed at the tip of the half rod 20A composing the first binding rod 20 projects to the near side. Moreover, the first binding rod recess 26 continuing to the first binding rod projection 24 is recessed to the far side. The second binding rod projection 34 composing the binding rod latching portion 32 of the second binding rod formed at the tip of the half rod 30A projects to the far side. Moreover, the second binding rod recess 36 continuing to this second binding rod projection 34 at the tip is recessed to the near side.

The first binding rod projection 24 and the first binding rod recess 26 and the second binding rod projection 34 and the second binding rod recess 36 are so formed as to project or be recessed in the opposite directions so that the first binding rod 20 and the second binding rod 30 engage with each other when closed.

The first binding rod projection 24 composing the binding rod latching portion 22 of the first binding rod of the half rod 20A and the binding rod projection 34 of the second binding rod composing the second binding rod latching portion 32 of the half rod 30A are so provided as to project in the opposite directions.

In addition, the first binding rod recess 26 composing the binding rod latching portion 22 of the first binding rod of the half rod 20A and the second binding rod recess 36 composing the binding rod latching portion 32 of the second binding rod of the half rod 30A are so formed as to be recessed in the opposite directions.

The binding rod latching portion 22 of the first binding rod and the binding rod latching portion 32 of the second binding rod have a disengagement preventing portion 28 and a disengagement preventing portion 38 so formed as to extend in the turning directions of the first binding rod 20 and the second binding rod 30 so that the binding rod latching portion 22 of the first binding rod and the binding rod latching portion 32 of the second binding rod do not disengage from each other in the turning directions of the first binding rod 20 and the second binding rod 30 and the direction crossing the turning directions.

The disengagement preventing portion 28 has: a hooked nose latching projection 28a projecting to the near side on a top portion side; and a latching recess 28b recessed to the far side on the base portion 20a side, and the latching recess 28b is formed on the base portion 20a side continuously from the latching projection 28a on a free end side.

The disengagement preventing portion 38 has: a hooked nose latching projection 38a projecting to the far side on a top portion side; and a latching recess 38b recessed to the near side on the base portion 30a side, and the latching recess 38b is formed on the base portion 30a side continuously from the latching projection 38a on a free end side.

When the first binding rod 20 and the second binding rod 30 are closed, the latching projection 28a of the disengagement preventing portion 28 is fitted into the latching recess 38b of the disengagement preventing portion 38, the latching projection 38a of the disengagement preventing portion 38 is fitted into the latching recess 28b of the disengagement preventing portion 28, and the latching projection 28a and the latching projection 38a hit each other when the first binding rod 20 and the second binding rod 30 are pulled in the turning directions.

The disengagement preventing portion 28 of the binding rod latching portion 22 of the first binding rod projects to an upper portion of the binding rod latching portion 32 of the second binding rod to prevent the second binding rod 30 from moving upwardly due to impact or the like when the binding rod latching portion 22 of the first binding rod and the binding rod latching portion 32 of the second binding rod engage with each other.

The disengagement preventing portion 38 of the binding rod latching portion 32 of the second binding rod projects to an upper portion of the binding rod latching portion 22 of the first binding rod to prevent the first binding rod 20 from moving upwardly due to impact or the like when the binding rod latching portion 22 of the first binding rod and the binding rod latching portion 32 of the second binding rod engage with each other.

As described above, in this embodiment, by pressing the pressing portions 140 with fingers, the first binding rod 20 of the first binding device member 18A can be moved to the far side and the second binding rod 30 of the second binding device member 18B can be moved to the near side to undo the engagement between the binding rod latching portion 22 of the first binding rod of the half rod 20A of the first binding rod 20 and the binding rod latching portion 32 of the second binding rod of the half rod 30A of the second binding rod 30.

Furthermore, the latching projection 28a of the disengagement preventing portion 28 and the latching projection 38a of the disengagement preventing portion 38 have inclined surfaces gently formed from the free ends in such a manner as to fit into the latching recess 38b and the latching recess 28b while hitting and sliding on them upon closing.

The first connecting portion 50 of the first binding device member 18A composing the connecting portions 14 includes: a first connecting portion opposing portion 56 as a region where the first connecting portion 50 and the second connecting portion 60 face each other; a first connecting portion outer portion 52 which opposes the first connecting portion opposing portion 56 and at which the first binding rod 20 is provided in a projecting manner; and a first connecting portion lower portion 58 which is a surface crossing the first connecting portion opposing portion 56 and the first connecting portion outer portion 52 between the first connecting portion opposing portion 56 and the first connecting portion outer portion 52 and to which the pivot coupling portion 16 is provided continuously.

The second connecting portion 60 of the second binding device member 18B composing the connecting portions 14 includes: a second connecting portion opposing portion 66 as a region where the first connecting portion 50 and the second connecting portion 60 face each other; a second connecting portion outer portion 62 which opposes the second connecting portion opposing portion 66 and at which the second binding rod 30 is provided in a projecting manner; and a second connecting portion lower portion 68 which is a surface crossing the second connecting portion opposing portion 66 and the second connecting portion outer portion 62 between the second connecting portion opposing portion 66 and the second connecting portion outer portion 62 and to which the pivot coupling portion 16 is provided continuously.

In this embodiment, the first connecting portion 50 and the second connecting portion 60 have a substantially quadrangular prism shape.

Moreover, the first connecting portion opposing portion 56 and the second connecting portion opposing portion 66 are planes orthogonal to the turning directions and extending perpendicularly, in other words, in the height direction when the binding device 10 is closed. The first connecting portion opposing portion 56 and the second connecting portion opposing portion 66 are so formed as to make close contact with each other when the binding device 10 is closed, as shown in FIGS. 9 and 10.

The connecting portions 14 have an aperture angle restricting portion 70 and an aperture angle restricting portion 72 formed on their side surfaces for restricting an aperture angle of the first binding rod 20 and the second binding rod 30 at an angle, for example, approximately 60 to 70 degrees, which permits easy insertion of the leaf 110.

The aperture angle restricting portion 70 of the first binding device member 18A has in cross-section a substantially semicircular-arc shape formed continuously to a first receiving portion 80 of the first connecting portion lower portion 58 of the first connecting portion 50, and includes a contact surface 70a extending downwardly from the first connecting portion lower portion 58. On the other hand, the aperture angle restricting portion 72 of the second binding device member 18B has in cross-section a substantially semicircular-arc shape formed continuously to a second receiving portion 90 of the second connecting portion lower portion 68 of the second connecting portion 60, and includes a contact surface 72a extending downwardly from the second connecting portion lower portion 68.

Moreover, when the binding rod portion 12 is closed, the contact surface 70a of the aperture angle restricting portion 70 and the contact surface 72a of the aperture angle restricting portion 72 are inclined surfaces opposing each other with an aperture of approximately 70 degrees, as shown in FIG. 9. When the binding rod portion 12 is opened, the contact surface 70a of the aperture angle restricting portion 70 and the contact surface 72a of the aperture angle restricting portion 72 make contact with each other, restricting the aperture angle of the half rod 10A and the half rod 30A at the angle which permits the easy insertion of the leaf 110, as shown in FIG. 15.

The pivot coupling portion 16 includes a shaft portion 100 and receiving portions for the shaft portion 100.

The receiving portions are composed of the first receiving portions 80 each provided continuously to the first connecting portion 50 and the second receiving portions 90 each provided continuously to the second connecting portion 60. The shaft portion 100 extends continuously from the far side to the near side along the longitudinal direction of the connecting portions 14, and couples together the first binding device member and the second binding device member.

The first receiving portion 80 and the second receiving portion 90 are provided continuously to the binding rod portion 12 and/or the connecting portions 14, and have aperture portions (aperture portion 84 of the first receiving portion 80 and aperture portion 94 of the second receiving portion 90) formed on their side surfaces for filling the shaft portion 100 therein, and are configured in such a manner as to serve as a rotation center upon closing with the tips of the half rod 20A and the half rod 30A brought into contact with each other and upon separation of the tips of the half rod 20A and the half rod 30A from each other so that the leaf 110 bound at the first binding rods 20 and the second binding rod 30 can be flipped along the first binding rod 20 and the second binding rods 30 and then flipped over through 360 degrees.

The first receiving portion 80 and the second receiving portion 90 are formed intermittently in the longitudinal direction of the connecting portions 14, and formed in such a manner as that the first receiving portion 80 and the second receiving portion 90 relatively move in the longitudinal direction when the half rod 20A and the half rod 30A turn with respect to the shaft portion 100 as a center and also the first binding rod 20 and the second binding rod 30 are opened/closed.

The shaft portion 100 is a rod-like metal bar of a circular shape in cross section. In correspondence therewith, the first receiving portion 80 and the second receiving portion 90 are arc-shaped as a whole, and the shaft portion 100 is filled in a circular-arc portion 86 and a circular-arc portion 96 inside the first receiving portion 80 and the second receiving portion 90, and to outer upper portions thereof, the connecting portions 14 are provided continuously in such a manner as to protrude in directions opposite to directions in which the half rod 20A and the half rod 30A protrude.

In this embodiment, the shaft portion 100, the first receiving portion 80, and the second receiving portion 90 are different members. The first receiving portion 80 is integrally formed with the first binding device member 18A by using synthetic resin, and the second receiving portion 90 is integrally formed with the second binding device member 18B by using synthetic resin.

Moreover, the shaft portion 100 is so formed as to extend from the first receiving portion 80 on the furthest side of the first binding device member 18A to the second receiving portion 90 on the nearest side of the second binding device member 18B.

The first receiving portion 80 on the first binding device member 18A side has a first housing portion 82 intermittently formed between this first receiving portion 80 and the adjacent first receiving portion 80 when the shaft portion 100 is filled, and the second receiving portion 90 on the second binding device member 18B side has a second housing portion 92 intermittently formed between this second receiving portion 90 and the adjacent second receiving portion 90 when the shaft portion 100 is filled.

Moreover, when the first binding rods 20 and the second binding rods 30 are closed, on an axis line of the pivot coupling portion 16, the first binding device member 18A has the first housing portions 82 housing the second receiving portions 90 of the second binding device member 18B and the second binding device member 18B has the second housing portions 92 housing the first receiving portions 80 of the first binding device member 18A. The first receiving portions 80 and the second receiving portions 90 are aligned with an appropriate space between each of the first receiving portions 80 of the first binding device member 18A and the second receiving portion 90 of the second binding device member 18B adjacent thereto and between each of the second receiving portions 90 of the second binding device member 18B and the first receiving portion 80 of the first binding device member 18A adjacent thereto. The appropriate space between each of the first receiving portions 80 of the first binding device member 18A and the second receiving portions 90 of the second binding device member 18B adjacent thereto and between each of the second receiving portions 90 of the second binding device member 18B and the first receiving portions 80 of the first binding device member 18A adjacent thereto refers to as a length required for relatively moving the first binding rod 20 and the second binding rod 30 in the longitudinal direction of the connecting portions 14, in other words, to the near side and the far side to thereby disengage the first binding rod latching portion 22 and the second binding rod latching portion 32.

In addition, the first binding device member 18A and the second binding device member 18B are slidably mounted at the shaft portion 100 so that the half rod 20A and the half rod 30A relatively move upon opening/closing of the first binding rod 20 and the second binding rod 30.

In this embodiment, the first binding rod 20 of the first binding device member 18A is moved to the far side and the second binding rod 30 of the second binding device member 18B is moved to the near side to open the closed first binding rod 20 and second binding rod 30.

In this embodiment, the aperture portion 84 of the first receiving portion 80 on the far side of the first binding device member 18A is covered on the far side. On the other hand, the aperture portion 94 of the second receiving portion 90 on the near side of the second binding device member 18B is covered on the near side. Accordingly, the first receiving portion 80 on the far side prevents a far-side end of the shaft portion 100 from coming off, and the second receiving portion 90 on the near side prevents a near side end of the shaft portion 100 from coming off.

An outer periphery portion of the base portion 20a of the half rod 20A and an outer periphery portion of the base portion 30a of the half rod 30A are formed with their lower portions located at the same positions as those of the lower portions of the connecting portions 14. An outer side of the first receiving portion 80 and an outer side of the second receiving portion 90 of the pivot coupling portion 16 are formed with their upper portions located at the same positions as those of the lower portions of the connecting portions 14.

In this embodiment, the first receiving portion 80 of the pivot coupling portion 16 has the aperture portion 84 making contact with the outer periphery portion of the half rod 20A, and the second receiving portion 90 of the pivot coupling portion 16 has the aperture portion 94 making contact with the outer periphery portion of the half rod 30A. The first connecting portion 50 has a height between an inner periphery portion of the half rod 20A and the aperture portion 84 of the first receiving portion 80, and the second connecting portion 60 has a height between an inner periphery portion of the half rod 30A and the aperture portion 94 of the second receiving portion 90.

A width of the connecting portions 14 (in a width direction) is equal to or smaller than half a width of the first receiving portion 80 of the pivot coupling portion 16 or the second receiving portion 90 of the pivot coupling portion 16 (in a width direction). This configuration is provided since if a width obtained by adding together a width of the first connecting portion 50 and a width of the second connecting portion 60 is equal to or smaller than the width of the first receiving portion 80 of the pivot coupling portion 16 and the width of the second receiving portion 90 of the pivot coupling portion 16, when the leaf 110 is flipped over through 360 degrees and the front side and the reverse side of the leaf 110 are brought into contact with each other with the pivot coupling portion 16 sandwiched therebetween, this contact can be made without space relatively.

Between the first housing portion 82 of the first binding device member 18A located in the vicinity of the center of the first connecting portion 50 and the second housing portion 92 of the second binding device member 18B located in the vicinity of the center of the second connecting portion 60, a elastic member 102 which applies tension (tensile or compressive force) in the longitudinal direction of the shaft portion 100 is fitted in a compressed state. The elastic member 102 is formed of a coil spring made by winding a steel wire into a coil form, and the shaft portion 100 is inserted into the loop of the tube-shaped coil spring.

Moreover, the elastic member 102 has a far-side end making contact with the near-side end of the second receiving portion 90 of the second binding device member 18B and has a near-side end making contact with a far-side end of the first receiving portion 80 of the first binding device member 18A. The elastic member 102 is so configured as to press down the first binding device member 18A to the near side and to press up the second binding device member 18B to the far side by (uniform) restoring force.

Thus, the elastic member 102 operates in the direction engaging the binding rod latching portion 22 of the first binding rod with the binding rod latching portion 32 of the second binding rod when the binding rod portion 12 is closed.

When the binding rod latching portion 22 of the first binding rod and the binding rod latching portion 32 of the second binding rod, which are latched with each other, are to be detached by pressing the pressing portions 140 by fingers, against the spring force of the elastic member 102, the first binding rod 20 of the first binding device member 18A is moved to the far side, and the second binding rod 30 of the second binding device member 18B is moved to the near side, thereby opening the first binding rod 20 and the second binding rod 30, which have been closed.

The elastic member 102 may be configured in the below manner.

FIG. 6B is a schematic perspective view showing another elastic member in the state in which the elastic member is attached to the first and second binding device members. FIG. 6C is a schematic cross-sectional view of the binding device shown in FIG. 6B, wherein (A) is a schematic cross-sectional view showing a closed state, and (B) is a schematic cross-sectional view showing an opened state. FIG. 6D is a schematic elevation view of further another elastic member.

The elastic member 102 shown in FIG. 6B is composed of a torsion coil spring. A coil portion 102a, a linear first fixing tip portion 102b, and a linear second fixing tip portion 102c are continuously provided, wherein the first and second fixing tip portions 102b and 102c are extending in the direction orthogonal to or intersecting with the central axis of the coil portion 102a from both ends of the coil portion 102a. In the original state in which no torsion moment is generated, the first fixing tip portion 102b and the second fixing tip portion 102c are projecting in the tangent direction outside the coil portion 102a.

In order to support the tip portions extending from the both ends of the coil portion 102a of the elastic member 102, a support portion 50a and a support portion 60a are formed in the connecting portions 14.

The fixing tip portions extending from the both ends of the coil portion 102a of the elastic member 102 are latched and supported by the support portion 50a, which is formed in the first connecting portion 50 of the first binding device member 18A, and the support portion 60a of the second connecting portion 60 of the second binding device member 18B opposed to the support portion 50a.

In other words, the first fixing tip portion 102b in one side is supported by the support portion 50a of the first connecting portion 50, and the second fixing tip portion 102c in the other side is supported by the support portion 60a of second connecting portion 60 so as to be opposed to the first fixing tip portion 102b.

When the binding rod latching portion 22 of the first binding rod and the binding rod latching portion 32 of the second binding rod, which are latched with each other, are to be detached from each other by pressing the pressing portions 140 by fingers, the first fixing tip portion 102b is supported by the support portion 50a of the first connecting portion 50 in the side opposite to the moving direction thereof, and the second fixing tip portion 102c in the other side is supported by the support portion 60a of the second connecting portion 60 in the side opposite to the moving direction thereof.

The fixing tip portion 102b in one side and the fixing tip portion 102c in the other side have been originally in an opened state. However, when the first binding rod 20 and the second biding rod 30 are in a closed state, the first fixing tip portion 102b and the second fixing tip portion 102c, which have been moved from the original opened state to be close to each other approximately in parallel, are supported by the support portion 50a and the support portion 60a of the connecting portions 14. In other words, the elastic member 102 is in a twisted state, in which the first fixing tip portion 102b is latched by the support portion 50a of the first connecting portion 50, and the second fixing tip portion 102c is latched by the support portion 60a of the second connecting portion 60.

Moreover, the elastic member 102 has a far-side end making contact with the near-side end of the second receiving portion 90 of the second binding device member 18B and has a near-side end making contact with a far-side end of the first receiving portion 80 of the first binding device member 18A. The elastic member 102 is so configured as to press down the first binding device member 18A to the near side and to press up the second binding device member 18B to the far side by (uniform) restoring force.

Thus, the elastic member 102 operates in the direction engaging the binding rod latching portion 22 of the first binding rod with the binding rod latching portion 32 of the second binding rod when the binding rod portion 12 is closed.

When the binding rod latching portion 22 of the first binding rod and the binding rod latching portion 32 of the second binding rod, which are latched with each other, are to be detached by pressing the pressing portions 140 by fingers, against the spring force of the elastic member 102, the first binding rod 20 of the first binding device member 18A is moved to the far side, and the second binding rod 30 of the second binding device member 18B is moved to the near side, thereby opening the first binding rod 20 and the second binding rod 30, which have been closed.

When the pressing portions 140 are pressed by fingers to relatively move the first connecting portion 50 of the first binding device member 18A and the second connecting portion 60 of the second binding device member 18B in mutually opposite directions, the first connecting portion 50 and the second connecting portion 60 are turned in the turning direction since the force that returns the elastic member 102 to the original state works, in other words, the force works so that the first fixing tip portion 102b in one side and the second fixing tip portion 102c in the other side are turned in the turning direction and open the binding rod portion 12.

In this manner, in the present embodiment, when the binding rod latching portion 22 of the first binding rod and the binding rod latching portion 32 of the second binding rod are disengaged from each other, the state that the first binding rod 20, the first connecting portion 50, the second binding rod 30, and the second connecting portion 60 are opened is obtained since the force that separates the first fixing tip portion 102b in one side and the second fixing tip portion 102c in the other side from each other in the circumferential direction works.

As shown in FIG. 6D, the first fixing tip portion 102b and the second fixing tip portion 102c may be configured to project in radial directions to the outside of the coil portion 102a.

In this modification example, the first connecting portion 50 and the second connecting portion 60 can be turned in the turning direction when the force that returns the elastic member 102 to the original state works, in other words, stronger force works so that the first fixing tip portion 102b in one side and the second fixing tip portion 102c in the other side are turned in the turning direction to open the binding rod portion 12.

The pressing portion 140 formed in the coupling region is formed into a columnar shape or a block-like shape in order to displace the first binding rod 20 or the second binding rod 30 in the longitudinal direction of the connecting portions 14, which is the extending direction of the center for opening/closing the first binding rod 20 and the second binding rod 30 upon latching or disengaging the binding rod latching portion 22 of the first binding rod and the binding rod latching portion 32 of the second binding rod, and disengage the binding rod latching portion 22 of the first binding rod and the binding rod latching portion 32 of the second binding rod.

The pressing portions 140 are composed of the first pressing portion 142 provided to project from the lower end portion of the first connecting portion 50 and the second pressing portion 144 provided to project from the upper end portion of the second connecting portion 60, wherein the first and second pressing portions are in the longitudinal direction of the connecting portions 14, composing the coupling region of coupling the first binding device member 18A and the second binding device member 18B and the height direction which is the extending direction of the center for opening/closing the first binding rod 20 and the second binding rod 30.

The first pressing portion 142 is a cylindrical rod body, which extends from the lower end portion of the lower side of the first connecting portion 50 to the opposite side of the direction for moving the first connecting portion 50 upon disengagement of the binding rod latching portion 22 of the first binding rod of the first binding device member 18A, in other words, to the near side (lower side), and the first pressing portion 142 is formed to have a size extending to the near side of the second connecting portion 60 and is formed so that the area for pressing is large.

The second pressing portion 144 is a cylindrical rod body, which extends from the upper end portion of the upper side of the second connecting portion 60 to the opposite side of the direction for moving the first connecting portion 50 upon disengagement of the binding rod latching portion 32 of the second binding rod of the second binding device member 18B, in other words, to the far side (upper side), and the second pressing portion 144 is formed to have a size extending to the far side of the first connecting portion 50 and is formed so that the area for pressing is large.

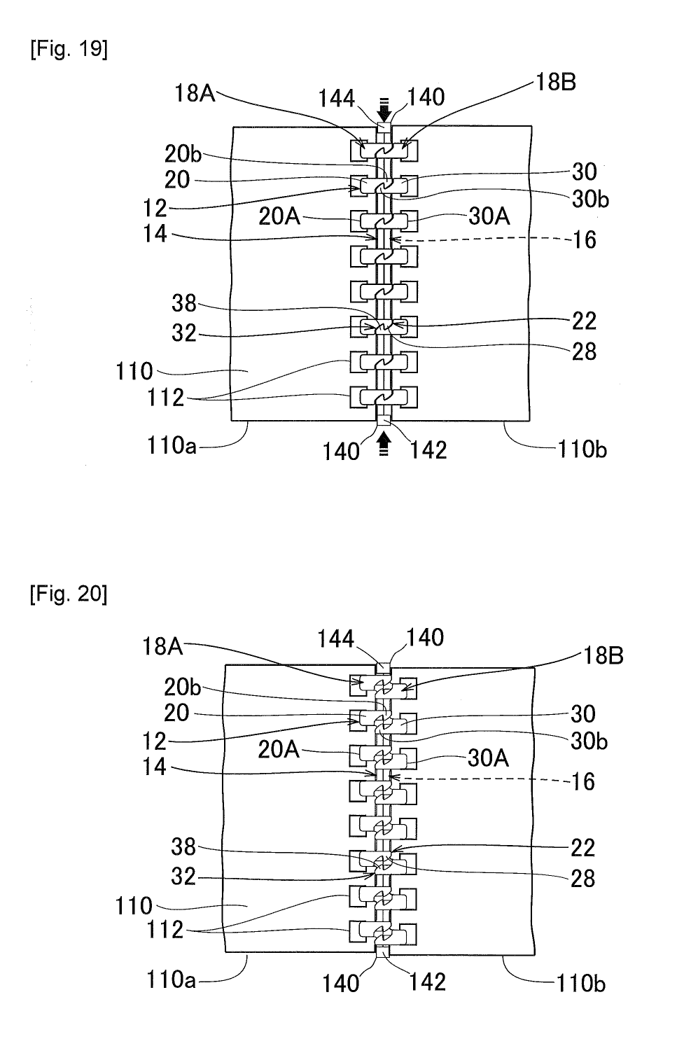

As shown in FIG. 19, the binding rod latching portion 22 of the first binding rod and the binding rod latching portion 32 of the second binding rod are disengaged, for example, by placing the thumb on the first pressing portion 142, placing the index finger on the second pressing portion 144, and pressing the first pressing portion 142 toward the far side (upper side) and the second pressing portion 144 toward the near side (lower side).

Then, as shown in FIG. 20, the first pressing portion 142 and the second pressing portion 144 are turned in the mutually opposite directions in the direction in which the first binding rod 20 and the second binding rod 30 are extending, thereby opening the binding rod portion 12.

The binding device 10 forms a notebook by binding the leaf 110 in such a manner that the binding holes 112 continuously provided at appropriate intervals in a height direction of the leaf 110 are penetrated by the first binding rods 20 and the second binding rods 30, the pivot coupling portion 16 is situated on a side of a binding margin side edge 114 extending in the height direction of the leaf 110, and the first binding rods 20 and the second binding rods 30 bridge between the binding holes 112 and the binding margin side edge 114.

The binding device 10 may form a notebook by binding the leaf 110 in such a manner that a length direction of the binding device 10 extends in the width direction of the leaf 110 having the binding holes 112 formed at the edge extending in the width direction.

Substantially-L-shaped recesses may be formed in the leaves 110 so that fingers can enter when the upper and lower ends of the binding margin side edges 114 bound at the binding rods 12 shown in FIG. 19 and FIG. 20, in other words, the pressing portions 140 are to be pressed by the fingers to the far side (upper side) of the binding holes 112.

If such a configuration is employed, even when the leaves 110 are spread by being distributed to the first binding rod 20 side and the second binding rod 30 side, the space for entering the fingers are formed around the first pressing portion 142 and the second pressing portion 144, and the first pressing portion 142 and the second pressing portion 144 can be pressed or turned.

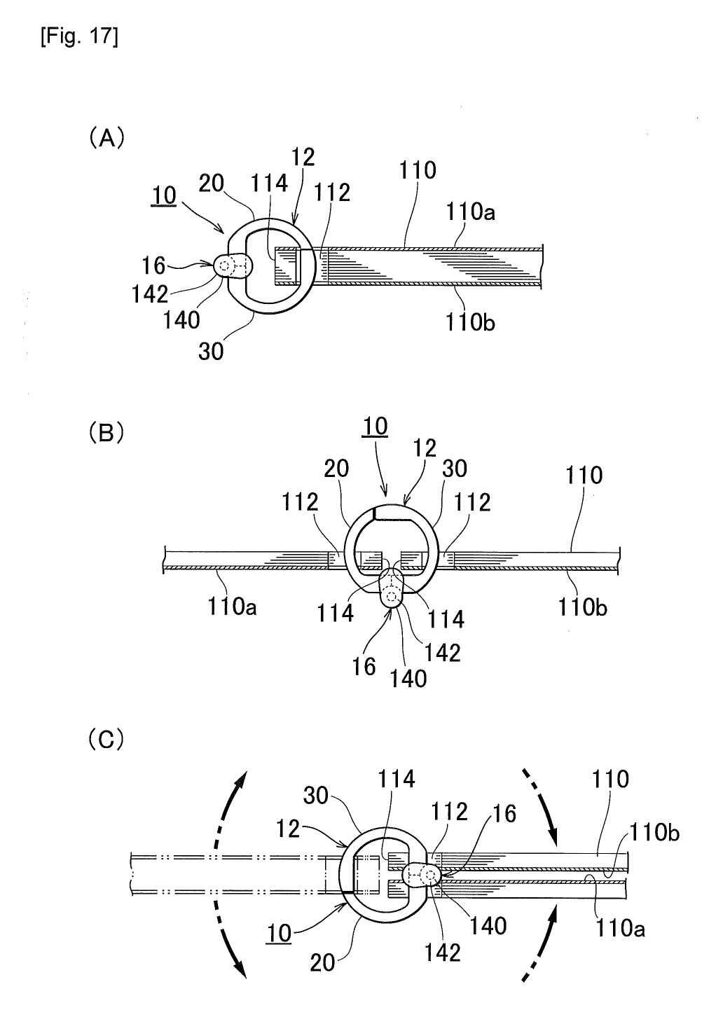

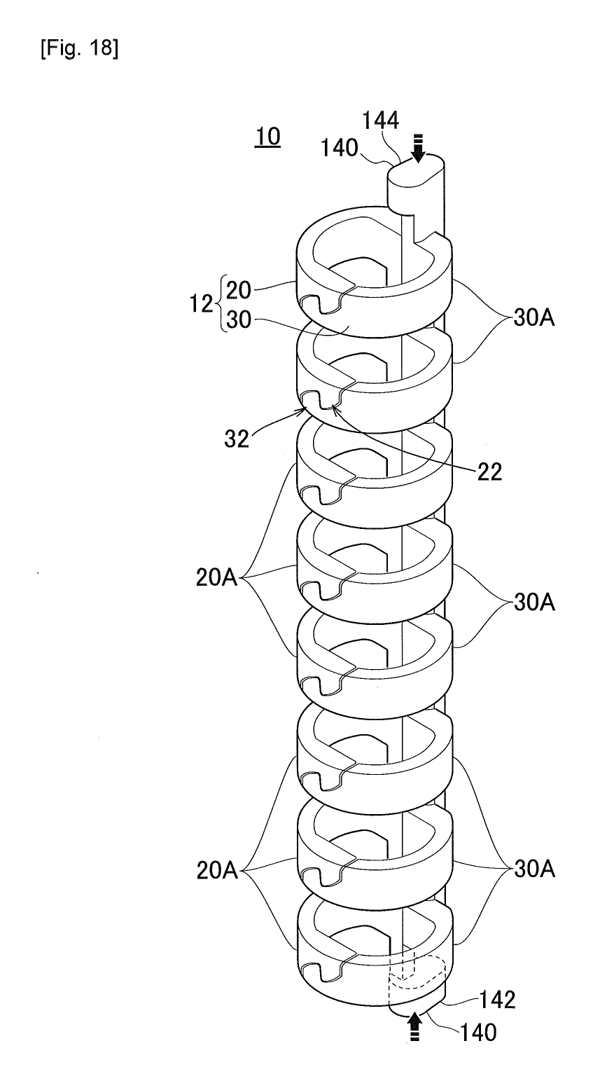

The leaf 110 bound by the binding device 10 can be used for writing or otherwise in such a manner that the leaf 110 is flipped over to the pivot coupling portion 16 side and a leaf front side 110a and a leaf reverse side 110b are brought into contact with each other with the pivot coupling portion 16 sandwiched therebetween when the leaves are laid during closing, as shown in FIG. 17.

According to the embodiment of the present invention, the binding rod portions 12 and the connecting portions 14 are formed at each of the first binding device member 18A and the second binding device member 18B in a pair, and the binding rods 20 and 30 composing the binding rod portions 12 are provided at the appropriate intervals in the longitudinal direction of the connecting portions 14 in such a manner as to project from the outer portion or the upper portion of the connecting portions 14 so that the first binding rods 20 on the first binding device member 18A side and the second binding rods 30 on the second binding device member 18B side face each other. Therefore, when the binding rod portions 12 are opened, lowest portions of the binding rod portions 12 are grounded on a surface of, for example, a desk top plate to be thereby easily horizontally stabilized, and also the binding rod portions 12 can be easily opened at an appropriate degree.

According to the embodiment of the present invention, the binding rod portion 12 includes the first binding rod 20 and the second binding rod 30 in the symmetrical form separated to the left and right with respect to the pivot coupling portion 16 as the center, and the connecting portions 14 includes the first connecting portion 50 and the second connecting portion 60 in the symmetrical form separated to the left and right with respect to the pivot coupling portion 16 as the center. Therefore, the left and right members can be formed with the same die, which makes it easy to manufacture them.

According to the embodiment of the present invention, the connecting portions 14 includes: the mutually facing opposing portions 56 and 66 of the first connecting portion 50 and the second connecting portion 60; the outer portions 52 and 62 which oppose the opposing portions 56 and 66 and from which the binding rods 20 and 30 are provided in such a manner as to project; and the lower portions 58 and 68 which are surfaces crossing the opposing portions 56 and 66 and the outer portions 52 and 62 between the opposing portions 56 and 66 and the outer portions 52 and 62 and to which the pivot coupling portion 16 is provided continuously. Therefore, the first connecting portion opposing portion 56 and the second connecting portion opposing portion 66 are planes orthogonal to the turning directions and extending perpendicularly, in other words, the height direction when the binding device 10 is closed. Forming the first connecting portion opposing portion 56 and the second connecting portion opposing portion 66 in such a manner as to bring them into close contact with each other when the binding device 10 is closed can stably maintain condition of the engagement between the binding rod latching portion 22 of the first binding rod and the binding rod latching portion 32 of the second binding rod when the binding device 10 is closed, which can reduce shrinking action of an annular diameter formed by the first binding rod 20 and the second binding rod 30 composing the binding rod portion 12.

According to the embodiment of the present invention, the receiving portions 80 and 90 are formed intermittently in the longitudinal direction of the connecting portions 14, and formed in such a manner that the binding rod portions 12 turn with respect to the shaft portion 100 as the center and relatively move in the longitudinal direction upon opening/closing of the binding rod portions 12. Therefore, the binding rod portion 12 composed of plural binding rods 20 and 30 can be opened and closed at once.

According to the embodiment of the present invention, the shaft portion 100 is of a circular rod shape in cross section, the receiving portions 80 and 90 are arc-shaped as a whole, the shaft portion 100 is filled in the arc portions therein, and to the outer upper portions thereof, the connecting portions 14 are provided continuously in such a manner as to protrude in the directions opposite to the directions in which the binding rods 20 and 30 protrude. Therefore, the binding rod portions 12 composed of the plurality of binding rods 20 and 30 can be opened/closed at once, the lowest portions of the binding rod portions 12 are grounded on the surface of, for example, the desk top plate to be thereby easily horizontally stabilized, and the binding rod portions 12 can easily be opened at the appropriate degree.

According to the embodiment of the present invention, the base portions 20a and 30a of the binding rods 20 and 30 are formed with their lower portions located at the same positions as those of the lower portions of the connecting portions 14, and the receiving portions 80 and 90 of the pivot coupling portion 16 are formed with their upper portions located at the same positions as those of the lower portions of the connecting portions 14. Therefore, when the binding rod portions 12 are opened, the lowest portions of the binding rod portions 12 are grounded on the surface of, for example, the desk top plate to be thereby easily horizontally stabilized, and the binding rod portions 12 can easily be opened at the appropriate degree.

According to the embodiment of the present invention, the width of the connecting portions 14 is equal to or smaller than half the width of the pivot coupling portion 16. Therefore, it does not extend beyond the width of the pivot coupling portion 16, and when the leaf 110 is flipped along the binding rods 20 and 30 and opened through 360 degrees, the space between the front side and the reverse side of the leaf 110 is small, thus providing relative flatness, which also makes writing easier.

According to the embodiment of the present invention, the receiving portions 80 and 90 of the pivot coupling portion 16 have the aperture portions 84 and 94 of the receiving portions 80 and 90 making contact with the outer periphery portions of the binding rods 20 and 30, and the connecting portions 14 have height from the inner periphery portions of the binding rods 20 and 30 to the aperture portions 84 and 94 of the receiving portions 80 and 90. Therefore, when the leaf 110 is flipped along the binding rods 20 and 30 and opened through 360 degrees, the space between the leaf front side 110a and the leaf reverse side 110b is small, thus providing relative flatness, which also makes writing easier.

According to the embodiment of the present invention, the binding rod latching portions 22 and 32, in order to be engaged or disengaged in the turning directions of the binding rods 20 and 30, are so configured as to engage the projection 24 and the recess 26 of the first binding rod 20 and the recess 36 and the projection 34 of the second binding rod 30, and the binding rod latching portions 22 and 32, in order not to be disengaged in the direction crossing the turning directions of the binding rods 20 and 30, have the disengagement preventing portions 28 and 38 so formed as to extend in the turning directions of the binding rods 20 and 30. Therefore, the binding rod latching portions 22 and 32 of the closed binding rods are hard to be disengaged in the direction crossing the turning directions of the binding rods 20 and 30.

The binding device 10 of the embodiment of the present invention can form a datebook or a notebook bound with the binding rod portions 12 of the binding device 10 penetrated through the binding holes 112 of the leaf 110, and can form a file, a binder, or the like by being fixed on the cover including the front cover, the back cover, and a spine.

The present invention is not limited to the embodiment described above and thus various modifications can be made based on the spirits of the present invention.

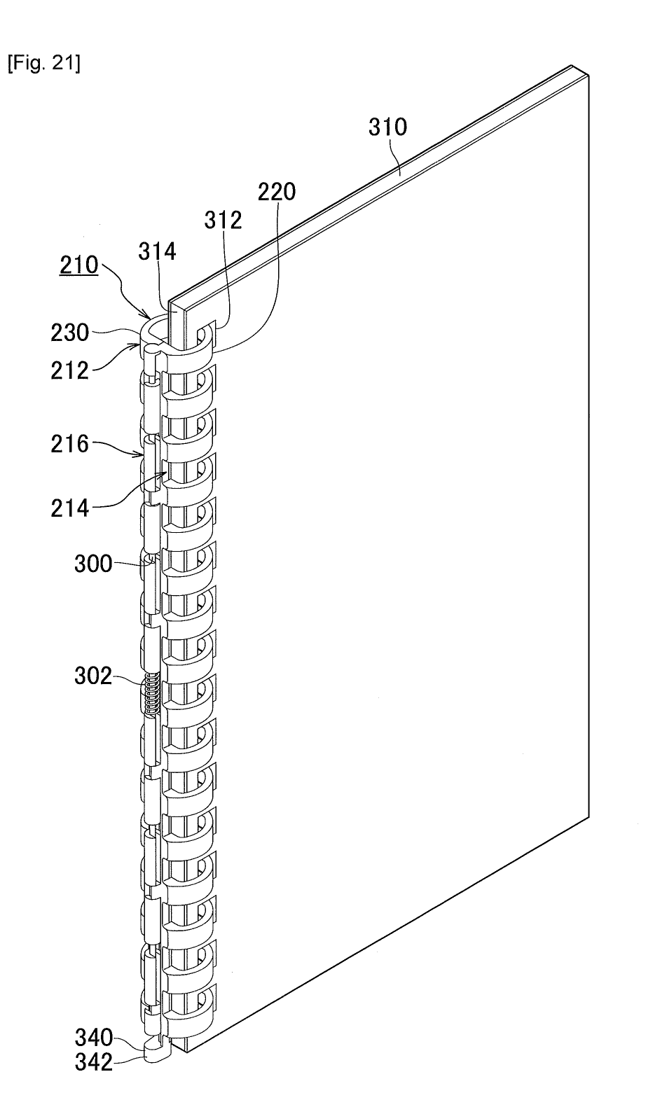

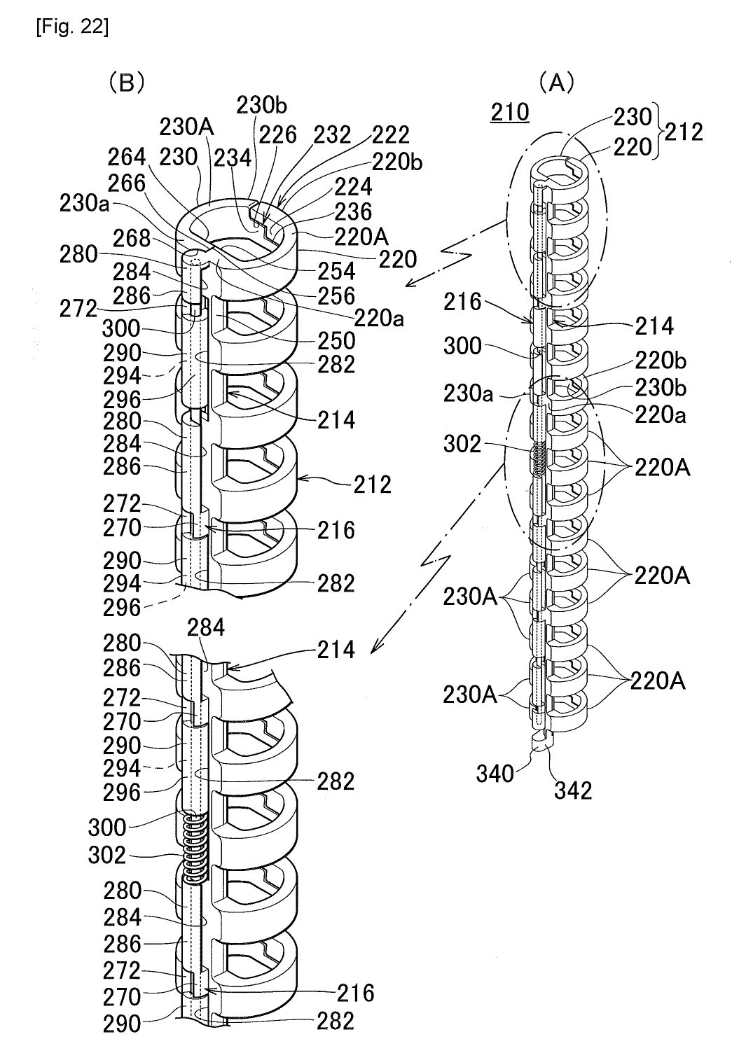

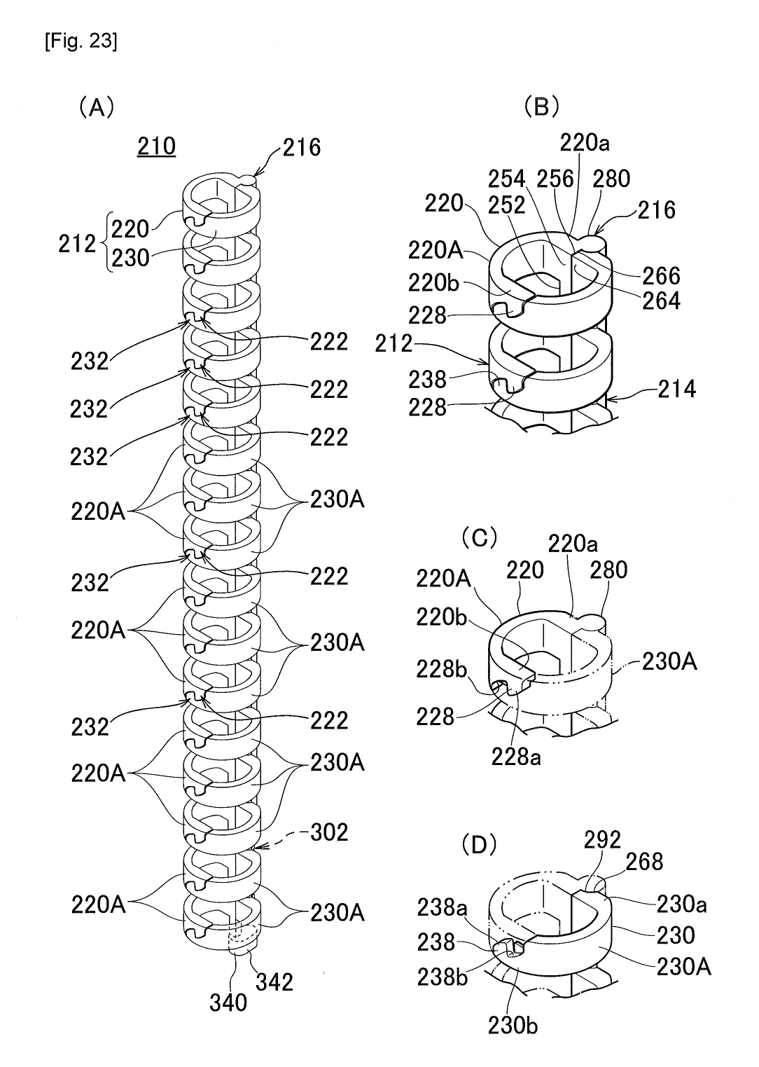

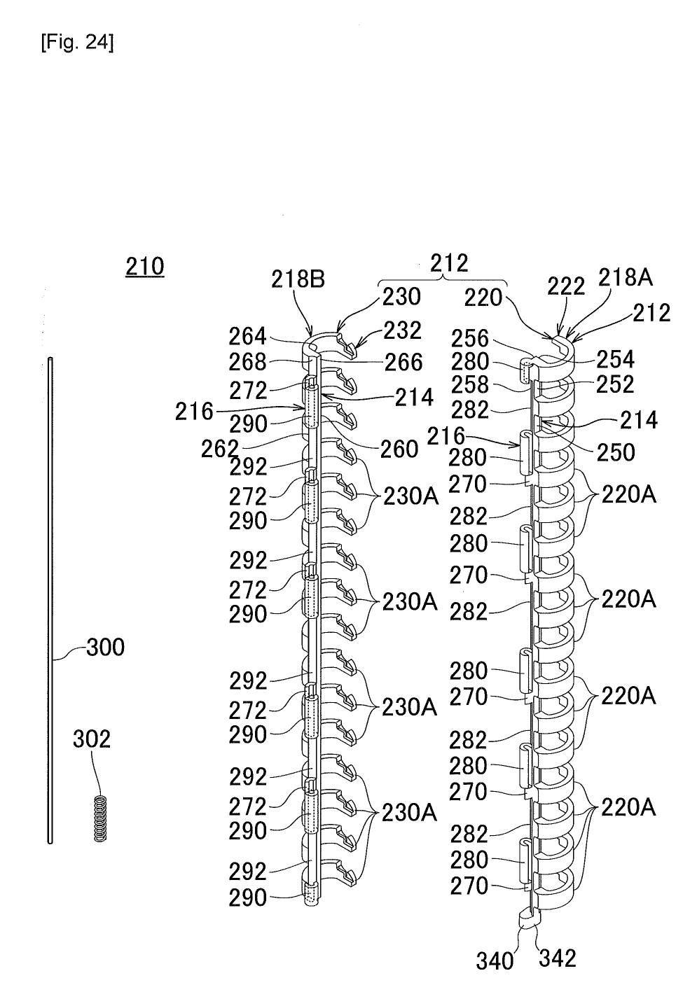

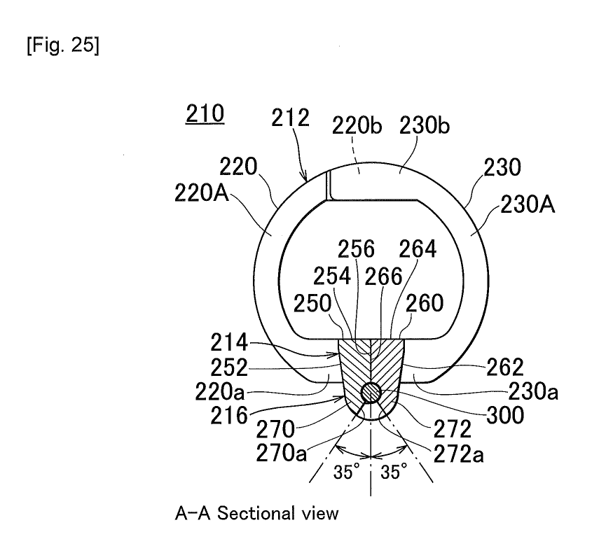

FIG. 21 is a schematic perspective view of a notebook with a binding device according to the present invention. FIG. 22 is a schematic perspective view of the binding device according to the present invention, wherein (A) is an overall view, and (B) is a partially enlarged view. FIG. 23 is a schematic perspective view of the binding device according to the present invention, wherein (A) is an overall view, (B) is a partially enlarged view, and (C) and (D) are views of half rods. FIG. 24 is a schematic perspective view of the binding device according to the present invention in a disassembled state. FIG. 25 is a schematic cross-sectional view taken along line A-A of FIG. 7.

A binding device 210 of the present invention includes: a plurality of binding rod portions 212, connecting portions 214 composing a connecting region for connecting the binding rod portions 212, and an pivot coupling portion 216 serving as a center upon opening and closing of binding rods composing the binding rod portions 212. The binding device 10 is configured such that the closed binding rod portions 12 can be opened by twisting the binding rod portions 212.

This binding device 210 is mainly designed for a datebook or a notebook similar to a notebook typically referred to as a plastic ring type notebook and is configured so that leaves 310 can be turned along the binding rod portions 212 of the binding device 210 to be spread through 360 degrees, in other words, when the leaf 310 bound at the binding rod portions 212 is flipped along the binding rods and flipped over through 360 degrees for closing, the front side and the reverse side of the leaves 310 located at both ends can make contact with each other with the pivot coupling portion 216 sandwiched therebetween.

Usually, on a front side and a reverse side of writing sheets with binding holes, covers relatively harder than the aforementioned sheets are laid. In the scope of the present specification and claims, the front side and the reverse side of the leaf 310 include the front side of a front cover on the front side and the reverse side of a back cover on the reverse side of a sheet, a pocket of synthetic resin, or the like.

The binding rods composing the binding rod portions 212 are respectively provided at pairs of connecting portions 214 composing connecting portions 214 at appropriate intervals in a longitudinal direction thereof in such a manner as to project from outer portions or upper portions of the connecting portions 214 so that pairs of the binding rods face each other. Each of the binding rod portions 212 includes the first binding rod 220 and the second binding rod 230 in a symmetric form separated to the left and right with respect to the pivot coupling portion 216 as a center.

The coupling region is formed over half rods 220A and half rods 230A so that the half rod 220A and the half rod 230A composing the first binding rod 220 and the second binding rod 230 are formed in parallel with appropriate intervals between the mutually adjacent half rod 220A and the half rod 220A and between the half rod 230A and the half rod 230A.

The connecting portions 214 include a first connecting portion 250 and a second connecting portion 260 in a symmetric form separated to the left and the right with respect to the pivot coupling portion 216 as a center. The first connecting portion 250 and the second connecting portion 260 are of a substantially columnar shape linearly extending in a longitudinal direction continuously from a far side to a near side.

In the region(s) of one end (or both ends) in the direction in which the center for opening/closing the binding rods are extending, a pressing portion(s), which simultaneously displaces, in the direction in which the center is extending, the plurality of binding rods in opposing one side among the binding rods composing the binding rod portions 212 in order to disengage them from latching portions of the plurality of binding rods in the opposing other side, is projecting.

In this embodiment, the first binding rods 220 and the first connecting portion 250 are formed in a first binding device member 218A, the second binding rods 230 and the second connecting portion 260 are formed in a second binding device member 218B, and the first binding device member 218A and the second binding device member 218B are formed in a symmetric form.

The first binding device member 218A is integrally formed of synthetic resin, and the second binding device member 218B is similarly integrally formed of synthetic resin.

In the pivot coupling region, the first binding device member 218A and the second binding device member 218B are coupled to each other with the pivot coupling portion 216 serving as the center, and the pivot coupling region is formed as a region that serves as the center of rotation upon opening/closing of the binding rod portions 212.

The connecting portions 214 have lower portions to which the pivot coupling portion 216 is provided continuously at a position close to base portions of the first binding rod 220 and the second binding rod 230 in such a manner that when the leaf 310 bound at the binding rod portions 212 is flipped along the first binding rods 220 and the second binding rods 230 and flipped over through 360 degrees for closing, the front side and the reverse side of the leaf 310 located at the both ends can make contact with each other with the pivot coupling portion 216 sandwiched therebetween.

The pivot coupling portion 216 extends in the longitudinal direction of the connecting portions 214 (the first connecting portion 250 and the second connecting portion 260) to couple the pair of the connecting portions 214 (the first connecting portion 250 and the second connecting portion 260), and is configured to serve as a rotation center upon closing with free ends 220b of the first binding rods 220 and free ends 230b of the second binding rods 230 brought into contact with each other and upon separation of the free ends 220b of the first binding rods 220 and the free ends 230b of the second binding rods 230 from each other so that the leaf 310 bound at the binding rod portions 212 can be flipped along the first binding rods 220 and the second binding rods 230 and flipped over through 360 degrees.

The binding rod portion 212 has, at the free end 220b and the free end 230b on a side opposite to the base portion 220a and the base portion 230a of the first binding rod 220 and the second binding rod 230 provided continuously to the connecting portions 214, binding rod latching portions formed for latching the first binding rod 220 and the second binding rod 230 when they are closed. In other words, the first binding rod 220 has the binding rod latching portion 222 of the first binding rod formed at the free end 220b as a top portion on the side opposite to the base portion 220a, and the second binding rod 230 has the binding rod latching portion 232 of the second binding rod formed at the free end 230b as a top portion on the side opposite to the base portion 230a.

The binding rod portion 212 includes a height direction (perpendicular direction) from the base portion 220a and the base portion 230a to the top portions and a width direction (horizontal direction) from an outer periphery portion (outer portion) of the first binding rod 220 to an outer periphery portion (outer portion) of the second binding rod 230. The binding rod portion 212 is of a cross-sectionally rectangular shape with a width of the first binding rod 220 and the second binding rod 230 in a longitudinal direction of the binding device, the width being longer than a thickness of the first binding rod 220 and the second binding rod 230 (a length between the outer periphery portions and inner periphery portions). Moreover, the first binding rod 220 and the second binding rod 230 are formed into a shape inserted through binding holes 312 of the leaf 310 from the base portion 220a and the base portion 230a to the top portions thereof so that the leaf 310 can be flipped.

The binding rod latching portion 222 of the first binding rod and the binding rod latching portion 232 of the second binding rod are formed in such a manner as to be latched upon closing with tips of the first binding rod 220 and the second binding rod 230 brought into contact with each other or disengaged upon separation of the tips of these first binding rod 220 and the second binding rod 230 from each other by relatively moving the first binding rod 220 and the second binding rod 230, which are to be latched, in a direction crossing turning directions of the first binding rod 220 and the second binding rod 230, in other words, a longitudinal direction of the pivot coupling portion 216.

The first binding rod 220 is composed of a semicircular-arc half rod 220A in such a manner as to be a substantially annular binding rod when closed, the second binding rod 230 is composed of a semicircular-arc half rod 230A in such a manner as to be a substantially annular binding rod when closed, and the first binding rod 220 and the second binding rod 230 are so formed as to oppose each other.

Moreover, the binding rod latching portions 222 and 232 are formed at the tips of the half rod 220A and the half rod 230A, in other words, at the top portions of the first binding rod 220 and the second binding rod 230 in such a manner as to penetrate through the binding holes 312 previously punched in the leaves 310 to thereby bind the leaves 310.

The half rod 220A composing the first binding rod 220 and the half rod 230A composing the second binding rod 230 are coupled together into a substantially annular form by latching the binding rod latching portion 222 of the first binding rod of the half rod 220A and the binding rod latching portion 232 of the second binding rod of the half rod 230A.

In the binding rod portion 212, the binding rod latching portion 222 of the first binding rod and the binding rod latching portion 232 of the second binding rod for latching the binding rods when the binding rods are closed are formed at the free end 220b and the free end 230b in the side opposite to the base portion 220a and the base portion 230a provided continuously to the connecting portions 214 and/or the pivot coupling portion 216 of the binding rods; the binding rod latching portion 222 of the first binding rod and the binding rod latching portion 232 of the second binding rod are formed so that the binding rods, which are latched in the direction intersecting with the turning direction of the binding rods latched therewith, are relatively moved and latched or disengaged; and the pressing portion 340 is provided to project from the binding rod and/or the connecting portions 214 and/or the pivot coupling portion 216 toward the side opposite to the direction of disengagement in the side opposite to the disengaging direction of the binding rods.

In the present embodiment, the pressing portion 340 is composed of a push rod provided to project to the near side of the first binding rod 220 in the longitudinal direction of the connecting portions 214.

A first binding rod projection 224 at a tip composing the binding rod latching portion 222 of the first binding rod formed at the tip of the half rod 220A composing the first binding rod 220 and a first binding rod recess 226 continuing to this first binding rod projection 224, and a second binding rod projection 234 at a tip composing the binding rod latching portion 232 of the second binding rod formed at the tip of the half rod 230A composing the second binding rod 230 and a second binding rod recess 236 continuing to the second binding rod projection 234 are formed to project or be recessed in opposite directions so that the first binding rod 220 and the second binding rod 230 engage with each other when closed.

Specifically, the first binding rod projection 224 composing the binding rod latching portion 222 of the first binding rod formed at the tip of the half rod 220A composing the first binding rod 220 projects to the near side. Moreover, the first binding rod recess 226 continuing to the first binding rod projection 224 is recessed to the far side. The second binding rod projection 234 composing the binding rod latching portion 232 of the second binding rod formed at the tip of the half rod 230A projects to the far side. Moreover, the second binding rod recess 236 continuing to this second binding rod projection 234 at the tip is recessed to the near side.

The first binding rod projection 224 and the first binding rod recess 226 and the second binding rod projection 234 and the second binding rod recess 236 are so formed as to project or be recessed in the opposite directions so that the first binding rod 220 and the second binding rod 230 engage with each other when closed.

The first binding rod projection 224 composing the binding rod latching portion 222 of the first binding rod of the half rod 220A and the binding rod projection 234 of the second binding rod composing the second binding rod latching portion 232 of the half rod 230A are so provided as to project in the opposite directions.

In addition, the first binding rod recess 226 composing the binding rod latching portion 222 of the first binding rod of the half rod 220A and the second binding rod recess 236 composing the binding rod latching portion 232 of the second binding rod of the half rod 230A are so formed as to be recessed in the opposite directions.

The binding rod latching portion 222 of the first binding rod and the binding rod latching portion 232 of the second binding rod have a disengagement preventing portion 228 and a disengagement preventing portion 238 so formed as to extend in the turning directions of the first binding rod 220 and the second binding rod 230 so that the binding rod latching portion 222 of the first binding rod and the binding rod latching portion 232 of the second binding rod do not disengage from each other in the turning directions of the first binding rod 220 and the second binding rod 230 and the direction crossing the turning directions.

The disengagement preventing portion 228 has: a hooked nose latching projection 228a projecting to the near side on a top portion side; and a latching recess 228b recessed to the far side on the base portion 220a side, and the latching recess 228b is formed on the base portion 220a side continuously from the latching projection 228a on a free end side.

The disengagement preventing portion 238 has: a hooked nose latching projection 238a projecting to the far side on a top portion side; and a latching recess 238b recessed to the near side on the base portion 230a side, and the latching recess 238b is formed on the base portion 230a side continuously from the latching projection 238a on a free end side.

When the first binding rod 220 and the second binding rod 230 are closed, the latching projection 228a of the disengagement preventing portion 228 is fitted into the latching recess 238b of the disengagement preventing portion 238, the latching projection 238a of the disengagement preventing portion 238 is fitted into the latching recess 228b of the disengagement preventing portion 228, and the latching projection 228a and the latching projection 238a hit each other when the first binding rod 220 and the second binding rod 230 are pulled in the turning directions.

The disengagement preventing portion 228 of the binding rod latching portion 222 of the first binding rod projects to an upper portion of the binding rod latching portion 232 of the second binding rod to prevent the second binding rod 230 from moving upwardly due to impact or the like when the binding rod latching portion 222 of the first binding rod and the binding rod latching portion 232 of the second binding rod engage with each other.

The disengagement preventing portion 238 of the binding rod latching portion 232 of the second binding rod projects to an upper portion of the binding rod latching portion 222 of the first binding rod to prevent the first binding rod 220 from moving upwardly due to impact or the like when the binding rod latching portion 222 of the first binding rod and the binding rod latching portion 232 of the second binding rod engage with each other.

As described above, in this embodiment, by pressing the pressing portions 340 with fingers, the first binding rod 220 of the first binding device member 218A can be moved to the far side and the second binding rod 230 of the second binding device member 218B can be relatively moved to the near side to undo the engagement between the binding rod latching portion 222 of the first binding rod of the half rod 220A of the first binding rod 220 and the binding rod latching portion 232 of the second binding rod of the half rod 230A of the second binding rod 230.

Furthermore, the latching projection 228a of the disengagement preventing portion 228 and the latching projection 238a of the disengagement preventing portion 238 have inclined surfaces gently formed from the free ends in such a manner as to fit into the latching recess 238b and the latching recess 228b while hitting and sliding on them upon closing.

The first connecting portion 250 of the first binding device member 218A composing the connecting portions 214 includes: a first connecting portion opposing portion 256 as a region where the first connecting portion 250 and the second connecting portion 260 face each other; a first connecting portion outer portion 252 which opposes the first connecting portion opposing portion 256 and at which the first binding rod 220 is provided in a projecting manner; and a first connecting portion lower portion 258 which is a surface crossing the first connecting portion opposing portion 256 and the first connecting portion outer portion 252 between the first connecting portion opposing portion 256 and the first connecting portion outer portion 252 and to which the pivot coupling portion 216 is provided continuously.

The second connecting portion 260 of the second binding device member 218B composing the connecting portions 214 includes: a second connecting portion opposing portion 266 as a region where the first connecting portion 250 and the second connecting portion 260 face each other; a second connecting portion outer portion 262 which opposes the second connecting portion opposing portion 266 and at which the second binding rod 230 is provided in a projecting manner; and a second connecting portion lower portion 268 which is a surface crossing the second connecting portion opposing portion 266 and the second connecting portion outer portion 262 between the second connecting portion opposing portion 266 and the second connecting portion outer portion 262 and to which the pivot coupling portion 216 is provided continuously.

In this embodiment, the first connecting portion 250 and the second connecting portion 260 have a substantially quadrangular prism shape.

Moreover, the first connecting portion opposing portion 256 and the second connecting portion opposing portion 266 are planes orthogonal to the turning directions and extending perpendicularly, in other words, in the height direction when the binding device 210 is closed. The first connecting portion opposing portion 256 and the second connecting portion opposing portion 266 are so formed as to make close contact with each other when the binding device 210 is closed, as shown in FIG. 25.

The connecting portions 214 have an aperture angle restricting portion 270 and an aperture angle restricting portion 272 formed on their side surfaces for restricting an aperture angle of the first binding rod 220 and the second binding rod 230 at an angle, for example, approximately 60 to 70 degrees, which permits easy insertion of the leaf 310.

The aperture angle restricting portion 270 of the first binding device member 218A has in cross-section a substantially semicircular-arc shape formed continuously to a first receiving portion 80 of the first connecting portion lower portion 258 of the first connecting portion 250, and includes a contact surface 270a extending downwardly from the first connecting portion lower portion 258. On the other hand, the aperture angle restricting portion 272 of the second binding device member 218B has in cross-section a substantially semicircular-arc shape formed continuously to a second receiving portion 290 of the second connecting portion lower portion 268 of the second connecting portion 260, and includes a contact surface 272a extending downwardly from the second connecting portion lower portion 268.

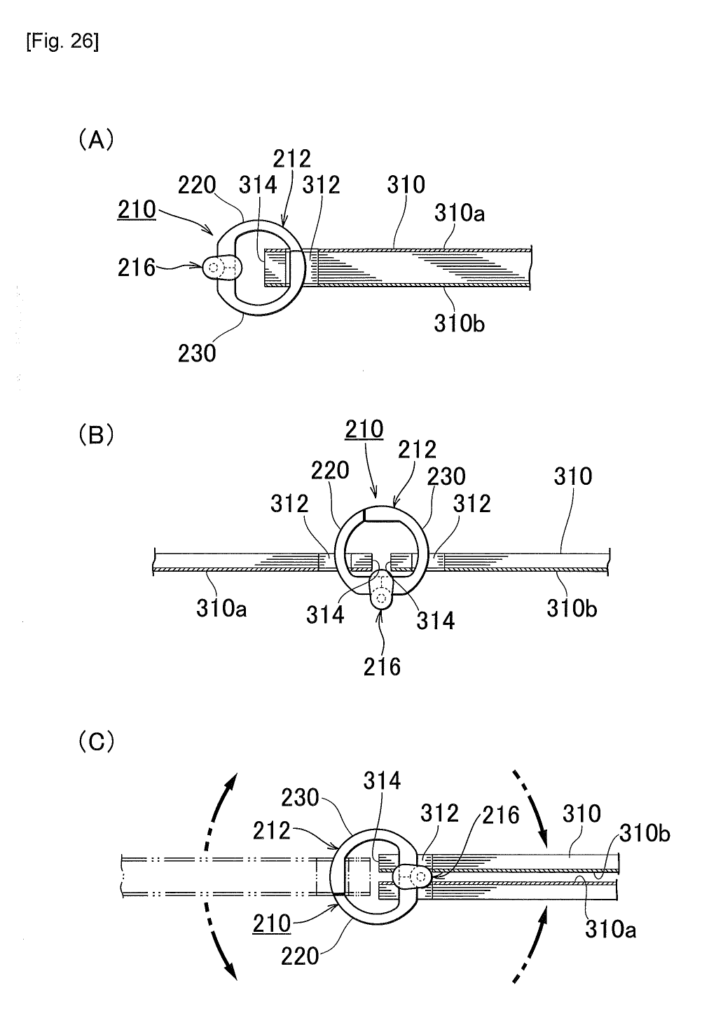

Moreover, when the binding rod portion 212 is closed, the contact surface 270a of the aperture angle restricting portion 270 and the contact surface 272a of the aperture angle restricting portion 272 are inclined surfaces opposing each other with an aperture of approximately 70 degrees, as shown in FIG. 25. When the binding rod portion 212 is opened, the contact surface 270a of the aperture angle restricting portion 270 and the contact surface 272a of the aperture angle restricting portion 272 make contact with each other, restricting the aperture angle of the half rod 210A and the half rod 230A at the angle which permits the easy insertion of the leaf 310, as shown in FIG. 26.

The pivot coupling portion 216 includes a shaft portion 300 and receiving portions for the shaft portion 300.

The receiving portions are composed of the first receiving portions 280 each provided continuously to the first connecting portion 250 and the second receiving portions 290 each provided continuously to the second connecting portion 260. The shaft portion 300 extends continuously from the far side to the near side along the longitudinal direction of the connecting portions 214, and couples together the first binding device member and the second binding device member.

The first receiving portion 280 and the second receiving portion 290 are provided continuously to the binding rod portion 212 and/or the connecting portions 214, and have aperture portions (aperture portion 284 of the first receiving portion 280 and aperture portion 294 of the second receiving portion 290) formed on their side surfaces for filling the shaft portion 300 therein, and are configured in such a manner as to serve as a rotation center upon closing with the tips of the half rod 220A and the half rod 230A brought into contact with each other and upon separation of the tips of the half rod 220A and the half rod 230A from each other so that the leaf 310 bound at the first binding rods 220 and the second binding rod 230 can be flipped along the first binding rod 220 and the second binding rods 230 and then flipped over through 360 degrees.

The first receiving portion 280 and the second receiving portion 290 are formed intermittently in the longitudinal direction of the connecting portions 214, and formed in such a manner as that the first receiving portion 280 and the second receiving portion 290 relatively move in the longitudinal direction when the half rod 220A and the half rod 230A turn with respect to the shaft portion 300 as a center and also the first binding rod 220 and the second binding rod 230 are opened/closed.

The shaft portion 300 is a rod-like metal bar of a circular shape in cross section. In correspondence therewith, the first receiving portion 280 and the second receiving portion 290 are arc-shaped as a whole, and the shaft portion 300 is filled in a circular-arc portion 286 and a circular-arc portion 296 inside the first receiving portion 280 and the second receiving portion 290, and to outer upper portions thereof, the connecting portions 214 are provided continuously in such a manner as to protrude in directions opposite to directions in which the half rod 220A and the half rod 230A protrude.

In this embodiment, the shaft portion 100, the first receiving portion 80, and the second receiving portion 90 are different members. The first receiving portion 80 is integrally formed with the first binding device member 18A by using synthetic resin, and the second receiving portion 90 is integrally formed with the second binding device member 18B by using synthetic resin.

Moreover, the shaft portion 300 is so formed as to extend from the first receiving portion 280 on the furthest side of the first binding device member 218A to the second receiving portion 290 on the nearest side of the second binding device member 218B.

The first receiving portion 280 on the first binding device member 218A side has a first housing portion 282 intermittently formed between this first receiving portion 280 and the adjacent first receiving portion 280 when the shaft portion 300 is filled, and the second receiving portion 290 on the second binding device member 218B side has a second housing portion 292 intermittently formed between this second receiving portion 290 and the adjacent second receiving portion 290 when the shaft portion 300 is filled.

Moreover, when the first binding rods 220 and the second binding rods 230 are closed, on an axis line of the pivot coupling portion 216, the first binding device member 218A has the first housing portions 282 housing the second receiving portions 290 of the second binding device member 218B and the second binding device member 218B has the second housing portions 292 housing the first receiving portions 280 of the first binding device member 218A. The first receiving portions 280 and the second receiving portions 290 are aligned with an appropriate space between each of the first receiving portions 280 of the first binding device member 218A and the second receiving portion 290 of the second binding device member 218B adjacent thereto and between each of the second receiving portions 290 of the second binding device member 218B and the first receiving portion 280 of the first binding device member 218A adjacent thereto. The appropriate space between each of the first receiving portions 280 of the first binding device member 218A and the second receiving portions 290 of the second binding device member 218B adjacent thereto and between each of the second receiving portions 290 of the second binding device member 218B and the first receiving portions 280 of the first binding device member 218A adjacent thereto refers to as a length required for relatively moving the first binding rod 220 and the second binding rod 230 in the longitudinal direction of the connecting portions 214, in other words, to the near side and the far side to thereby disengage the first binding rod latching portion 222 and the second binding rod latching portion 232.

In addition, the first binding device member 218A and the second binding device member 218B are slidably mounted at the shaft portion 300 so that the half rod 220A and the half rod 230A relatively move upon opening/closing of the first binding rod 220 and the second binding rod 230.

In this embodiment, the first binding rod 220 of the first binding device member 218A is moved to the far side and the second binding rod 230 of the second binding device member 218B is moved to the near side to open the closed first binding rod 220 and second binding rod 230.

In this embodiment, the aperture portion 284 of the first receiving portion 280 on the far side of the first binding device member 218A is covered on the far side. On the other hand, the aperture portion 294 of the second receiving portion 290 on the near side of the second binding device member 218B is covered on the near side. Accordingly, the first receiving portion 280 on the far side prevents a far-side end of the shaft portion 300 from coming off, and the second receiving portion 290 on the near side prevents a near side end of the shaft portion 300 from coming off.

An outer periphery portion of the base portion 220a of the half rod 220A and an outer periphery portion of the base portion 230a of the half rod 230A are formed with their lower portions located at the same positions as those of the lower portions of the connecting portions 214. An outer side of the first receiving portion 280 and an outer side of the second receiving portion 290 of the pivot coupling portion 216 are formed with their upper portions located at the same positions as those of the lower portions of the connecting portions 214.

In this embodiment, the first receiving portion 280 of the pivot coupling portion 216 has the aperture portion 284 making contact with the outer periphery portion of the half rod 220A, and the second receiving portion 290 of the pivot coupling portion 216 has the aperture portion 294 making contact with the outer periphery portion of the half rod 230A. The first connecting portion 250 has a height between an inner periphery portion of the half rod 220A and the aperture portion 284 of the first receiving portion 280, and the second connecting portion 260 has a height between an inner periphery portion of the half rod 230A and the aperture portion 294 of the second receiving portion 290.

A width of the connecting portions 214 (in a width direction) is equal to or smaller than half a width of the first receiving portion 280 of the pivot coupling portion 216 or the second receiving portion 290 of the pivot coupling portion 216 (in a width direction). This configuration is provided since if a width obtained by adding together a width of the first connecting portion 250 and a width of the second connecting portion 260 is equal to or smaller than the width of the first receiving portion 280 of the pivot coupling portion 216 and the width of the second receiving portion 290 of the pivot coupling portion 216, when the leaf 310 is flipped over through 360 degrees and the front side and the reverse side of the leaf 310 are brought into contact with each other with the pivot coupling portion 216 sandwiched therebetween, this contact can be made without space relatively.

Between the first housing portion 282 of the first binding device member 218A located in the vicinity of the center of the first connecting portion 250 and the second housing portion 292 of the second binding device member 218B located in the vicinity of the center of the second connecting portion 260, a elastic member 302 which applies tension (tensile or compressive force) in the longitudinal direction of the shaft portion 300 is fitted in a compressed state. The elastic member 302 is formed of a coil spring made by winding a steel wire into a coil form, and the shaft portion 300 is inserted into the loop of the tube-shaped coil spring.

Moreover, the elastic member 302 has a far-side end making contact with the near-side end of the second receiving portion 290 of the second binding device member 218B and has a near-side end making contact with a far-side end of the first receiving portion 280 of the first binding device member 218A. The elastic member 302 is so configured as to press down the first binding device member 218A to the near side and to press up the second binding device member 218B to the far side by (uniform) restoring force.

Thus, the elastic member 302 operates in the direction engaging the binding rod latching portion 222 of the first binding rod with the binding rod latching portion 232 of the second binding rod when the binding rod portion 212 is closed.

The pressing portion 340 formed in the connecting region is formed into a columnar shape or a block-like shape in order to displace the first binding rod 220 or the second binding rod 230 in the longitudinal direction of the connecting portions 214, which is the extending direction of the center for opening/closing the first binding rod 220 and the second binding rod 230, and disengage the binding rod latching portion 222 of the first binding rod and the binding rod latching portion 232 of the second binding rod.

The pressing portions 340 are composed of the first pressing portion 342 provided to project from the lower end portion of the first connecting portion 250, wherein the first and second pressing portions are in the longitudinal direction of the connecting portions 214, composing the coupling region of coupling the first binding device member 218A and the second binding device member 218B and the height direction which is the extending direction of the center for opening/closing the first binding rod 220 and the second binding rod 230. The pressing portions 340 are not composed of the second pressing portion 144 provided to project from the upper end portion of the second connecting portion 260 of the aforementioned embodiment.

The first pressing portion 342 is a cylindrical rod body, which extends from the lower end portion of the lower side of the first connecting portion 250 to the opposite side of the direction for moving the first connecting portion 250 upon disengagement of the binding rod latching portion 222 of the first binding rod of the first binding device member 218A, in other words, to the near side (lower side), and the first pressing portion 342 is formed to have a size extending to the near side of the second connecting portion 260 and is formed so that the area for pressing is large.

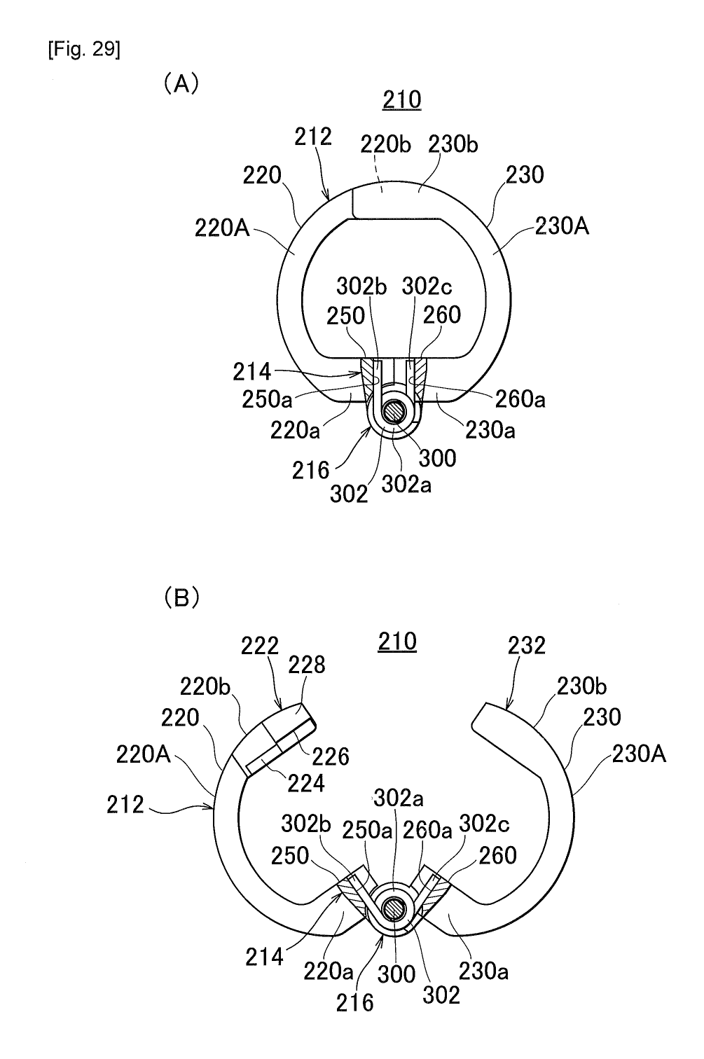

As shown in FIG. 29, the binding rod latching portion 222 of the first binding rod and the binding rod latching portion 232 of the second binding rod are disengaged, for example, by placing the thumb on the first pressing portion 342, pinching the second binding rod 230 by the fingers of the other hand, and pressing the first pressing portion 342 toward the far side (upper side).

Then, as shown in FIG. 26, the first binding rod 220 is turned in the direction opposite to the direction in which the first binding rod 220 and the second binding rod 230 are extending, thereby opening the binding rod portion 212.

The binding device 210 forms a notebook by binding the leaf 310 in such a manner that the binding holes 312 continuously provided at appropriate intervals in a height direction of the leaf 310 are penetrated by the first binding rods 220 and the second binding rods 230, the pivot coupling portion 216 is situated on a side of a binding margin side edge 314 extending in the height direction of the leaf 310, and the first binding rods 220 and the second binding rods 230 bridge between the binding holes 312 and the binding margin side edge 314.

The binding device 210 may form a notebook by binding the leaf 310 in such a manner that a length direction of the binding device 210 spread spatially while extending in the width direction of the leaf 310 having the binding holes 312 formed at the edge extending in the width direction.

The leaf 310 bound by the binding device 210 can be used for writing or otherwise in such a manner that the leaf 310 is flipped over to the pivot coupling portion 216 side and a leaf front side 310a and a leaf reverse side 310b are brought into contact with each other with the pivot coupling portion 216 sandwiched therebetween when the leaves are laid during closing, as shown in FIG. 26.

According to the embodiment of the present invention, the binding rod portions 212 and the connecting portions 214 are formed at each of the first binding device member 218A and the second binding device member 218B in a pair, and the binding rods 220 and 230 composing the binding rod portions 212 are provided at the appropriate intervals in the longitudinal direction of the connecting portions 214 in such a manner as to project from the outer portion or the upper portion of the connecting portions 214 so that the first binding rods 220 on the first binding device member 218A side and the second binding rods 230 on the second binding device member 218B side face each other. Therefore, when the binding rod portions 212 are opened, lowest portions of the binding rod portions 212 are grounded on a surface of, for example, a desk top plate to be thereby easily horizontally stabilized, and also the binding rod portions 212 can be easily opened at an appropriate degree.

According to the embodiment of the present invention, the binding rod portion 212 includes the first binding rod 220 and the second binding rod 230 in the symmetrical form separated to the left and right with respect to the pivot coupling portion 216 as the center, and the connecting portions 214 includes the first connecting portion 250 and the second connecting portion 260 in the symmetrical form separated to the left and right with respect to the pivot coupling portion 216 as the center. Therefore, the left and right members can be formed with the same die, which makes it easy to manufacture them.

According to the embodiment of the present invention, the connecting portions 214 includes: the mutually facing opposing portions 256 and 266 of the first connecting portion 250 and the second connecting portion 260; the outer portions 252 and 262 which oppose the opposing portions 256 and 266 and from which the binding rods 220 and 230 are provided in such a manner as to project; and the lower portions 258 and 268 which are surfaces crossing the opposing portions 256 and 266 and the outer portions 252 and 262 between the opposing portions 256 and 266 and the outer portions 252 and 262 and to which the pivot coupling portion 216 is provided continuously. Therefore, the first coupling portion opposing portion 256 and the second connecting portion opposing portion 266 are planes orthogonal to the turning directions and spatially spreading in such a manner as to extend perpendicularly, in other words, the height direction when the binding device 210 is closed. Forming the first coupling portion opposing portion 256 and the second coupling portion opposing portion 266 in such a manner as to bring them into close contact with each other when the binding device 210 is closed can stably maintain condition of the engagement between the binding rod latching portion 222 of the first binding rod and the binding rod latching portion 232 of the second binding rod when the binding device 210 is closed, which can reduce shrinking action of an annular diameter formed by the first binding rod 220 and the second binding rod 230 composing the binding rod portion 212.

According to the embodiment of the present invention, the receiving portions 280 and 290 are formed intermittently in the longitudinal direction of the connecting portions 214, and formed in such a manner that the binding rod portions 212 turn with respect to the shaft portion 300 as the center and relatively move in the longitudinal direction upon opening/closing of the binding rod portions 212. Therefore, the binding rod portion 212 composed of plural binding rods 220 and 230 can be opened and closed at once.

According to the embodiment of the present invention, the shaft portion 300 is of a circular rod shape in cross section, the receiving portions 280 and 290 are arc-shaped as a whole, the shaft portion 300 is filled in the arc portions therein, and to the outer upper portions thereof, the connecting portions 214 are provided continuously in such a manner as to protrude in the directions opposite to the directions in which the binding rods 220 and 230 protrude. Therefore, the binding rod portions 212 composed of the plurality of binding rods 220 and 230 can be opened/closed at once, the lowest portions of the binding rod portions 212 are grounded on the surface of, for example, the desk top plate to be thereby easily horizontally stabilized, and the binding rod portions 212 can easily be opened at the appropriate degree.

According to the embodiment of the present invention, the base portions 220a and 230a of the binding rods 220 and 230 are formed with their lower portions located at the same positions as those of the lower portions of the connecting portions 214, and the receiving portions 280 and 290 of the pivot coupling portion 216 are formed with their upper portions located at the same positions as those of the lower portions of the connecting portions 214. Therefore, when the binding rod portions 212 are opened, the lowest portions of the binding rod portions 212 are grounded on the surface of, for example, the desk top plate to be thereby easily horizontally stabilized, and the binding rod portions 212 can easily be opened at the appropriate degree.

According to the embodiment of the present invention, the width of the connecting portions 214 is equal to or smaller than half the width of the pivot coupling portion 216. Therefore, it does not extend beyond the width of the pivot coupling portion 216, and when the leaf 310 is flipped along the binding rods 220 and 230 and opened through 360 degrees, the space between the front side and the reverse side of the leaf 310 is small, thus providing relative flatness, which also makes writing easier.

According to the embodiment of the present invention, the receiving portions 280 and 290 of the pivot coupling portion 216 have the aperture portions 284 and 294 of the receiving portions 280 and 290 making contact with the outer periphery portions of the binding rods 220 and 230, and the connecting portions 214 have height from the inner periphery portions of the binding rods 220 and 230 to the aperture portions 284 and 294 of the receiving portions 280 and 290. Therefore, when the leaf 310 is flipped along the binding rods 220 and 230 and opened through 360 degrees, the space between the leaf front side 310a and the leaf reverse side 310b is small, thus providing relative flatness, which also makes writing easier.

According to the embodiment of the present invention, the binding rod latching portions 222 and 232, in order to be engaged or disengaged in the turning directions of the binding rods 220 and 230, are so configured as to engage the projection 224 and the recess 226 of the first binding rod 220 and the recess 236 and the projection 234 of the second binding rod 230, and the binding rod latching portions 222 and 232, in order not to be disengaged in the turning directions of the binding rods 220 and 230 and the direction crossing the turning directions when the binding rods portions 212 are closed, have the disengagement preventing portions 228 and 238 so formed as to extend in the direction crossing the turning directions of the binding rods 220 and 230. Therefore, the binding rod latching portions 222 and 232 of the closed binding rods are hard to be disengaged in the turning directions of the binding rods 220 and 230 and the direction crossing the turning directions.

The binding device 210 of the embodiment of the present invention can form a datebook or a notebook bound with the binding rod portions 212 of the binding device 210 penetrated through the binding holes 312 of the leaf 310, and can form a file, a binder, or the like by being fixed on the cover including the front cover, the back cover, and a spine.

The elastic member 302 may be configured in the below manner.

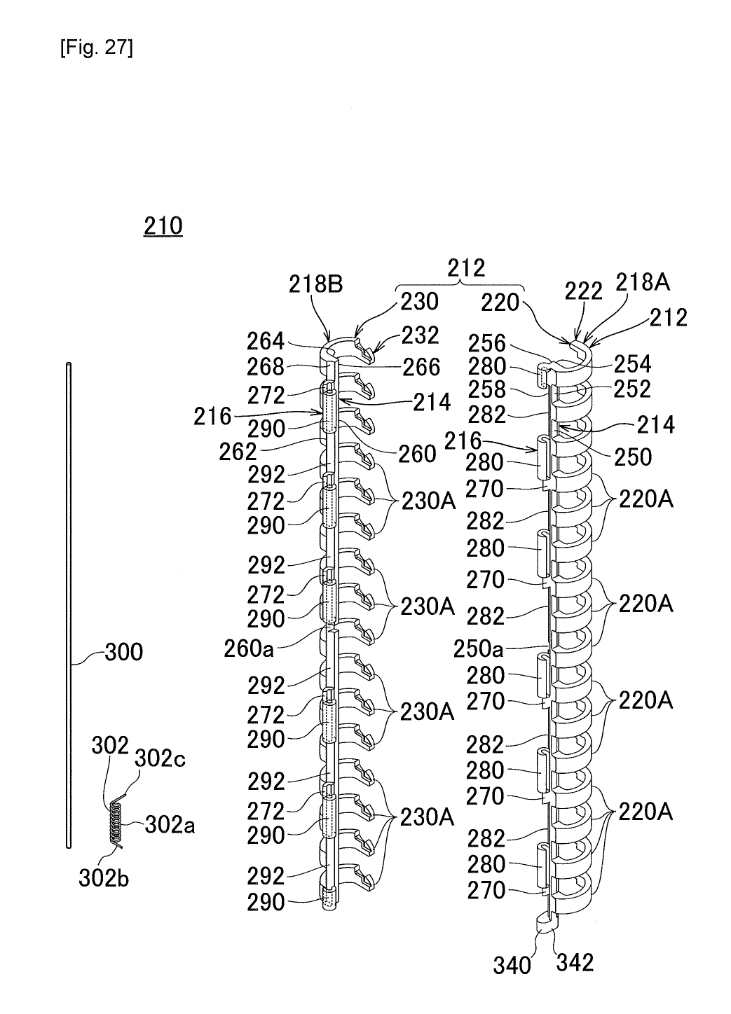

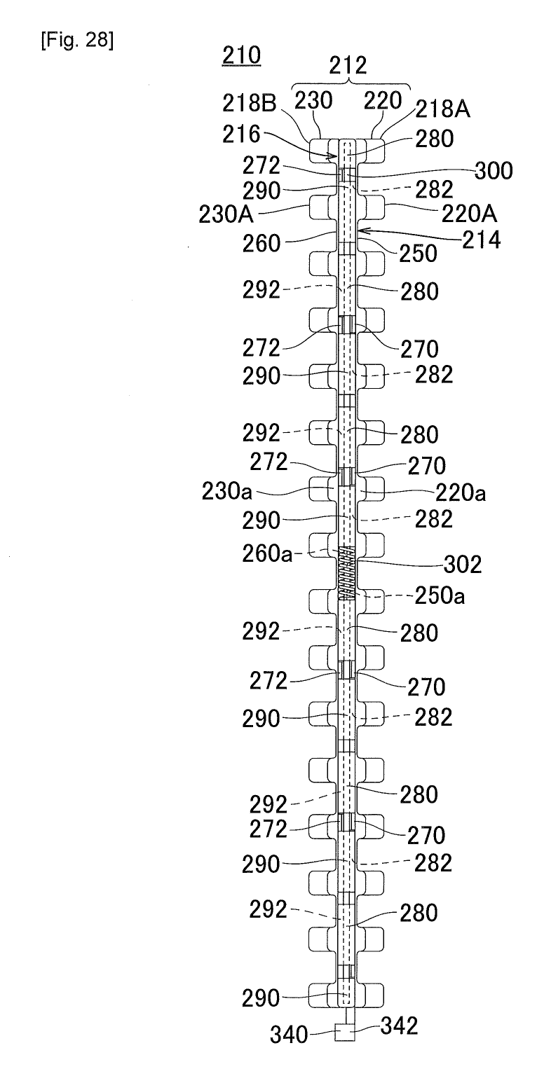

FIG. 27 is a schematic perspective view of a disassembled state of a binding device of a modification example. FIG. 28 is a schematic back view of the binding device in a closed state of the binding device shown in FIG. 27. FIG. 29 is a schematic cross-sectional view of the binding device shown in FIG. 19, wherein (A) is a schematic cross-sectional view of a closed state, and (B) is a schematic cross-sectional view of an opened state.

The elastic member 302 shown in FIG. 27 is composed of a torsion coil spring. A coil portion 302a, a linear first fixing tip portion 302b, and a linear second fixing tip portion 302c are continuously provided, wherein the first and second fixing tip portions 302b and 302c are extending in the direction orthogonal to or intersecting with the central axis of the coil portion 302a from both ends of the coil portion 302a. In the original state in which no torsion moment is generated, the first fixing tip portion 302b and the second fixing tip portion 302c are projecting in the tangent direction of the coil portion 302a.

In order to support the tip portions extending from the both ends of the coil portion 302a of the elastic member 302, a support portion 250a and a support portion 260a are formed in the connecting portion 214.

The fixing tip portions extending from the both ends of the coil portion 302a of the elastic member 302 are latched and supported by the support portion 250a, which is formed in the first connecting portion 250 of the first binding device member 218A, and the support portion 260a of the second connecting portion 260 of the second binding device member 218B opposed to the support portion 250a.

In other words, the first fixing tip portion 302b in one side is supported by the support portion 250a of the first connecting portion 250, and the second fixing tip portion 302c in the other side is supported by the support portion 260a of the second connecting portion 260 so as to be opposed to the first fixing tip portion 302b.

When the binding rod latching portion 222 of the first binding rod and the binding rod latching portion 232 of the second binding rod, which are latched with each other, are to be detached from each other by pressing the pressing portions 340 by fingers, the first fixing tip portion 302b is supported by the support portion 250a of the first connecting portion 250 in the side opposite to the moving direction thereof, and the second fixing tip portion 302c in the other side is supported by the support portion 260a of the second connecting portion 260 in the side opposite to the moving direction thereof.

The fixing tip portion 302b in one side and the fixing tip portion 302c in the other side have been originally in an opened state. However, when the first binding rod 220 and the second biding rod 230 are in a closed state, the first fixing tip portion 302b and the second fixing tip portion 302c, which have been moved from the original opened state to be close to each other approximately in parallel, are supported by the support portion 250a and the support portion 260a of the connecting portions 214. In other words, the elastic member 302 is in a twisted state, in which the first fixing tip portion 302b is latched by the support portion 250a of the first connecting portion 250, and the second fixing tip portion 302c is latched by the support portion 260a of the second connecting portion 260.

Moreover, the elastic member 302 has a far-side end making contact with the near-side end of the second receiving portion 290 of the second binding device member 218B and has a near-side end making contact with a far-side end of the first receiving portion 280 of the first binding device member 218A. The elastic member 302 is so configured as to press down the first binding device member 218A to the near side and to press up the second binding device member 218B to the far side by (uniform) restoring force.

Thus, the elastic member 302 operates in the direction engaging the binding rod latching portion 222 of the first binding rod with the binding rod latching portion 232 of the second binding rod when the binding rod portion 212 is closed.

When the binding rod latching portion 222 of the first binding rod and the binding rod latching portion 232 of the second binding rod, which are latched with each other, are to be detached by pressing the pressing portions 340 by fingers, against the spring force of the elastic member 302, the first binding rod 220 of the first binding device member 218A is moved to the far side, and the second binding rod 230 of the second binding device member 218B is moved to the near side, thereby opening the first binding rod 220 and the second binding rod 230, which have been closed.

When the pressing portions 340 are pressed by fingers to relatively move the first connecting portion 250 of the first binding device member 218A and the second connecting portion 260 of the second binding device member 218B in mutually opposite directions, the first connecting portion 250 and the second connecting portion 260 are turned in the turning direction since the force that returns the elastic member 302 to the original state works, in other words, the force works so that the first fixing tip portion 302b in one side and the second fixing tip portion 302c in the other side are turned in the turning direction and open the binding rod portion 212.

In this manner, in the present embodiment, when the binding rod latching portion 222 of the first binding rod and the binding rod latching portion 232 of the second binding rod are disengaged from each other, the state that the first binding rod 220, the first connecting portion 250, the second binding rod 230, and the second connecting portion 260 are opened is obtained since the force that separates the first fixing tip portion 302b in one side and the second fixing tip portion 302c in the other side from each other in the circumferential direction works.

Next, a binding device according to another embodiment is explained in addition.

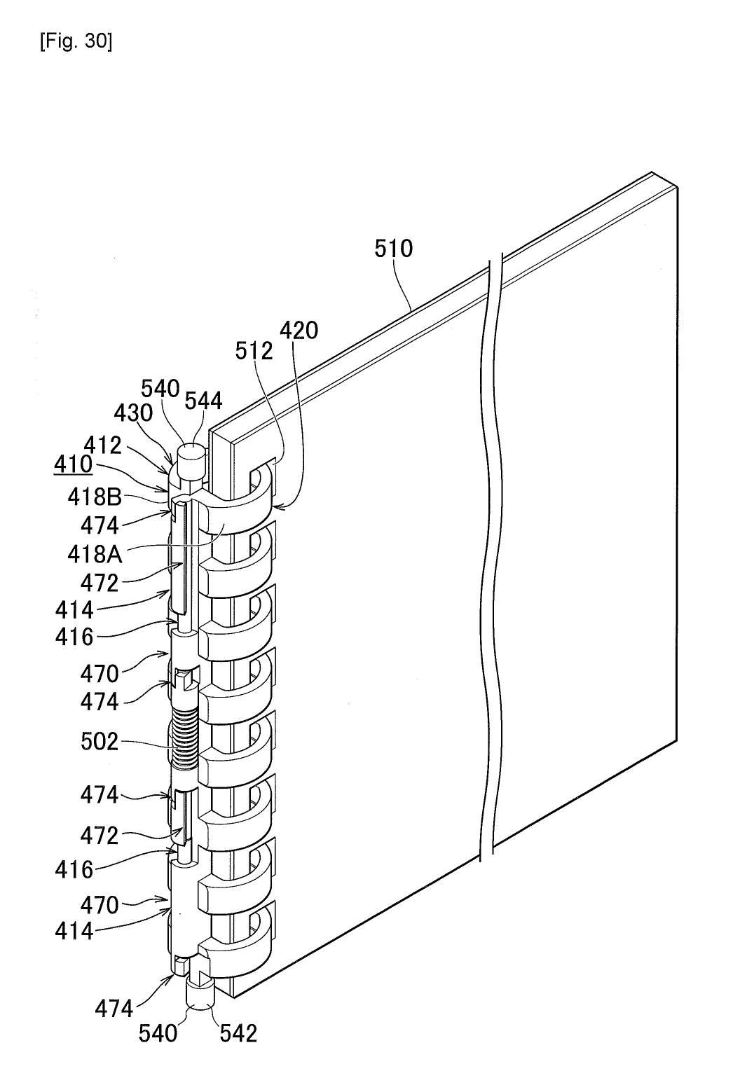

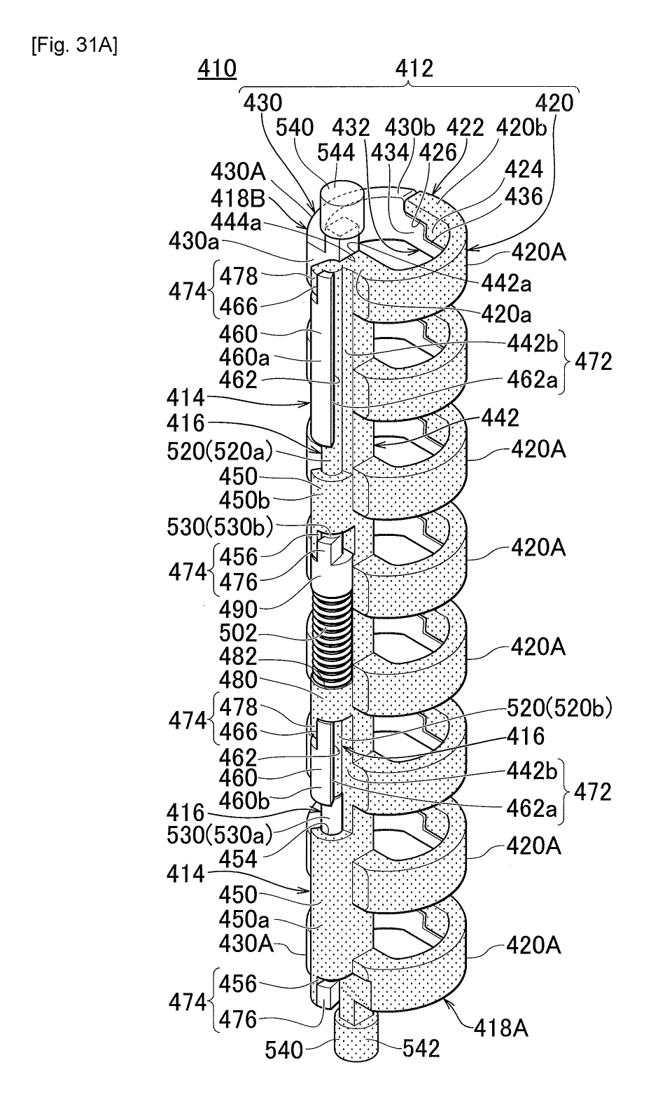

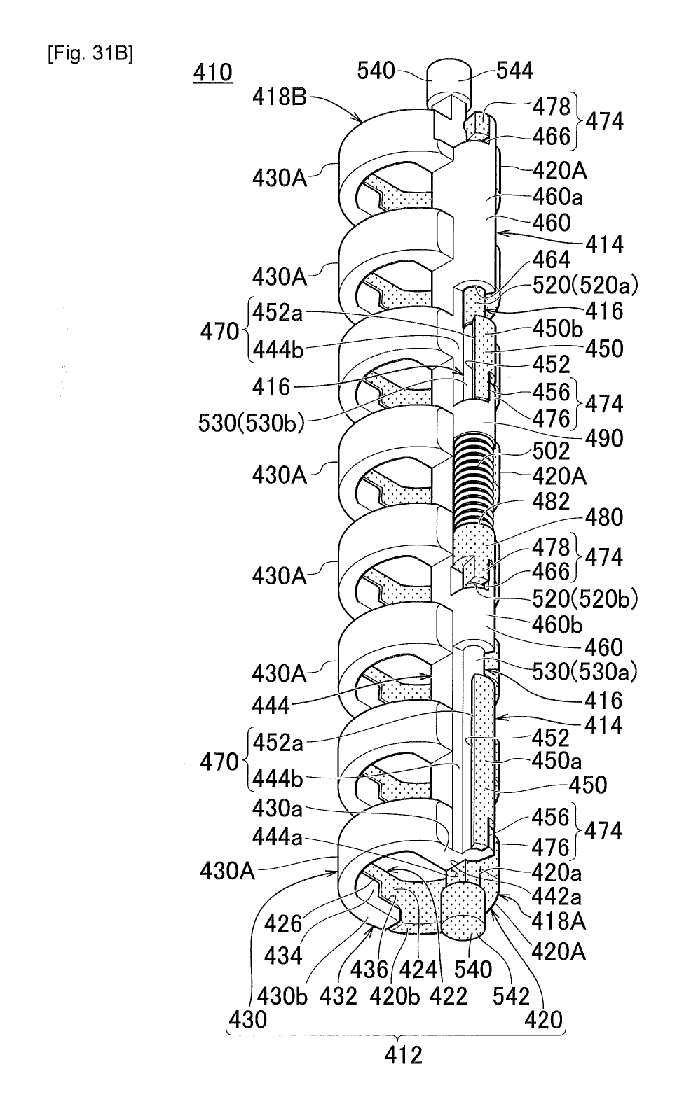

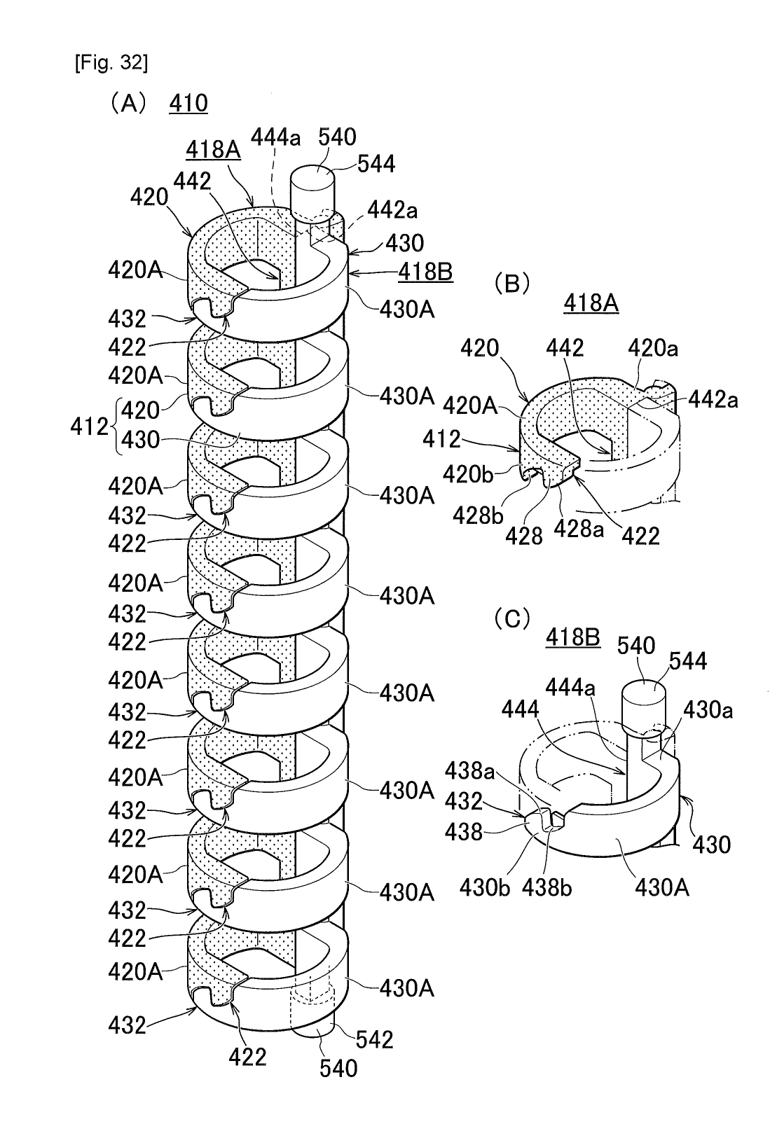

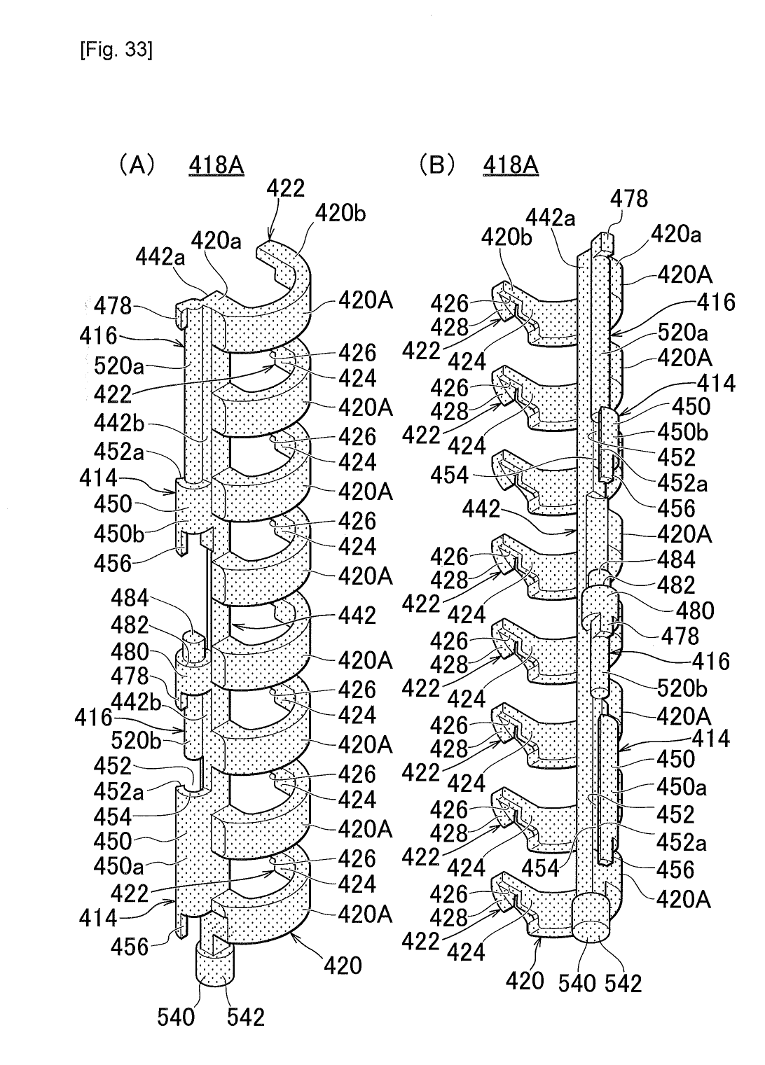

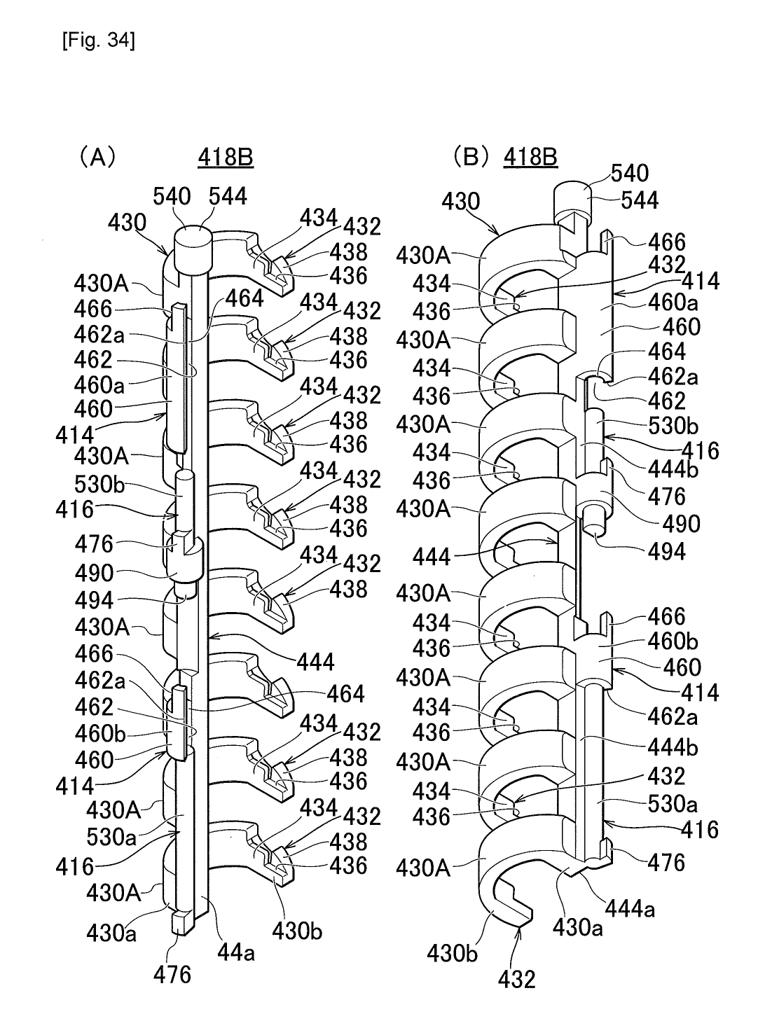

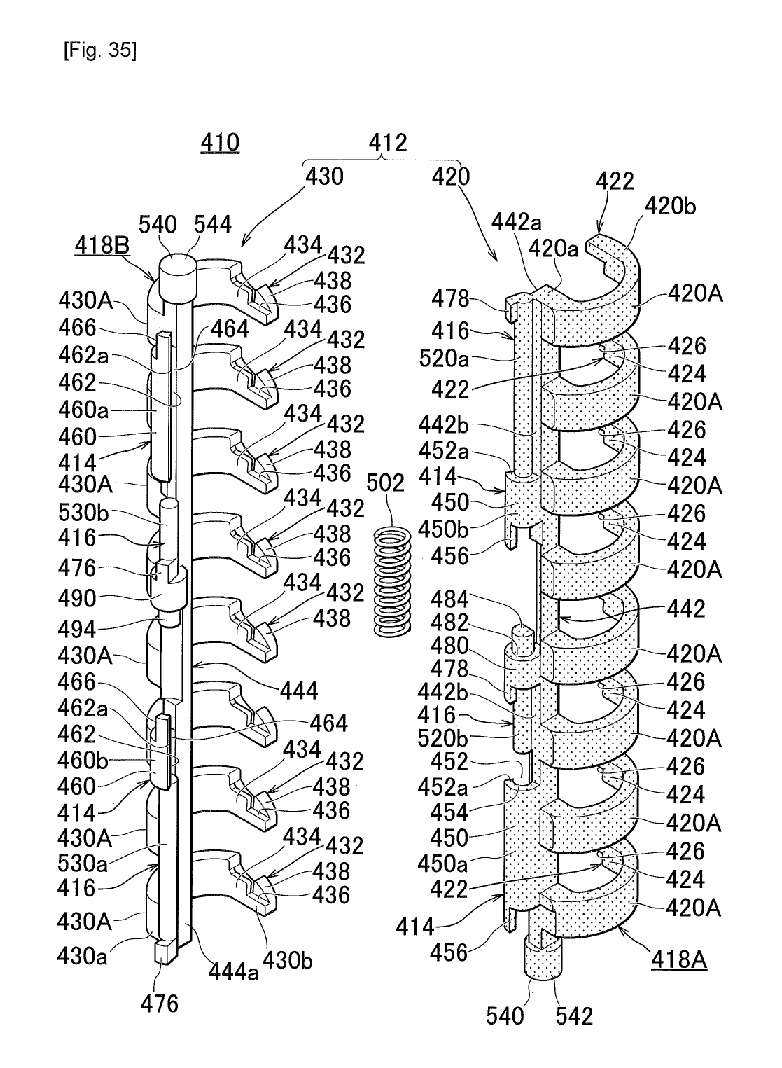

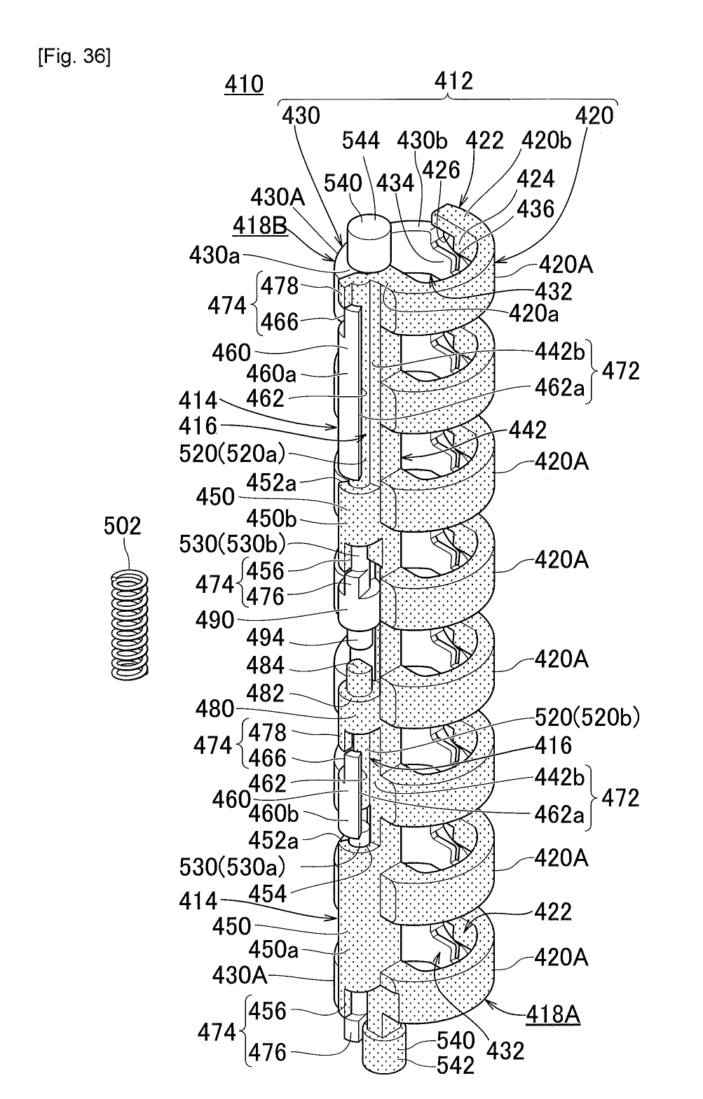

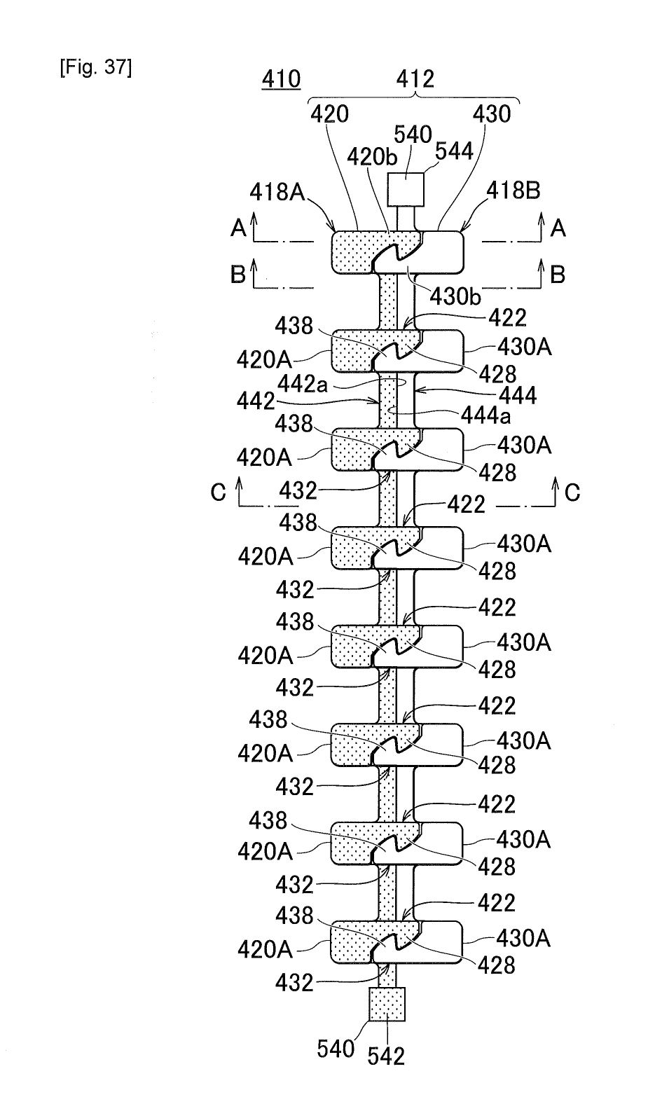

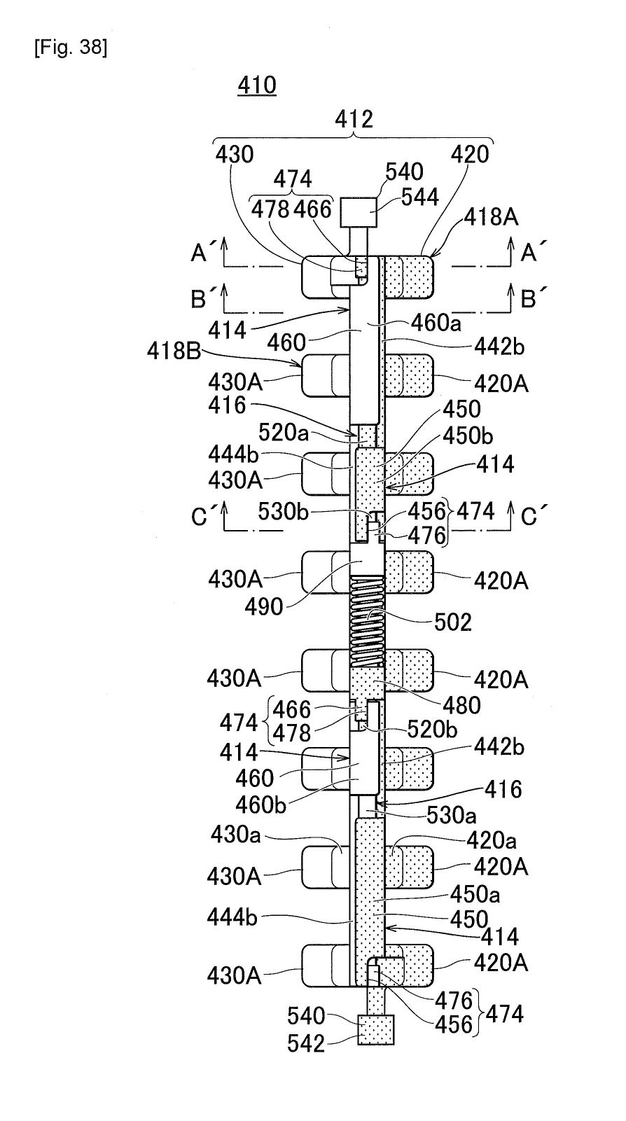

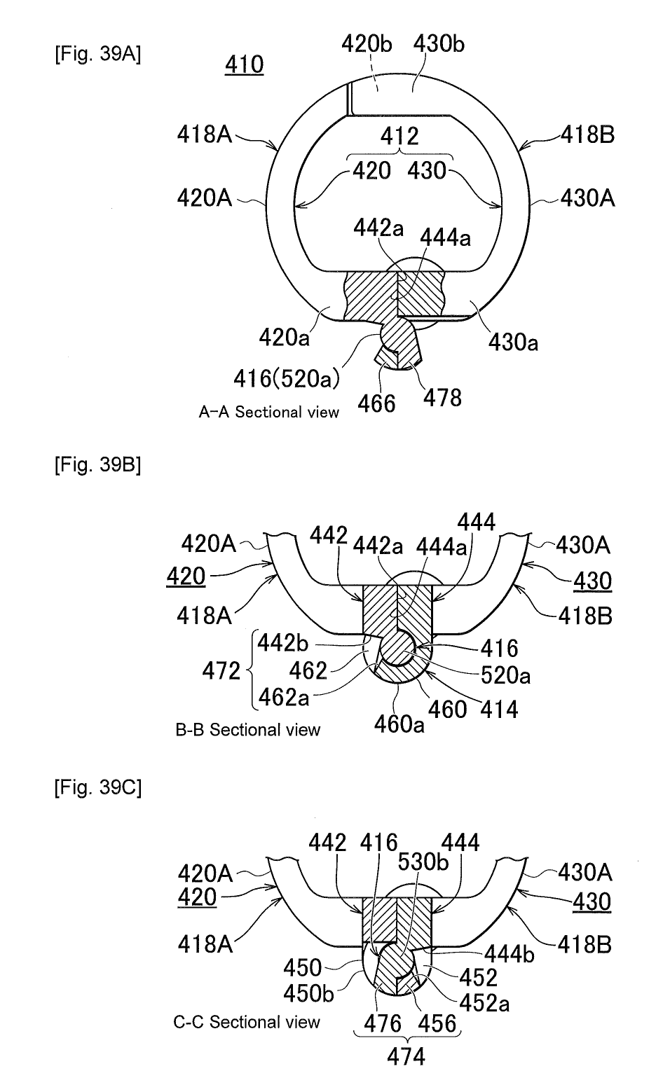

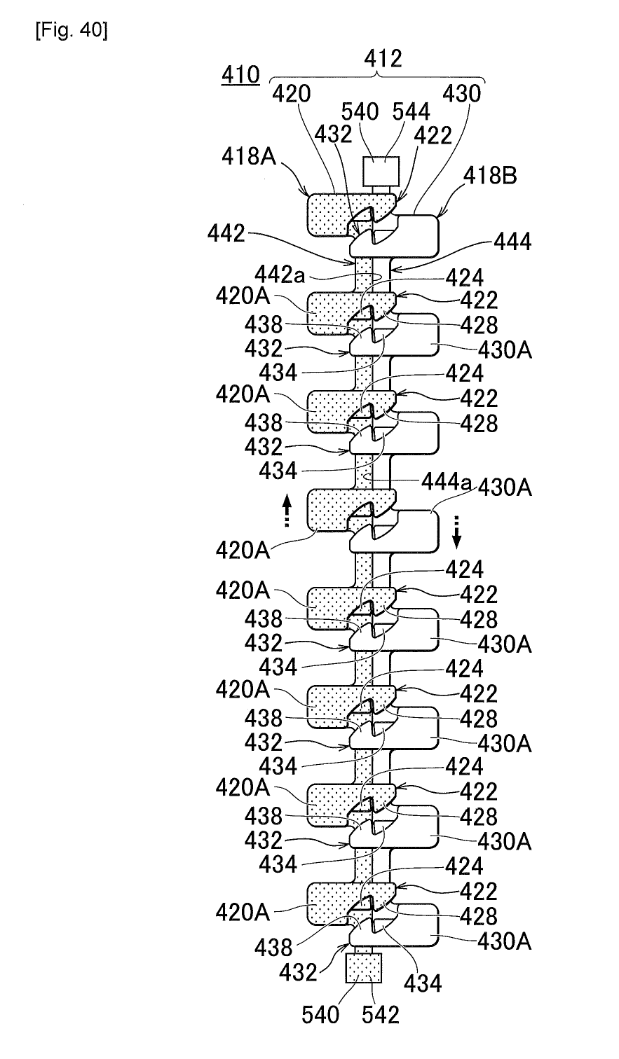

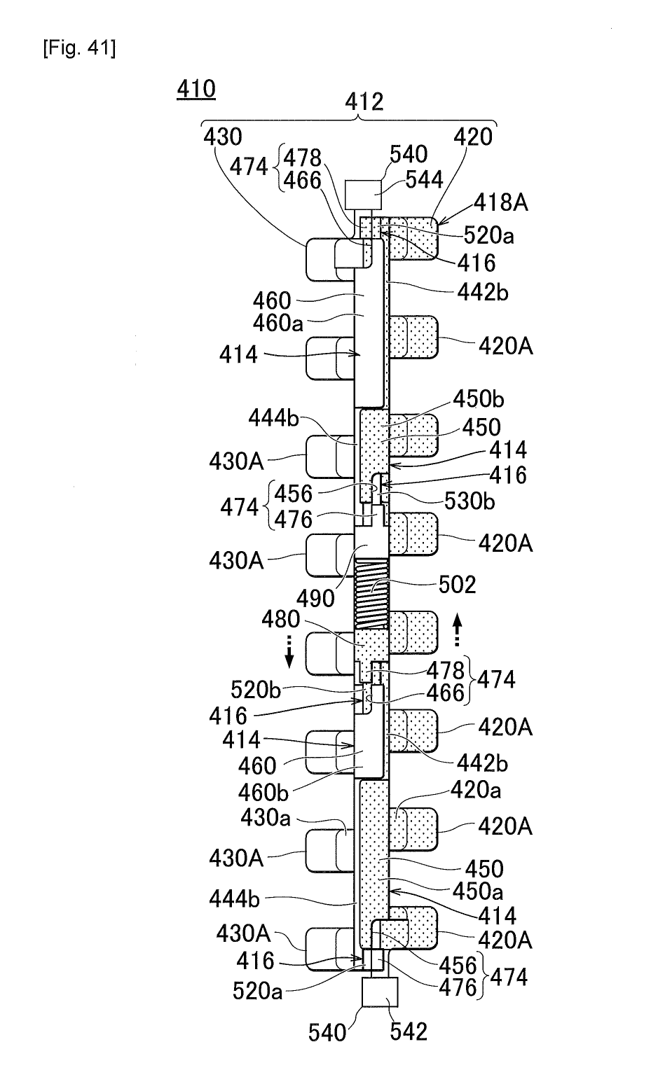

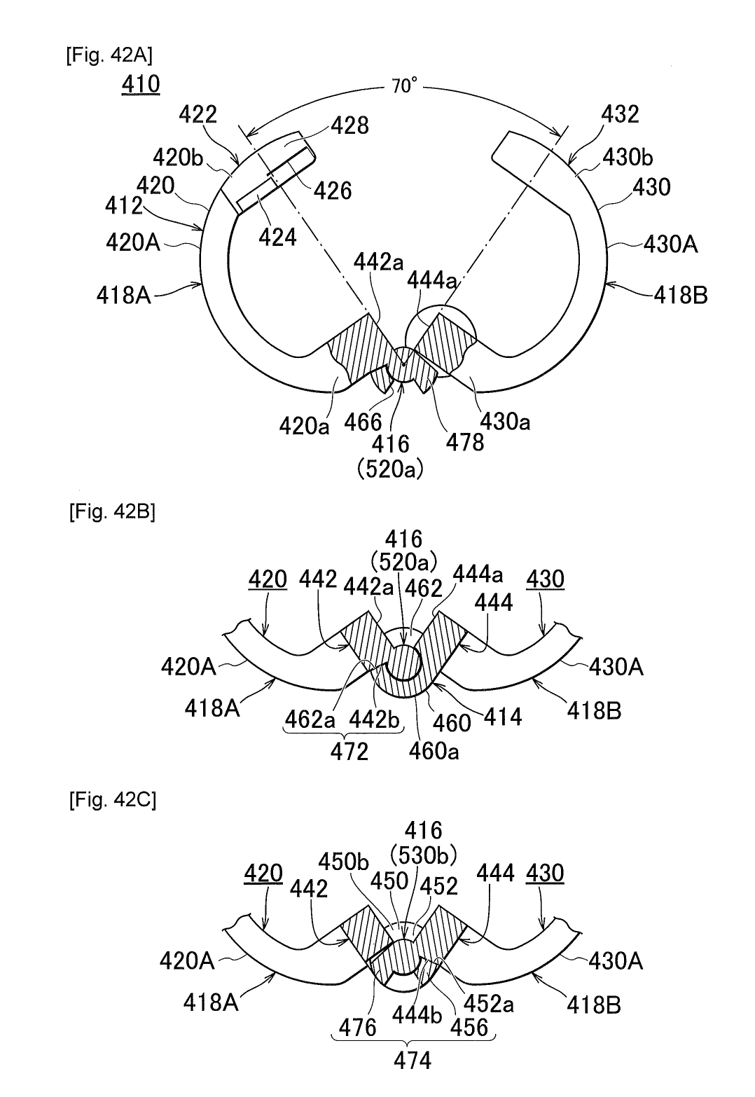

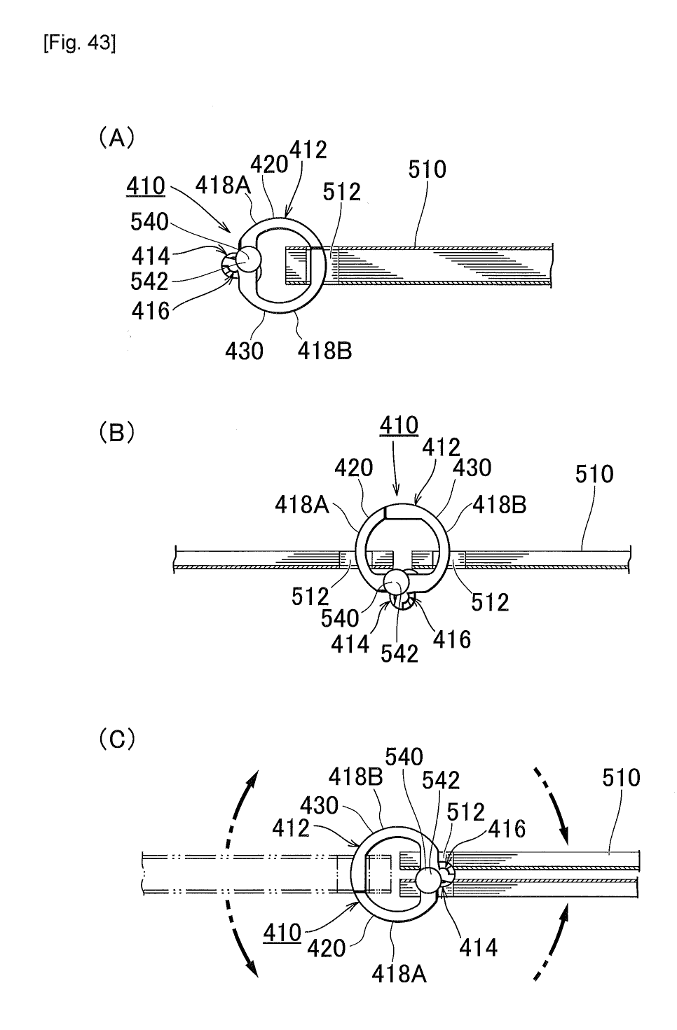

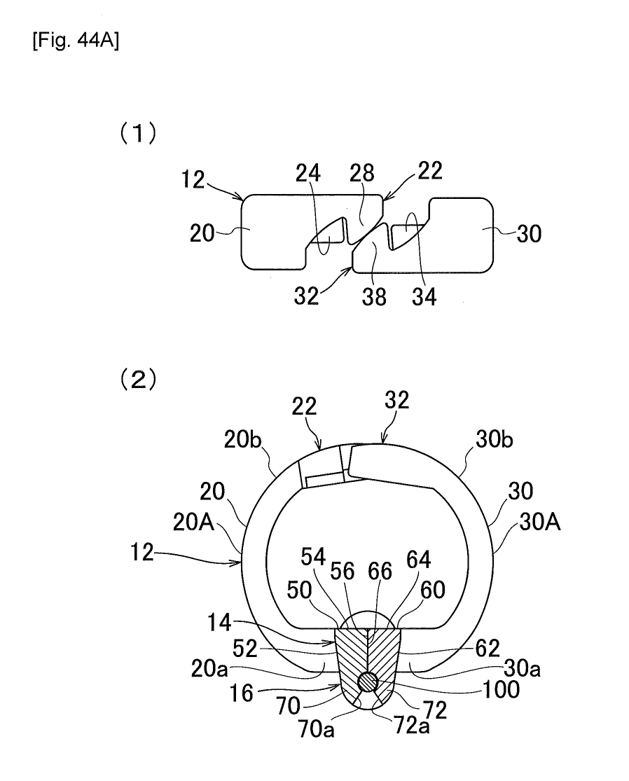

FIG. 30 is a schematic perspective view of a datebook using a binding device according to the present invention. FIG. 31A is a schematic perspective view of the entire binding device according to the present invention. FIG. 31B is a schematic perspective view of the entire binding device according to the present invention. FIG. 32 is a schematic perspective view of the binding device according to the present invention, wherein (A) is an overall view, and (B) and (C) are views of half rods. FIG. 33 is a schematic perspective view of a first binding device member, wherein (A) is a right-side view, and (B) is a left-side view. FIG. 34 is a schematic perspective view of a second binding device member, wherein (A) is a right-side view, and (B) is a left-side view. FIG. 35 is a schematic perspective view of the binding device according to the present invention in a disassembled state. FIG. 36 is a schematic perspective view showing a method of coupling the first binding device member and the second binding device member. FIG. 37 is a schematic elevation view of the binding device in a closed state. FIG. 38 is a schematic back view of the binding device in the closed state. FIG. 39A is a partial schematic cross-sectional view taken along line A-A of FIG. 37. FIG. 39B is a schematic cross-sectional view taken along line B-B of FIG. 37. FIG. 39C is a schematic cross-sectional view taken along line C-C of FIG. 37. FIG. 40 is a schematic elevation view of the binding device in an opening start state. FIG. 41 is a schematic back view of the binding device in an opening start state. FIG. 42A is a partial schematic cross-sectional view of A-A of FIG. 40. FIG. 42B is a schematic cross-sectional view of B-B of FIG. 40. FIG. 42C is a schematic cross-sectional view of C-C of FIG. 40. FIG. 43 is a schematic plan view showing a manner of opening leaves of the datebook, wherein (A) is a view of a closed state, (B) is a view of a half-flipped state, and (C) is a view of 360-degree-flipped state.

A binding device 410 of the present invention includes: a plurality of binding rod portions 412, bearing portions 414 composing a coupling region for coupling the binding rod portions 412, and pivot portions 416 composing an pivot coupling region serving as a center upon opening and closing of a first binding rod 420 and a second binding rod 430 composing the binding rod portions 412 for coupling the binding rod portions 412. The binding device 410 is configured such that the closed binding rod portions 412 can be opened by twisting the binding rod portions 412.

This binding device 410 is mainly designed for a datebook similar to a notebook typically referred to as a plastic ring type notebook and is configured so that leaves 510 can be turned along the binding rod portions 412 of the binding device 410 to be spread through 360 degrees, in other words, when the leaf 510 bound at the binding rod portions 412 is flipped along the binding rods and flipped over through 360 degrees for closing, the front side and the reverse side of the leaves 510 located at both ends can make contact with each other with the bearing portions 414 and the pivot portions 416 sandwiched therebetween.

Usually, on a front side and a reverse side of writing sheets with binding holes, covers relatively harder than the aforementioned sheets are laid. In the scope of the present specification and claims, the front side and the reverse side of the leaf 510 include the front side of a front cover on the front side and the reverse side of a back cover on the reverse side of a sheet, a pocket of synthetic resin, or the like.

The binding device 410 is composed of a first binding device member 418A and a second binding device member 418B. The first binding device member 418A and the second binding device member 418B are symmetric to each other of which center is the center of the length direction of the binding device 410, and each of the binding device members has the binding rod portions 412, the bearing portions 414, and the pivot portions 416.

The binding rod portion 412 has a first binding rod 420 of the first binding device member 418A and a second binding rod 430 of the second binding device member 418B. The first binding rods 420 and the second binding rods 430 composing the binding rod portions 412 are provided at the bearing portions 414 and the pivot portions 416, which are coupling the binding rod portions 412, to project from the outer portions or upper portions of the bearing portions 414 and the pivot portions 416 at appropriate intervals in the longitudinal direction thereof so that the first binding rod 420 of the first binding device member 418A and the second binding rod 430 of the second binding device member 418B of each pair face each other. The first binding rod 420 and the second binding rod 430 are in a symmetric form separated into the left and the right with the bearing portion 414 and the pivot portions 416 serving as the center thereof.

The plurality of first binding rods 420 are arranged in parallel in the longitudinal direction of the binding device 410 with appropriate intervals between the first binding rods 420 provided by first bridge portions 442 provided continuously to the base portions of the first binding rods 420.

The plurality of second binding rods 430 are arranged in parallel in the longitudinal direction of the binding device 410 with appropriate intervals between the second binding rods 430 provided by second bridge portions 444 provided continuously to the base portions of the second binding rods 430.

The bearing portions 414 includes a first bearing portion 450 of the first binding device member 418A and a second bearing portion 460 of the second binding device member 418B, and the first bearing portion 450 and the second bearing portion 460 have a symmetric form of which center is the center of the longitudinal direction of the binding device 410. Each of the first bearing portion 450 and the second bearing portion 460 has a solid semi-cylindrical shape linearly extending in the longitudinal direction continuously from the far side to the near side and has a substantially C-shape in cross section. The first bearing portion 450 is integrally formed to be continued to the first binding rods 420, and the second bearing portion 460 is integrally formed to be continued to the second binding rods 430.

The bearing portion 414 has a lower portion continuously provided at a position close to the base portions of the first binding rod 420 and the second binding rod 430 so that the leaves 510 bound at the binding rod portion 412 can be flipped along the first binding rod 420 and the second binding rod 430 to be flipped through 360 degrees and that the front side and the reverse side of the leaves 510 located at both ends when closed can be brought into contact with each other with the bearing portion 414 sandwiched therebetween.

The bearing portion 414 has a length extending in the direction orthogonal to the extending direction of the binding rod and has a thickness continued in the extending direction of the binding rod, and the bearing portion 414 is configured so that the leaves 510 bound at the binding portion 412 can be flipped along the binding rod portion 412 to be flipped through 360 degrees and that the front side and the reverse side of the leaves 510 at both ends when closed can be brought into contact with each other with the bearing portion 414 sandwiched therebetween. In other words, the first bearing portion 450 is provided to be continued to the base portion of the first binding rod 420, the second bearing portion 460 is provided to be continued to the base portion of the second binding rod 430, the first bearing portion 450 is bridged between the plurality of first binding rods 420 so as to mutually couple the plurality of first binding rods 420, and the second bearing portion 460 is bridged between the plurality of second binding rods 430 so as to mutually couple the plurality of second binding rods 430.

In the first bearing portion 450, an aperture portion 452 of the first bearing portion 450 to be filled with the pivot portion 416 is formed in a side surface in the side opposite to the half rod 420A. In the second bearing portion 460, an aperture portion 462 of the second bearing portion 460 is formed in a side surface in the side opposite to the half rod 430A. In the first bearing portion 450, a bearing recess 454 having an arc-shaped inner surface continued to the aperture portion 452 is formed. In the second bearing portion 460, a bearing recess 464 having an arc-shaped inner surface continued to the aperture portion 462 is formed.

The first binding device member 418A has a first receiving portion 480 provided to be continued to the base portion of the first binding rod 420, and the second binding device member 418B has a second receiving portion 490 provided to be continued to the base portion of the second binding rod 430. A housing portion 482 formed between the first receiving portion 480, which is provided to be continued to the base portion of the binding rod portion 412, and the base portion of the binding rod portion 412 is filled with a elastic member 502, which is compressed in and applies spring force in the longitudinal direction of the pivot portion 416. The first receiving portion 480, the second receiving portion 490, and the elastic member 502 serve as the center of turning when the tips of the first binding rod 420 and the second binding rod 430 are caused to meet with each other and closed and when the tips of the first binding rod 420 and the second binding rod 430 are separated from each other.

In the region(s) of one end or both ends in the extending direction of the center for opening/closing the binding rods, a pressing portion(s) 540, which simultaneously displaces in the center extending direction the plurality of opposed binding rods in one side among the binding rods constituting the binding rod portion 412 in order to disengage the binding rods from the latching portions of the plurality of opposed binding rods in the other side.

The outlines of the bearing portion 414, the first receiving portion 480, and the second receiving portion 490 are approximately the same and serve as the center of turning when the tips of the first binding rod 420 and the second binding rod 430 are caused to meet with each other and closed and when the tips of the first binding rod 420 and the second binding rod 430 are separated from each other. The bearing portion 414, the first receiving portion 480, and the second receiving portion 490 are configured so that the leaves 510 bound at the binding rod portion 412 can be flipped along the first binding rod 420 or the second binding rod 430 to be flipped through 360 degrees.

The pivot portion 416 has a length extending in the direction orthogonal to the extending direction of the first binding rod 420 and the second binding rod 430, has a thickness continued in the extending direction of the first binding rod 420 and the second binding rod 430, and has an outline which is continued in the longitudinal direction and partially arc-shaped. The pivot portion 416 is bridged between the plurality of first binding rods 420 and the second binding rods 430 so as to be provided to be continued to the base portions of the first binding rods 420 and the second binding rods 430 and provided to be continued to the plurality of first binding rods 420 and the second binding rods 430.

The pivot portion 416 has a first shaft portion 520 of the first binding device member 418A and a second shaft portion 530 of the second binding device member 418B, and the first shaft portion 520 and the second shaft portion 530 have a symmetric form of which center is the center of the length direction of the binding device 410.

The first shaft portion 520 and the second shaft portion 530 are continued from the far side to the near side, have a solid columnar shape extending linearly in the longitudinal direction, and are a substantially true circle in cross section. The first shaft portion 420 is integrally formed to be continued to the first binding rod 420, and the second shaft portion 530 is integrally formed to be continued to the second binding rod 430.

In the arc-shaped region, the first shaft portion 520 of the first binding device member 418A composing the pivot portion 416 is swingably fitted in the bearing recess 464 wherein the inner surface from the aperture portion 462 of the second bearing portion 460 of the second binding member 418B to the bearing portion 414 is arc shaped and extending in the longitudinal direction. In the arc-shaped region, the second shaft portion 530 of the second binding device member 418B is swingably fitted in the bearing recess 454 wherein the inner surface from the aperture portion 452 of the first bearing portion 450 of the first binding device member 418A to the bearing portion 414 is arc shaped and extending in the longitudinal direction.

The pivot portion 416 (the first shaft portion 520 and the second shaft portion 530) extends in the longitudinal direction of the bearing portion 414 (the first bearing portion 450 and the second bearing portion 460) and couples the first bearing portion 450 of the first binding device member 418A and the second bearing portion 460 of the second binding device member 418B of the left/right-separated pair to each other in the state in which they are linearly arranged in the length direction. The pivot portions 416 is configured to serve as the center of turning when the free end 420b of the first binding rod 420 and the free end 430b of the second binding rod 430 are caused to meet with each other and closed and when the free end 420b of the first binding rod 420 and the free end 430b of the second binding rod 430 are separated from each other so that the leaves 510 bound at the binding rod portion 412 can be flipped along the first binding rods 420 and the second binding rods 430 to be flipped through 360 degrees.

In the present embodiment, the first binding rods 420, the first bearing portions 450, the first receiving portion 480, and the first shaft portion 520 are formed in the first binding device member 418A; the second binding rods 430, the second bearing portions 460, the second receiving portion 490, and the second shaft portion 530 are formed in the second binding device member 418B; and the first binding device member 418A and the second binding device member 418B have a symmetric form of which center is the center of the longitudinal direction of the binding device 410.

The first bearing portion 450 of the first binding device member 418A is formed to be separated into a near-side first bearing portion 450a and an intermediate first bearing portion 450b, and the first receiving portion 480 of the first binding device member 418A is formed between the near-side first bearing portion 450a and the intermediate first bearing portion 450b.

The first shaft portion 520 is formed to be separated into a far-side first shaft portion 520a and an intermediate first shaft portion 520b. The far-side first shaft portion 520a is continuously formed from the intermediate first bearing portion 450b to the far side, and the intermediate first shaft portion 520b is continuously formed from the first receiving portion 480 to the near side.

The second bearing portion 460 of the second binding device member 418B is formed to be separated into a far-side second bearing portion 460a and an intermediate second shaft portion 460b, and the second receiving portion 490 of the second binding device member 418B is formed between the far-side second bearing portion 460a and the intermediate second bearing portion 460b.

The second shaft portion 530 of the second binding device member 418B is formed to be separated into a near-side second shaft portion 530a and an intermediate second shaft portion 530b. The near-side second shaft portion 530a is continuously formed from the intermediate second bearing portion 460b to the near side, and the second shaft portion 530b is continuously formed from the second receiving portion 490 to the far side.

In the present embodiment, the first binding device member 418A is composed of the binding rod portion 412 (the first binding rods 420), the bearing portion 414 (the first bearing portion 450), the pivot portion 416 (the first shaft portion 520), and the first receiving portion 480, which are integrally formed of synthetic resin. Similarly, the second binding device member 418B is composed of the binding rod portion 412 (the second binding rods 430), the bearing portion 414 (the second bearing portion 460), the pivot portion 416 (the second shaft portion 530), and the second receiving portion 490, which are integrally formed of synthetic resin.

The binding rod portion 412, the first bridge portions 442 of the first binding rods 420, the second bridge portions 444 of the second binding rods 430, and the pivot portion 416 are solid and are continuously and integrally formed. The binding rod portion 412, the first bridge portions 442 of the first binding rods 420, the second bridge portions 444 of the second binding rods 430, and the bearing portion 414 are solid and are continuously and integrally formed.

In the present embodiment, the far-side first shaft portion 520a of the first binding device member 418A and the intermediate first shaft portion 520b linearly extend in the longitudinal direction, have substantially cylindrical shapes having the same diameter, and are formed to be continued to and integral with the half rods 420A and the first bridge portions 442 composing the first binding device member 418A in the lower side of the half rods 420A and the first bridge portions 442; and the near-side second shaft portion 530a of the second binding device member 418B and the intermediate second shaft portion 530b linearly extend in the longitudinal direction, have substantially cylindrical shapes having the same diameter, and are formed to be continued to and integral with the half rods 430A and the second bridge portions 444 in the lower side of the half rods 430A and the second bridge portions 444.

The far-side first shaft portion 520a and the intermediate first shaft portion 520b of the first binding device member 418A have the shapes which are fitted in the bearing recesses 464 of the second bearing portions 460 of the second binding device member 418B. The near-side second shaft portion 530a and the intermediate second shaft portion 530b of the second binding device member 418B have the shapes which are fitted in the bearing recesses 454 of the first bearing portions 450 of the first binding device member 418A.

The first bearing portions 450 of the first binding device member 418A are linearly arranged in the longitudinal direction, wherein the longitudinally-extending cross sections of the aperture portion 452 of the near-side first bearing portion 450a and the aperture portion 452 of the intermediate first bearing portion 450b are mutually the same and linear.

The second bearing portions 460 of the second binding device member 418B are linearly arranged in the longitudinal direction, wherein the longitudinally-extending cross sections of the aperture portion 462 of the far-side second bearing portion 460a and the aperture portion 462 of the intermediate second bearing portion 460b are mutually the same and linear.

A far-side projecting portion 478 of the far-side first shaft portion 520a of the first binding device member 418A and a near-side projecting portion 478 of the first receiving portion 480 are linearly arranged in the longitudinal direction. A near-side projecting portion 476 of the near-side second shaft portion 530a of the second binding device member 418B and a far-side projecting portion 476 of the second receiving portion 490 are linearly arranged in the longitudinal direction.

The binding rod portion 412 includes binding rod latching portions for latching the first binding rod 420 of the first binding device member 418A and the second binding rod 430 of the second binding device member 418B when they are closed, wherein latching portions are formed respectively at the free end 420b and the free end 430b in the side opposite to the base portion 420a and the base portion 430a provided continuously to the bearing portions 414 and the pivot portions 416 of the first binding rod 420 of the first binding device member 418A and the second binding rod 430 of the second binding device member 418B, first receiving portions 480 of the first binding device member 418A and second receiving portions 490 of the second binding device member 418B,

In other words, the first binding rod 420 of the first binding device member 418A has the binding rod latching portion 422 of the first binding rod formed at the free end 420b as a top portion on the side opposite to the base portion 420a, and the second binding rod 430 of the second binding device member 418B has the binding rod latching portion 432 of the second binding rod formed at the free end 430b as a top portion on the side opposite to the base portion 430a.

The binding rod portion 412 includes a height direction (perpendicular direction) from the base portion 420a and the base portion 430a to the top portions and a width direction (horizontal direction) from an outer periphery portion (outer portion) of the first binding rod 420 to an outer periphery portion (outer portion) of the second binding rod 430. The binding rod portion 412 is of a cross-sectionally rectangular shape with a width of the first binding rod 420 and the second binding rod 430 in a longitudinal direction of the binding device, the width being longer than a thickness of the first binding rod 420 and the second binding rod 430 (a length between the outer periphery portions and inner periphery portions). Moreover, the first binding rod 420 and the second binding rod 430 are formed into a shape inserted through binding holes 512 of the leaf 510 from the base portion 420a and the base portion 430a to the top portions thereof so that the leaf 510 can be flipped.

The binding rod latching portion 422 of the first binding rod of the first binding device member 418A and the binding rod latching portion 432 of the second binding rod of the second binding device member 418B are formed in such a manner as to be latched upon closing with tips of the first binding rod 420 of the first binding device member 418A and the second binding rod 430 of the second binding device member 418B brought into contact with each other or disengaged upon separation of the tips of these first binding rod 420 of the first binding device member 418A and the second binding rod 430 of the second binding device member 418B from each other by relatively moving the first binding rod 420 of the first binding device member 418A and the second binding rod 430 of the second binding device member 418B, which are to be latched, in a direction crossing turning directions of the first binding rod 420 of the first binding device member 418A and the second binding rod 430 of the second binding device member 418B, in other words, a longitudinal direction of the pivot portion 416.

The first binding rod 420 of the first binding device member 418A is composed of a semicircular-arc half rod 420A in such a manner as to be a substantially annular binding rod when closed, the second binding rod 430 of the second binding device member 418B is composed of a semicircular-arc half rod 430A in such a manner as to be a substantially annular binding rod when closed, and the first binding rod 420 of the first binding device member 418A and the second binding rod 430 of the second binding device member 418B are so formed as to oppose each other.

Moreover, the binding rod latching portions 422 and 432 are formed at the tips of the half rod 420A and the half rod 430A, in other words, at the top portions of the first binding rod 420 and the second binding rod 430 in such a manner as to penetrate through the binding holes 512 previously punched in the leaves 510 to thereby bind the leaves 510.

The half rod 420A composing the first binding rod 420 and the half rod 430A composing the second binding rod 430 are coupled together into a substantially annular form by latching the binding rod latching portion 422 of the first binding rod of the half rod 420A and the binding rod latching portion 432 of the second binding rod of the half rod 430A.

The binding rod portion 412 includes a binding rod latching portion 422 of the first binding rod and a binding rod latching portion 432 of the second binding rod for latching the binding rods when closed, wherein the latching portions are formed respectively at the free end 420b and the free end 430b in the side opposite to a base portion 420a and a base portion 430a provided to be continuous to the first bridge portion 442 and the second bridge portion 444 of the binding rods and/or to the pivot portion 416. The binding rod latching portion 422 of the first binding rod and the binding rod latching portion 432 of the second binding rod are formed so as to relatively move the binding rods, which are to be latched in the direction intersecting with the turning direction of the latched binding rods, and latch or disengage them.

In the side opposite to the direction in which the first bridge portion 442 and the second bridge portion 444 serving as the coupling region, the bearing portion 414, and the pivot portion 416 are moved upon disengagement of the biding rods, the pressing portion 540 is provided on the binding rod and/or the coupling portion 414 and/or the pivot portion 416 to be projected toward the side opposite to the direction in which the bearing portion 414 and the pivot portion 416 are moved upon disengagement.

In the present embodiment, the pressing portions 540, which are formed in the near side of the half rod 420A of the first binding device member 418A and in the far side of the half rod 430A of the second binding device member 418B, are composed of a push rod, which is provided to project to the near side of the first binding rod 420 in the longitudinal direction of the first bearing portion 450 composing the coupling region, and a push rod, which is provided to project to the far side of the second binding rod 430 in the longitudinal direction of the second bearing portion 460 composing the coupling region.

The pressing portion 540 is formed into a columnar shape or a block-like shape in order to disengage the binding rod latching portion 422 of the first binding rod and the binding rod latching portion 432 of the second binding rod by displacing the first binding rod 420 or the second binding rod 430 in the extending direction of the center for opening/closing the binding rod portion 412 in the longitudinal direction of the bearing portion 414, the pivot portion 416, the first bridge portion 442, and the second bridge portion 444 composing the coupling region coupling the first binding device member 418A and the second binding device member 418B.

In the height direction which is the extending direction of the center for opening/closing the binding rod portion 412 in the longitudinal direction of the bearing portion 414, the pivot portion 416, the first bridge portion 442, and the second bridge portion 444 composing the coupling region coupling the first binding device member 418A and the second binding device member 418B, the pressing portion 540 is composed of a first pressing portion 542, which is provided to project from the lower end portion of the half rod 420A of the first binding device member 418A, and a second pressing portion 544, which is provided to project from the upper end portion of the half rod 430A of the second binding device member 418B.

The first pressing portion 542 is a cylindrical rod body extending from the lower end of the base portion 420a of the half rod 420A toward the side opposite to the direction of moving the bearing portion 414 and the pivot portion 416. when the binding rod latching portion 422 of the first binding rod of the first binding device member 418A is to be disengaged, in other words, toward the near side (lower side). The first pressing portion 542 is formed to have a size extending to the near side of the half rod 430A and is formed to have a large area for pressing.

The second pressing portion 544 is a cylindrical rod body extending from the upper end of the base portion 430a of the half rod 430A toward the side opposite to the direction of moving the bearing portion 414 and the pivot portion 416. when the binding rod latching portion 432 of the second binding rod of the second binding device member 418B is to be disengaged, in other words, toward the far side (upper side). The second pressing portion 544 is formed to have a size extending to the far side of the half rod 420A and is formed to have a large area for pressing.

As shown in FIG. 40, the binding rod latching portion 422 of the first binding rod and the binding rod latching portion 432 of the second binding rod disengage the binding rod latching portion 422 of the first binding rod and the binding rod latching portion 432 of the second binding rod, for example, by placing the thumb on the first pressing portion 542, placing the index finger on the second pressing portion 544, pressing the first pressing portion 542 toward the far side (upper side), and pressing the second pressing portion 544 toward the near side (lower side).

Then, as shown in FIG. 42, the first pressing portion 542 and the second pressing portion 544 are turned in the mutually opposite directions in the extending direction of the first binding rod 420 and the second binding rod 430, thereby opening the binding rod portion 412.

When the binding rod portion 412 is to be opened, the first binding rod 420 and the second binding rod 430 are configured so that the binding rod latching portion 422 of the first binding rod and the binding rod latching portion 432 of the second binding rod, which are latched, can be disengaged from each other by pushing the pressing portion 540 by finger.

A first binding rod projection 424 at a tip composing the binding rod latching portion 422 of the first binding rod formed at the tip of the half rod 420A composing the first binding rod 420 and a first binding rod recess 426 continuing to this first binding rod projection 424, and a second binding rod projection 434 at a tip composing the binding rod latching portion 432 of the second binding rod formed at the tip of the half rod 430A composing the second binding rod 430 and a second binding rod recess 436 continuing to the second binding rod projection 434 are formed to project or be recessed in opposite directions so that the first binding rod 420 and the second binding rod 430 engage with each other when closed.

Specifically, the first binding rod projection 424 composing the binding rod latching portion 422 of the first binding rod formed at the tip of the half rod 420A composing the first binding rod 420 projects to the near side. Moreover, the first binding rod recess 426 continuing to the first binding rod projection 424 is recessed to the far side. The second binding rod projection 434 composing the binding rod latching portion 432 of the second binding rod formed at the tip of the half rod 430A projects to the far side. Moreover, the second binding rod recess 436 continuing to this second binding rod projection 434 at the tip is recessed to the near side.

The first binding rod projection 424 and the first binding rod recess 426 and the second binding rod projection 434 and the second binding rod recess 436 are so formed as to project or be recessed in the opposite directions so that the first binding rod 420 and the second binding rod 430 engage with each other when closed.

The first binding rod projection 424 composing the binding rod latching portion 422 of the first binding rod of the half rod 420A and the binding rod projection 434 of the second binding rod composing the second binding rod latching portion 432 of the half rod 430A are so provided as to project in the opposite directions.

In addition, the first binding rod recess 426 composing the binding rod latching portion 422 of the first binding rod of the half rod 420A and the second binding rod recess 436 composing the binding rod latching portion 432 of the second binding rod of the half rod 430A are so formed as to be recessed in the opposite directions.

The binding rod latching portion 422 of the first binding rod and the binding rod latching portion 432 of the second binding rod have a disengagement preventing portion 428 and a disengagement preventing portion 438 so formed as to extend in the turning directions of the first binding rod 420 and the second binding rod 430 so that the binding rod latching portion 422 of the first binding rod and the binding rod latching portion 432 of the second binding rod do not disengage from each other in the turning directions of the first binding rod 420 and the second binding rod 430 and the direction crossing the turning directions.

The disengagement preventing portion 428 has: a hooked nose latching projection 428a projecting to the near side on a top portion side; and a latching recess 428b recessed to the far side on the base portion 420a side, and the latching recess 428b is formed on the base portion 420a side continuously from the latching projection 428a on a free end side.

The disengagement preventing portion 438 has: a hooked nose latching projection 438a projecting to the far side on a top portion side; and a latching recess 438b recessed to the near side on the base portion 430a side, and the latching recess 438b is formed on the base portion 430a side continuously from the latching projection 438a on a free end side.

When the first binding rod 420 and the second binding rod 430 are closed, the latching projection 428a of the disengagement preventing portion 428 is fitted into the latching recess 438b of the disengagement preventing portion 438, the latching projection 438a of the disengagement preventing portion 438 is fitted into the latching recess 428b of the disengagement preventing portion 428, and the latching projection 428a and the latching projection 438a hit each other when the first binding rod 420 and the second binding rod 430 are pulled in the turning directions.

The disengagement preventing portion 428 of the binding rod latching portion 422 of the first binding rod projects to an upper portion of the binding rod latching portion 432 of the second binding rod to prevent the second binding rod 430 from moving upwardly due to impact or the like when the binding rod latching portion 422 of the first binding rod and the binding rod latching portion 432 of the second binding rod engage with each other.

The disengagement preventing portion 438 of the binding rod latching portion 432 of the second binding rod projects to an upper portion of the binding rod latching portion 422 of the first binding rod to prevent the first binding rod 420 from moving upwardly due to impact or the like when the binding rod latching portion 422 of the first binding rod and the binding rod latching portion 432 of the second binding rod engage with each other.

As described above, in this embodiment, by pressing the first pressing portion 542, which is provided to project from the base portion 420a of the first binding rod 420, and the second pressing portion 544, which is provided to project from the base portion 430a of the second binding rod 430, with fingers, the first binding rod 420 of the first binding device member 418A can be moved to the far side and the second binding rod 430 of the second binding device member 418B can be moved to the near side to undo the engagement between the binding rod latching portion 422 of the first binding rod of the half rod 420A of the first binding rod 420 and the binding rod latching portion 432 of the second binding rod of the half rod 430A of the second binding rod 430.

Furthermore, the latching projection 428a of the disengagement preventing portion 428 and the latching projection 438a of the disengagement preventing portion 438 have inclined surfaces gently formed from the free ends in such a manner as to fit into the latching recess 438b and the latching recess 428b while hitting and sliding on them upon closing.

The first bridge portion 442 of the first binding device member 418A includes an opposing portion 442a of the first bridge portion 442 which is the region in which the first bridge portion 442 and the second bridge portion 444 of the second binding device member 418B are opposed to each other.

The second bridge portion 444 of the second binding device member 418B includes an opposing portion 444a of the second bridge portion 444 which is the region in which the first bridge portion 442 of the first binding device member 418A and the second bridge portion 444 are opposed to each other.

In the present embodiment, each of the first bridge portion 442 and the second bridge portion 444 has a substantially quadrangular prism shape.

The opposing portion 442a of the first bridge portion 442 of the first binding device member 418A and the opposing portion 444a of the second bridge portion 444 of the second biding device member 418B are the planes which are approximately orthogonal to the turning direction and extend vertically, in other words, in the height direction when the binding device 410 is closed. As shown in FIG. 31 and FIG. 39, the opposing portions are formed to be brought into close contact with each other when the binding device 410 is closed.

In a side surface of the bearing portion 414, a first aperture angle restricting portion 470 and a second aperture angle restricting portion 472 for restricting the aperture angle of the first binding rod 420 and the second binding rod 430 to an angle at which the leaf 510 can be easily inserted thereto, for example, to about 60 to 70 degrees are formed.

The first aperture angle restricting portion 470 is composed of a contact surface 452a of the aperture edge portion of the aperture portion 452 of the first bearing portion 450 of the first binding device member 418A and a contact surface 444b of the lower end of the second bridge portion 444 of the second binding device member 418B. On the other hand, the second aperture angle restricting portion 472 is composed of a contact surface 462a of the aperture edge portion of the aperture portion 462 of the second bearing portion 460 of the second binding device member 418B and a contact surface 442b of the lower end of the first bridge portion 442 of the first binding device member 418A.

As shown in FIG. 39, when the binding rod portion 412 is closed, the contact surface 452a of the first aperture angle restricting portion 470 of the first binding device member 418A and the contact surface 444b of the first aperture angle restricting portion 470 of the second binding device member 418B are inclined surfaces with an aperture of approximately 70 degrees and are opposed to each other. As shown in FIG. 42, when the binding rod portion 412 is opened, the contact surface 452a of the first aperture angle restricting portion 470 of the first binding device member 418A and the contact surface 444b of the first aperture angle restricting portion 470 of the second binding device member 418B are in contact with each other and restrict the aperture angle of the half rod 420A and the half rod 430A to an angle at which the leaf 510 can be easily inserted thereto.

As shown in FIG. 39, when the binding rod portion 412 is closed, the contact surface 462a of the second aperture angle restricting portion 472 of the second binding device member 418B and the contact surface 442b of the second aperture angle restricting portion 472 of the first binding device member 418A are inclined surfaces with an aperture of approximately 70 degrees and are opposed to each other. As shown in FIG. 42, when the binding rod portion 412 is opened, the contact surface 462a of the second aperture angle restricting portion 472 of the second binding device member 418B and the contact surface 442b of the second aperture angle restricting portion 472 of the first binding device member 418A are in contact with each other and restrict the aperture angle of the half rod 420A and the half rod 430A to an angle at which the leaf 510 can be easily inserted thereto.

Shaft-portion turning restricting portions 474, which prevents the closed first binding rod 420 and second binding rod 430 from opening, are formed at end portions of the pivot portion 416, the first receiving portion 480, and the second receiving portion 490.

The shaft-portion turning restricting portions 474 are composed of: the projecting portion 476 formed in the near side of the second shaft portion 530a in the near side of the second binding device member 418B, a restricting recess 456 formed by cut-out in the near side of the first bearing portion 450 of the first binding device member 418A, the projecting portion 478 formed in the far side of the first shaft portion 520a in the far side of the first binding device member 418A, and a restricting recess 466 formed by cut-out in the far side of the second bearing portion 460 of the second binding device member 418B. The projecting portion 476 of the second binding device member 418B, the restricting recess 456 of the first binding device member 418A, the projecting portion 478 of the first binding device member 418A, and the restricting recess 466 of the second binding device member 418B have the surfaces which are latched with the edges in the side opposite to the opening direction of the binding rod 412 when the binding rod portion 412 is closed.

The projecting portion 478 of the first binding device member 418A has a plane (extending in the length direction of the binding device 410) latched with the opposing portion of the restricting recess 466 of the second binding device member 418B. The opposing portion of the restricting recess 456 of the first binding device member 418A has a plane (extending in the length direction of the binding device 410) latched with the projecting portion 476 of the second binding device member 418B.

The projecting portion 476 of the second binding device member 418B has a plane (extending in the length direction of the binding device 410) latched with the opposing portion of the restricting recess 456 of the first binding device member 418A. The opposing portion of the restricting recess 466 of the second binding device member 418B has a plane (extending in the length direction of the binding device 410) latched with the projecting portion 478 of the first binding device member 418A.

Furthermore, the other projecting portions 476 are provided to project to have a width approximately the same as the width of the pivot portion 416 (the second shaft portion 530b) in the near side of the pivot portion 416 (the second shaft portion 530b) of the second binding device member 418B and in the far side of the second receiving portion 490 and have a length slightly shorter than that of the restricting recess 456 of the intermediate first bearing portion 450b. The other projecting portions 478 are provided to project to have a width approximately the same as the width of the pivot portion 416 (the first shaft portion 520b) in the far side of the pivot portion 416 (the first shaft portion 520b) of the first binding device member 418A and the near side of the first receiving portion 480 and have a length slightly shorter than that of the restricting recess 466 of the intermediate second bearing portion 460b.

When the binding rod portion 412 is closed, a gap is formed between the near side end of the projecting portion 478 of the first receiving portion 480 and the far side end of the intermediate second bearing portion 460b. When the binding rod portion 412 is closed, a gap is formed between the far side end of the projecting portion 476 of the second receiving portion 490 and the near side end of the intermediate first bearing portion 450b.

Thus, when the binding rod portion 412 is closed, the planes of the opposing portions of the projecting portion 478 and the restricting recess 456 of the first binding device member 418A and the planes of the opposing portions of the projecting portions 476 and the restricting recess 466 of the second binding device member 418B are brought into contact with each other; and, even when the force in the width direction that separates the first binding device member 418A and the second binding device member 418B from each other or the force that separates them in the radial direction of the binding rod portion 412 works, the half rod 420A of the first binding device member 418A and the half rod 430A of the second binding device member 418B are not separated from each other.

When the binding rod portion 412 is to be opened, the restricting recess 466 of the far-side second bearing portion 460a and the projecting portion 478 slide in the length direction, the restricting recess 456 of the near-side first bearing portion 450a and the projecting portion 476 slide in the length direction, the projecting portion 478 of the first receiving portion 480 and the restricting recess 466 of the intermediate second bearing portion 460b slide, and the projecting portion 476 of the second receiving portion 490 and the restricting recess 456 of the intermediate first bearing portion 450b slide. Thus, the first binding device member 418A and the second binding device member 418B can be relatively moved in the length direction of the binding device 410, and the first binding rod 420 and the second binding rod 430 can be opened in the width direction of the binding device 410.

As shown in FIG. 35, the first binding device member 418A and the second binding device member 418B are symmetrically formed. As shown in FIG. 36, the first binding device member 418A and the second binding device member 418B separated from each other are configured so that: the far side tip of the far-side second bearing portion 460a of the second binding device member 418B is positioned in the near side of the projecting portion 478 of the first binding device member 418A, the near side tip of the near-side first bearing portion 450a is positioned at the far side of the projecting portion 476 of the second binding device member 418B, the near-side second shaft portion 530a and the intermediate second shaft portion 530b of the second binding device member 418B are fitted in from the aperture portion 452 of the near-side first bearing portion 450a of the first binding device member 418A and the aperture portion 452 of the intermediate first bearing portion 450b, and the far-side first shaft portion 520a and the intermediate first shaft portion 520b of the first binding device member 418A are fitted in from the aperture portion 462 of the far-side second bearing portion 460a of the second binding device member 418B and the aperture portion 462 of the intermediate second bearing portion 460b, thereby coupling the first binding device member 418A and the second binding device member 418B to each other.

Also, the first binding device member 418A and the second binding device member 418B includes the bearing portion 414 slidably filled with the pivot portion 416 so that the half rod 420A and the half rod 430A can be relatively moved in the length direction of the binding device 410 when the first binding rod 420 and the second binding rod 430 are opened/closed.

The first binding device member 418A and the second binding device member 418B form the housing portion 482 between the first receiving portion 480 and the second receiving portion 490, which are opposed to each other, when the second shaft portion 530 of the second bearing device member 418B fits the first bearing portion 450 of the first binding device member 418A side and when the first shaft portion 520 of the first binding device member 418A fits the second bearing portion 460 of the second binding device member 418B side.

The housing portion 482 is filled with the elastic member 502, and the elastic member 502 strongly latch the half rod 420A of the first binding device member 418A and the half rod 430A of the second binding device member 418B by pushing the first receiving portion 480 to the near side and pushing the second receiving portion 490 to the far side.

When the first binding rods 420 and the second binding rods 430 are closed, on the axis line of the pivot portion 416, the near-side end face of the intermediate first bearing portion 450b of the first binding member 418A and the far-side end face of the second receiving portion 490 of the second binding device member 418B are brought into contact with each other, and the far-side end face of the intermediate bearing portion 460b of the second binding device member 418B and the near-side end face of the first receiving portion 480 of the first binding device member 418A are brought into contact with each other. In order to cause the first binding rod 420 and the second binding rod 430 to open at appropriate positions in the length direction when the first binding rods 420 and the second binding rods 430 are disengaged and opened, on the axis line of the pivot portion 416, the near-side end face of the intermediate first bearing portion 450b of the first binding device member 418A and the far-side end face of the second receiving portion 490 of the second binding device member 418B are brought into contact with each other, and the far-side end face of the intermediate second bearing portion 460b of the second binding device member 418B and the near-side end face of the first receiving portion 480 of the first binding device member 418A are brought into contact with each other.

When the first binding rods 420 and the second binding rods 430 are closed, alignment is carried out with appropriate intervals between the far-side edge of the intermediate first bearing portion 450b of the first binding device member 418A and the near-side edge of the far-side second bearing portion 460a of the second binding device member 418B, which are adjacent to each other, and between the near-side edge of the intermediate second bearing portion 460b of the second binding device member 418B and the far-side edge of the near-side first bearing portion 450a of the first binding device member 418A, which are adjacent to each other.

The appropriate intervals between the far-side edge of the intermediate first bearing portion 450b of the first binding device member 418A and the near-side edge of the far-side second bearing portion 460a of the second binding device member 418B, which are adjacent to each other, and between the near-side edge of the intermediate second bearing portion 460b of the second binding device member 418B and the far-side edge of the near-side first bearing portion 450a of the first binding device member 418A, which are adjacent to each other, (when the first binding rods 420 and the second binding rods 430 are closed) refer to the length necessary for relatively moving the first binding rods 420 and the second binding rods 430 in the length direction of the bearing portion 414, in other words, relatively moving the second binding rods 430 toward the near side and the first binding rods 420 toward the far side to disengage the binding rod latching portions 422 of the first binding rods and the binding rod latching portions 432 of the second binding rods.

Also, the alignment is carried out with appropriate intervals between the near-side edge of the intermediate first bearing portion 450b of the first binding device member 418A and the tip of the projecting portion 476 of the second receiving portion 490 of the second binding device member 418B, which are adjacent to each other, and between the far-side edge of the intermediate second bearing portion 460b of the second binding device member 418B and the tip of the projecting portion 478 of the first receiving portion 480 of the first binding device member 418A, which are adjacent to each other.

In the present embodiment, against the pressing force of the elastic member 502, the first binding rods 420 of the first binding device member 418A are moved to the far side, and the second binding rods 430 of the second binding device member 418B are moved to the near side, thereby opening the first binding rods 420 and the second binding rods 430, which have been closed.

In the present embodiment, the near side of the near-side first bearing portion 450a of the first binding device member 418A is blocked by the projecting portion 476 of the second binding device member 418B. The far side of the far-side second bearing portion 460a of the second binding device member 418B is blocked by the projecting portion 478 of the first binding device member 418A. Therefore, the far-side end of the far-side first shaft portion 520a is prevented from coming off from the far-side second bearing portion 460a by the far-side projecting portion 478, and the near-side end of the near-side second shaft portion 530a is prevented from coming off from the near-side first bearing portion 450a by the near-side projecting portion 476.

The width (in width direction) of the bearing portion 414, the first receiving portion 480, and the second receiving portion 490 is equal to or smaller than the total width (in width direction) of the first bridge portion 442 of the first binding device member 418A and the second bridge portion 444 of the second binding device member 418B. The width of the region of the shaft-portion turning restricting portion 474, in other words, the sum of the width of the opposing portion region of the near-side first bearing portion 450a and the width of the projecting portion 476, the sum of the width of the opposing region of the far-side second bearing portion 460a and the width of the projecting portion 478, is similar to or smaller than the total width of the width of the first bridge portion 442 and the width of the second bridge portion 444.

This is for the reason that, if the width of the bearing portion 414 and the shaft-portion turning restricting portion 474 is equal to or smaller than the total width of the width of the first bridge portion 442 and the width of the second bridge portion 444, the leaves 510 can be flipped over through 360 degrees, and the front surface and the reverse surface of the leaves 510 can be brought into contact with each other comparatively with a small interval with the pivot portion 416 and the shaft-portion turning restricting portion 474 sandwiched therebetween.

In a receiving portion 482 formed between the first receiving portion 480 of the first binding device member 418A and the second receiving portion 490 of the second binding device member 418B located in the vicinity of the center of the binding device 410, a elastic member 502 which applies tension in the longitudinal direction of the pivot portion 416 is fitted in a compressed state. The elastic member 502 is formed of a coil spring made by winding a steel wire into a coil form, and a spring member fixing projection 484, which is provided to project from the first receiving portion 480 to the receiving portion 482 side, and a spring member fixing projection 494, which is provided to project from the second receiving portion 490 to the receiving portion 482 side, are inserted into the loop of the tube-shaped coil spring.

Moreover, the elastic member 502 has a far-side end making contact with the near-side end of the second receiving portion 490 of the second binding device member 418B and has a near-side end making contact with a far-side end of the first receiving portion 480 of the first binding device member 418A. The elastic member 502 is so configured as to press down the first binding device member 418A to the near side and to press up the second binding device member 418B to the far side by (uniform) restoring force.

Thus, the elastic member 502 operates in the direction engaging the binding rod latching portion 422 of the first binding rod with the binding rod latching portion 432 of the second binding rod when the binding rod portion 412 is closed.

Upon detachment of the latched binding rod latching portion 422 of the first binding rod and binding rod latching portion 432 of the second binding rod from each other by pressing the first pressing portion 542 and the second pressing portion 544 by fingers, the first binding rod 420 of the first binding device member 418A is moved to the far side and the second binding rod 430 of the second binding device member 418B is moved to the near side against spring force of the elastic member 502, whereby the closed first binding rod 420 and second binding rod 430 are opened. Furthermore, the first binding rod 420 and the second binding rod 430 can be turned outwardly in the width direction (in other words, the first binding rod 420 can be turned to a left side (front side) and the second binding rod 430 can be turned to a right side (reverse side)) to easily bind or unbind the leaf 510.

The binding device 410 forms a datebook by binding the leaf 510 in such a manner that the binding holes 512 continuously provided at appropriate intervals in a height direction of the leaf 510 are penetrated by the first binding rods 420 and the second binding rods 430, the pivot portion 416 is situated on a side of a binding margin side edge 514 extending in the height direction of the leaf 510, and the first binding rods 420 and the second binding rods 430 bridge between the binding holes 512 and the binding margin side edge 514.

The binding device 410 may form a datebook by binding the leaf 510 in such a manner that a length direction of the binding device 410 extends in the width direction of the leaf 510 having the binding holes 512 formed at the edge extending in the width direction.

The leaf 510 bound by the binding device 410 can be used for writing or otherwise in such a manner that the leaf 110 is flipped over to the pivot portion 416 side and a leaf front side 510a and a leaf reverse side 510b are brought into contact with each other with the pivot portion 416 sandwiched therebetween when the leaves are laid during closing, as shown in FIG. 43.

According to the embodiment of the present invention, the binding rod portions 412 and the bearing portions 414 are formed at each of the first binding device member 418A and the second binding device member 418B in a pair, and the binding rods 420 and 430 composing the binding rod portions 412 are provided at the appropriate intervals in the longitudinal direction of the bearing portions 414 in such a manner as to project from the outer portion or the upper portion of the bearing portions 414 so that the first binding rods 420 on the first binding device member 418A side and the second binding rods 430 on the second binding device member 418B side face each other. Therefore, when the binding rod portions 412 are opened, lowest portions of the binding rod portions 412 are grounded on a surface of, for example, a desk top plate to be thereby easily horizontally stabilized, and also the binding rod portions 412 can be easily opened at an appropriate degree.

According to the embodiment of the present invention, the binding rod portion 412 includes the first binding rod 420 and the second binding rod 430 in the symmetrical form separated to the left and right with respect to the pivot portion 416 as the center, and the bearing portion 414 includes the first bearing portion 450 and the second bearing portion 460 in the symmetrical form separated to the left and right with respect to the pivot portion 416 as the center. Therefore, the left and right members can be formed with the same die, which makes it easy to manufacture them.

According to the embodiment of the present invention, the first bridge portion 442 and the second bridge portion 444 are planes orthogonal to the turning directions and extending perpendicularly, in other words, the height direction when the binding device 410 is closed. Forming the first bridge portion 442 and the second bridge portion 444 in such a manner as to bring them into close contact with each other when the binding device 410 is closed can stably maintain condition of the engagement between the binding rod latching portion 422 of the first binding rod and the binding rod latching portion 432 of the second binding rod when the binding device 410 is closed, which can reduce shrinking action of an annular diameter formed by the first binding rod 420 and the second binding rod 430 composing the binding rod portion 412.

According to the embodiment of the present invention, the far-side second bearing portion 460a, the intermediate first bearing portion 450b, the near-side first bearing portion 450a and the intermediate second bearing portion 460b are formed intermittently in the longitudinal direction of the pivot portion 416, and formed in such a manner that the binding rod portions 412 turn with respect to the pivot portion 416 as the center and relatively move in the longitudinal direction upon opening/closing of the binding rod portions 412. Therefore, the binding rod portion 412 composed of plural binding rods 420 and 430 can be opened and closed at once.

According to the embodiment of the present invention, the pivot portion 416 is of a approximately circular rod shape in cross section, the bearing portions 414 are arc-shaped as a whole, the pivot portion 416 is filled in the arc portions therein, and the bearing portions 414 are provided continuously in such a manner as to protrude in the directions opposite to the directions in which the binding rods 420 and 430 protrude. Therefore, the binding rod portions 412 composed of the plurality of binding rods 420 and 430 can be opened/closed at once, the lowest portions of the binding rod portions 412 are grounded on the surface of, for example, the desk top plate to be thereby easily horizontally stabilized, and the binding rod portions 412 can easily be opened at the appropriate degree.

According to the embodiment of the present invention, the base portions 420a and 430a of the binding rods 420 and 430 are formed with their lower portions located at the same positions as those of the lower portions of the bearing portions 414. Therefore, when the binding rod portions 412 are opened, the lowest portions of the binding rod portions 412 are grounded on the surface of, for example, the desk top plate to be thereby easily horizontally stabilized, and the binding rod portions 412 can easily be opened at the appropriate degree.

According to the embodiment of the present invention, the width of the bearing portion 414, the width of the first receiving portion 480 and the width of the second receiving portion 490 are equal to or smaller than total width of the width of the first bridge portion 442 and the width of the second bridge portion 444. Therefore, they does not extend beyond the width of the first bridge portion 442 and the width of the second bridge portion 444, and when the leaf 510 is flipped along the binding rods 420 and 430 and opened through 360 degrees, the space between the front side and the reverse side of the leaf 510 is small, thus providing relative flatness, which also makes writing easier.

According to the embodiment of the present invention, the binding rod latching portions 422 and 432, in order to be engaged or disengaged in the turning directions of the binding rods 420 and 430, are so configured as to engage the projection 424 and the recess 426 of the first binding rod 420 and the recess 436 and the projection 434 of the second binding rod 430, and the binding rod latching portions 422 and 432, in order not to be disengaged in the turning directions of the binding rods 420 and 430 and the direction crossing the turning directions when the binding rod portions 412 are closed, have the disengagement preventing portions 428 and 438 so formed as to extend in the direction crossing the turning directions of the binding rods 420 and 430. Therefore, the binding rod latching portions 422 and 432 of the closed binding rods are hard to be disengaged in the turning directions of the binding rods 420 and 430 and the direction crossing the turning directions.

The binding device 410 of the embodiment of the present invention can form a datebook bound with the binding rod portions 412 of the binding device 410 penetrated through the binding holes 512 of the leaf 510, and can form a file, a binder, or the like by being fixed on the cover including the front cover, the back cover, and a spine.

The present invention is not limited to the above described embodiments, and various modifications can be made based on the idea of the present invention.

The above described embodiments are composed with eight binding rods so as to bind the leaves 510 for 8 holes and 16 holes. However, the number of the binding rods may be changed so that the leaves with the less or more holes can be bound.

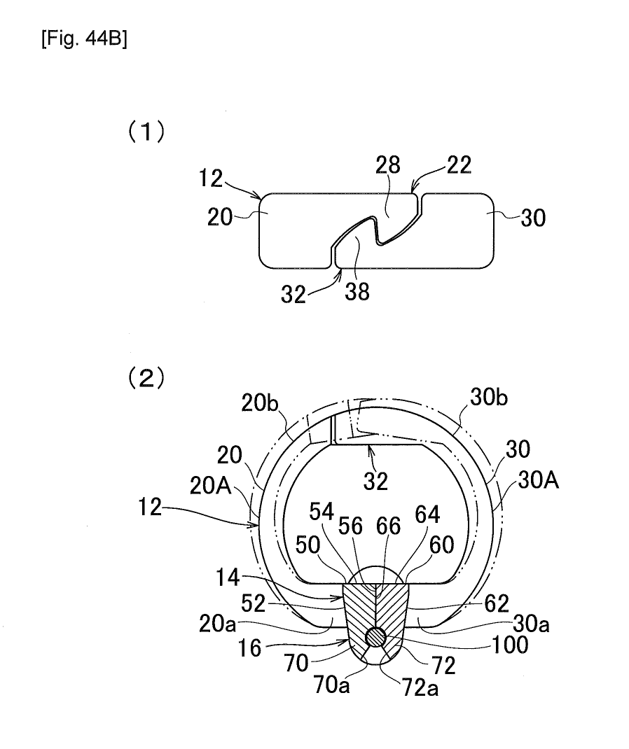

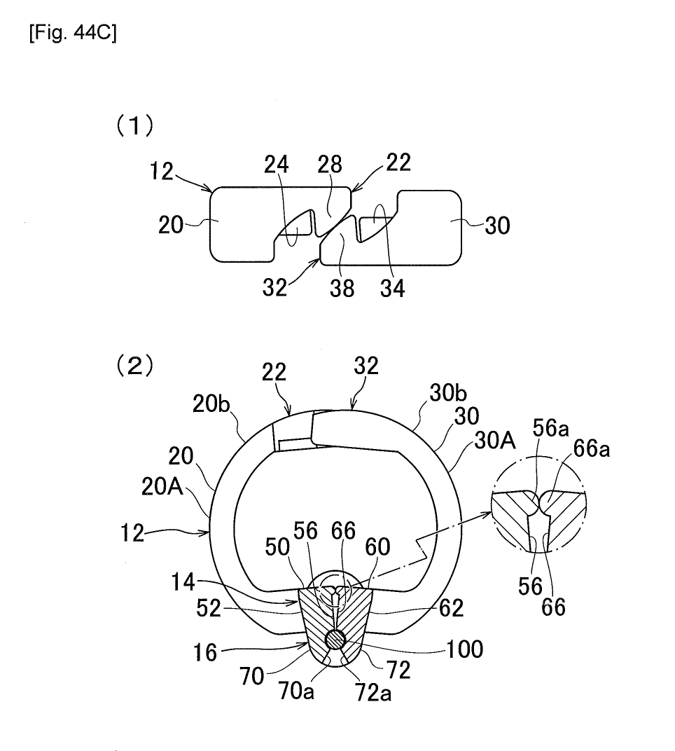

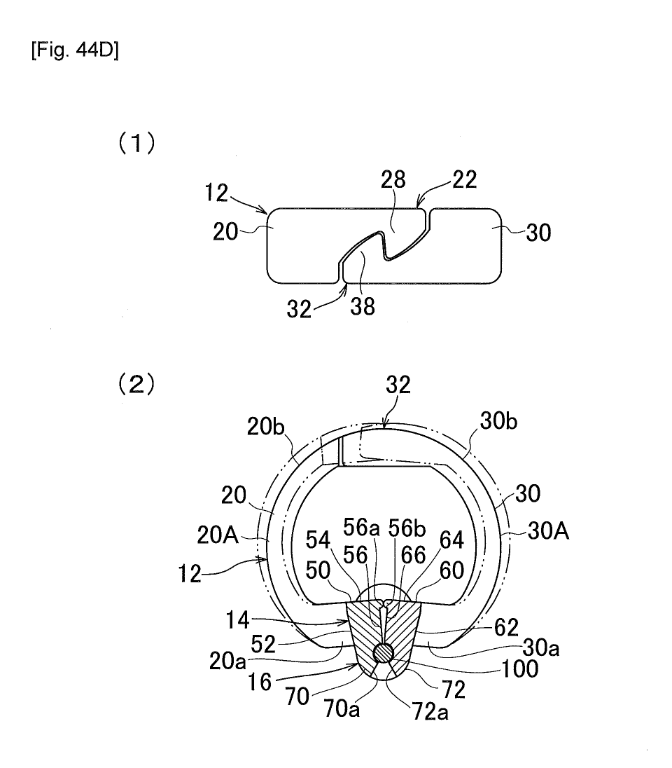

FIG. 44 shows a modification example of the binding device 10 which is the embodiment shown in FIG. 1.

As shown in FIG. 44A and FIG. 44B, the first connecting portion 50 and the second connecting portion 60 are configured to be brought into contact with each other with the opposing portion 56 and the opposing portion 66 when the binding rod portion 12 is closed, and the binding rod latching portion 22 of the first binding rod and the binding rod latching portion 32 of the second binding rod may be configured to be not closely engaged with each other when the opposing portions of the first connecting portion 50 and the second connecting portion 60 are brought into contact with each other.

The opposing portion 56 and the opposing portion 66 may be configured in a below manner.

As shown in FIG. 44C and FIG. 44D, a projection 56a for forming an interval from the opposing portion 66 of the second connecting portion 60 is formed on the surface of the opposing portion 56 of the first connecting portion 50, and a projection 66a for forming an interval from the opposing portion 56 of the first connecting portion 50 is formed on the surface of the opposing portion 66 of the second connecting portion 60.

The first binding rod 20 and the second binding rod 30 have elasticity and are configured so that the binding rod latching portion 22 of the first binding rod and the second-binding-rod binding rod latching portion 32 of the second binding rod 30 are engaged with each other by pressing in the width direction the first binding rod 20 and the second binding rod 30 which are separated from each other when the opposing portion 56 of the first connecting portion 50 and the opposing portion 66 of the second connecting portion 60 are brought into contact with each other when the binding rod portion 12 is closed.

Thus, if the binding rod latching portion 22 of the first binding rod and the binding rod latching portion 32 of the second binding rod are once latched, the latching portions are strongly engaged with each other with the restoring force of the first binding rod 20 and the second binding rod 30 that works to recover the no-load state of the first binding rod 20 and the second binding rod 30.

As the elastic member 102, a coil spring (shown in FIG. 6A) with only the coil portion 102a without the formation of the first fixing tip portion 102b and the second fixing tip portion 102c is mounted.

The pressing portion 140 is not required to be integrally formed with the base portion 20a of the first binding rod 20 and the base portion 30a of the second binding rod 30.

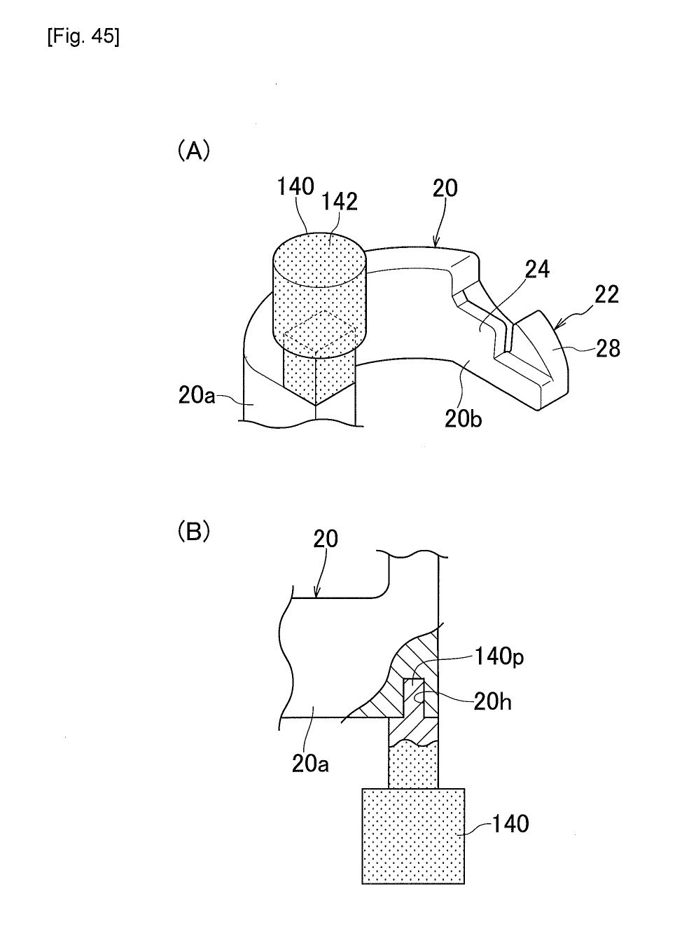

For example, as shown in FIG. 45, the pressing portion 140 may be configured in the manner that a fixing projection 140p provided to project from the end face of the pressing portion 140 that is in the side opposite to the pressing region fits in a fixing hole 20h of the pressing portion 140 formed in the base portion 20a of the first binding rod 20.

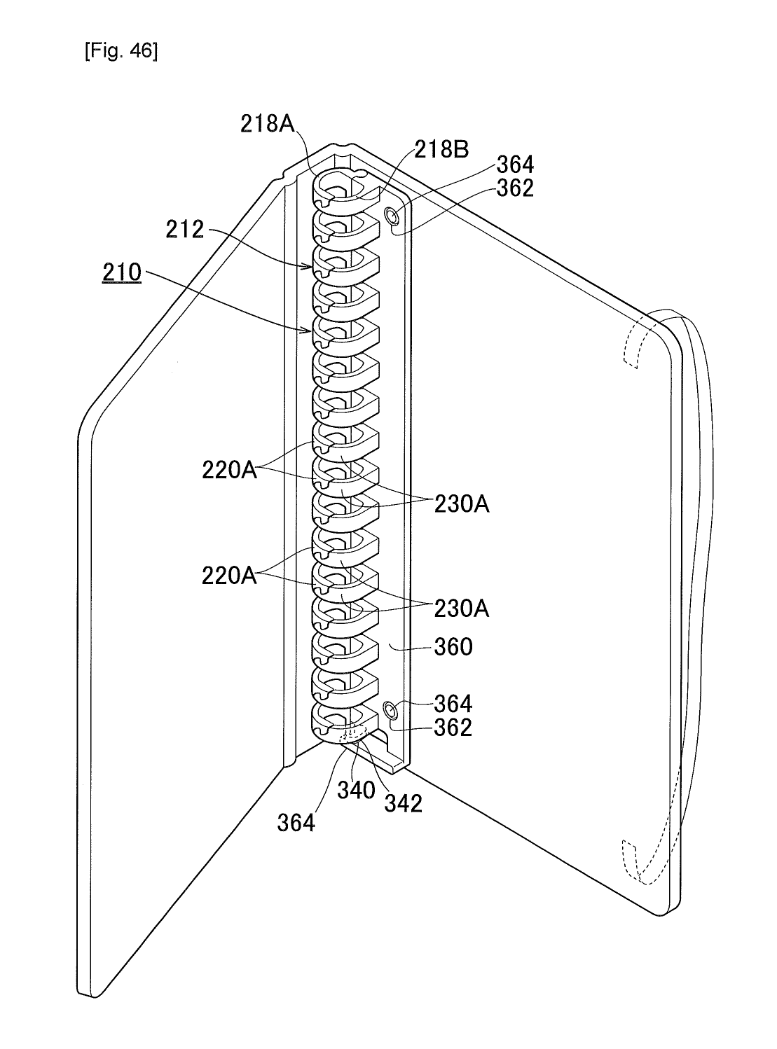

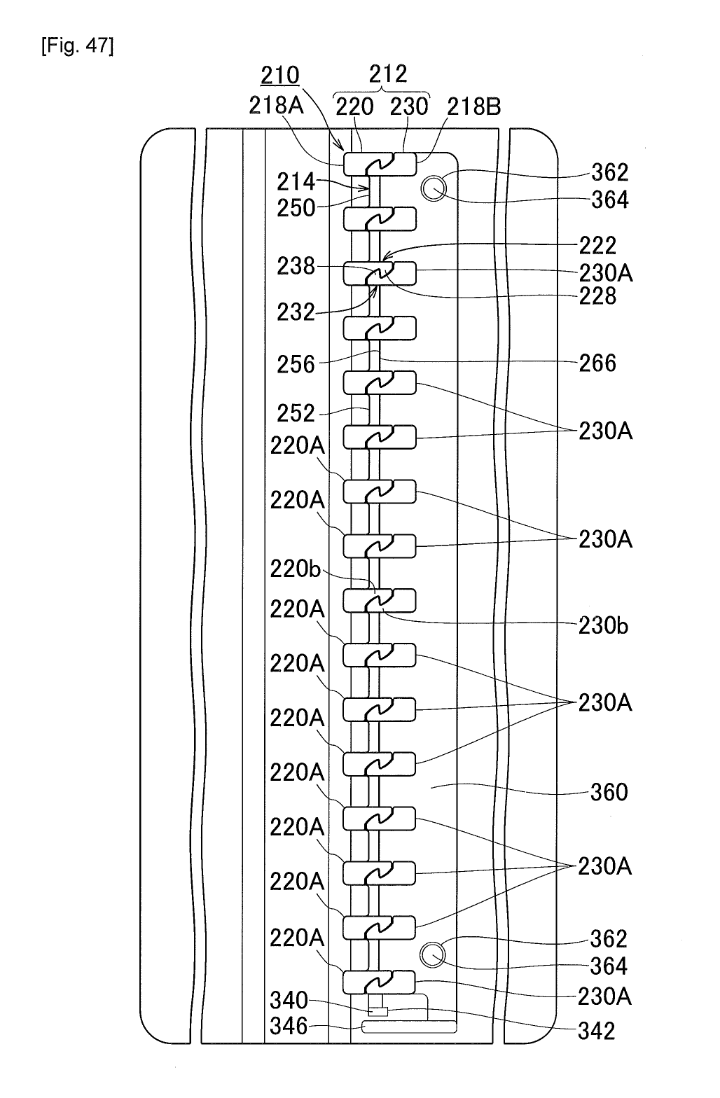

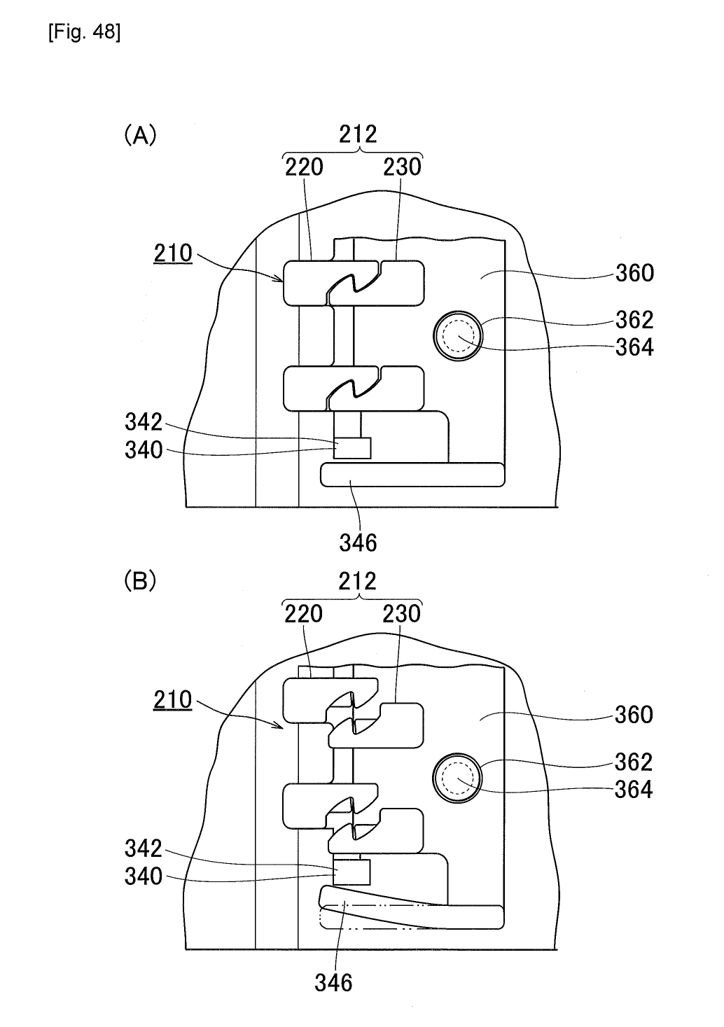

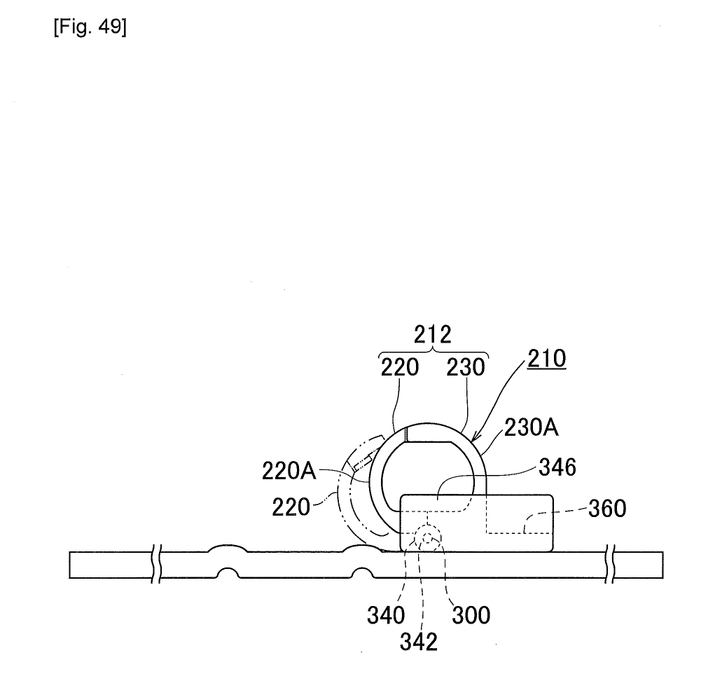

FIG. 46 is a schematic perspective view of a binding device which is a modification example of the binding device which is the embodiment shown in FIG. 21. FIG. 47 is a schematic plan view of the binding device which is the modification example of the binding device which is the embodiment shown in FIG. 21. FIG. 48 is a schematic plan view of the binding device which is the modification example of the binding device which is the embodiment shown in FIG. 21, wherein (A) is a view of the state in which the binding rods are closed, and (B) is a view of the state in which the binding rods starts opening. FIG. 49 is a schematic elevation view of the binding device which is the modification example of the embodiment shown in FIG. 21.

The binding device 210 includes a plurality of binding rod portions 212, a connecting portion 214 for connecting the binding rod portions 212, and an pivot coupling portion 216 having a shaft portion 300 serving as the center for opening/closing first binding rods 220 and second binding rods 230 composing the binding rod portions 212.

The binding rods composing the binding rod portions 212 are provided to project from upper portions of the connecting portion 214 with appropriate intervals in the longitudinal direction at a pair of first connecting portion 250 and a second connecting portion 260 composing the connecting portion 214 so that the first binding rod 220 and the second binding rod 230 of each pair face each other.

The connecting portion 214 has a lower portion at which an pivot coupling portion 216 is continuously provided at a position close to the base portions of the first binding rod 220 and the second binding rod 230.

The pivot coupling portion 216 includes a first receiving portion 280, a first housing portion 282, a second receiving portion 290, and a second housing portion 292, which are separated, and is configured so as to extend in the longitudinal direction of the connecting portion 214 and couple the pair of the first connecting portion 250 and the second connecting portion 260.

The base portions of the first binding rods 220 and the second binding rods 230 are formed so that the lower portions of the outer periphery portions of the first binding rods 220 and the second binding rods 230 are positioned at the same positions as the lower portions of the first connecting portion 250 and the second connecting portion 260. The first receiving portion 280 and the second receiving portion 290 composing the pivot coupling portion 216 are foamed so that the upper portions thereof are positioned at the same positions as the lower portions of the first connecting portion 250 and the second connecting portion 260.

An attachment portion 360 for attaching the binding device 210 to the inner surface of the cover of a datebook is continuously provided in a side portion of the second binding rods 230, the second connecting portions 260, and the second receiving portion 290 composing the second binding device member 218B.

The binding device 210 is fixed to the cover of a datebook with rivets or grommets 364 penetrating through through holes 362 penetrating through the attachment portion 360. The attachment portion 360 has a rectangular shape having a length direction from the near side to the far side of the second binding device member 218B, and the reverse surface thereof is formed to be a flat surface so that the reverse surface thereof can be attached to the cover.

The pressing portion 340 is configured to be directly pressed with fingers in the above described embodiments. However, the pressing portion 340 may be configured to be indirectly pressed in the below manner.

At the second binding rod 230 of the binding device 210 shown in FIG. 21, the pressing portion 340 for displacing the first binding rod 220 or the second binding rod 230 in the longitudinal direction of the coupling portion 214 to disengage the binding rod latching portion 222 of the first binding rod and the binding rod latching portion 232 of the second binding rod is formed. In other words, the pressing portion 340 is composed of the pressing portion 340 provided to project from the lower end portion below the second coupling portion 260.

The pressing portion 340 is a cylindrical rod body extending from the lower end portion of the lower side of the second coupling portion 260 toward the side opposite to the direction of disengaging the binding rod latching portion 232 of the second binding rod, in other words, toward the near side (lower side), and the pressing portion is formed on the surface in the side opposite to the direction of opening the second binding rods 230 in the vicinity of the base portion 230a of the second binding rod 230.

An operating portion 346 is formed at the attachment portion 360 with an appropriate interval from the tip of the first pressing portion 342.

The operating portion 346 is composed of a plate-like body having flexibility which is provided to project from an upper portion of the attachment portion 360 toward the extending direction of the binding rod portion 212, and the operating portion is configured to be warped when pressed toward the first pressing portion 342 side with finger.

Thus, the operating portion 346 enables detachment of the binding rod latching portions 222 of the first binding rods from the binding rod latching portions 232 of the second binding rods when the surface in the opposite side of the surface opposed to the first pressing portion 342, in other words, a back-to-back surface is pressed toward the first pressing portion 342.

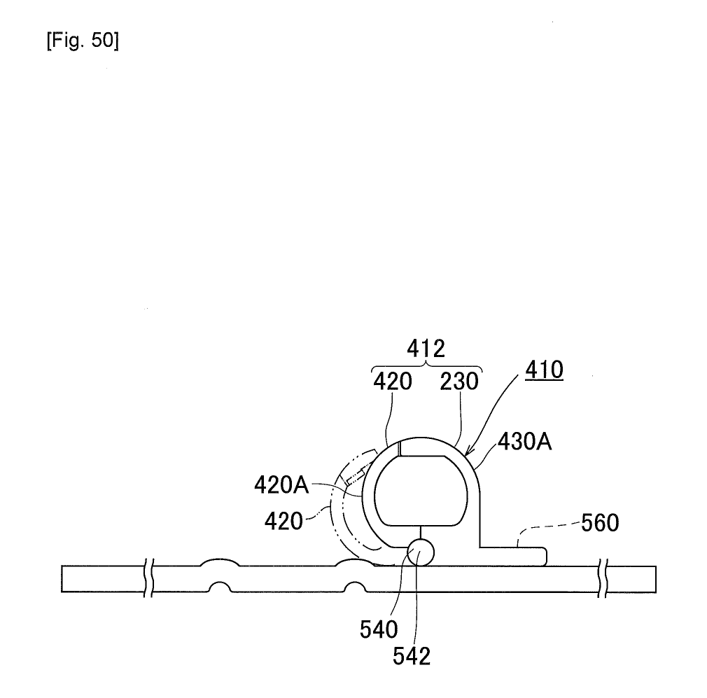

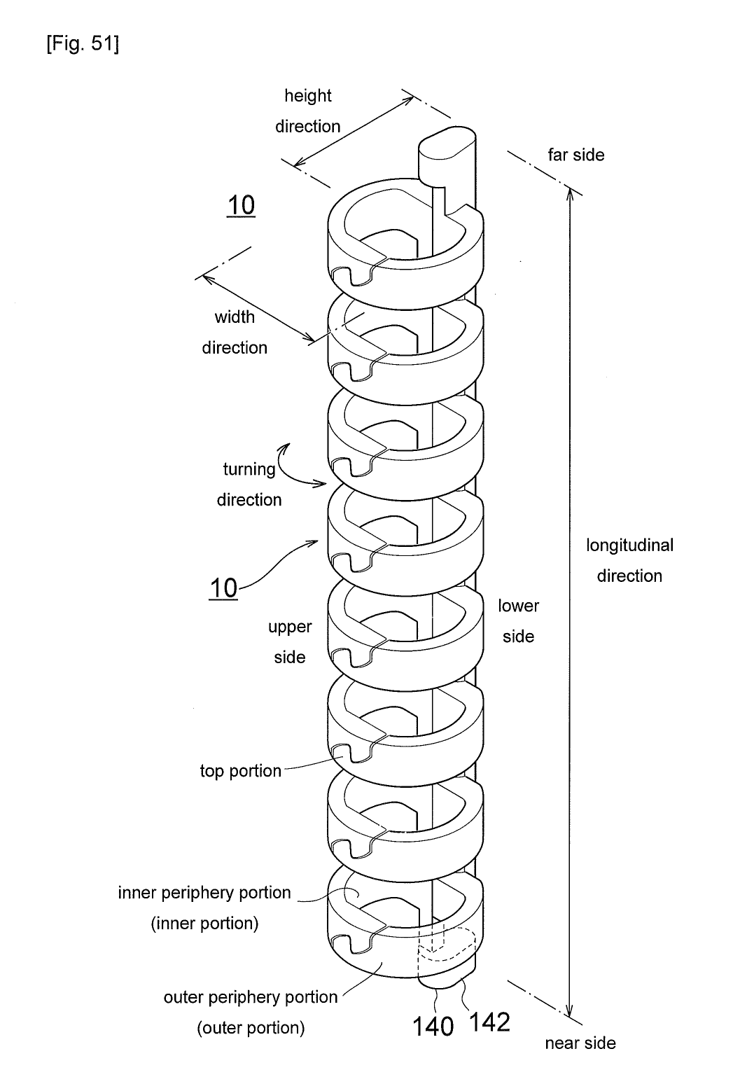

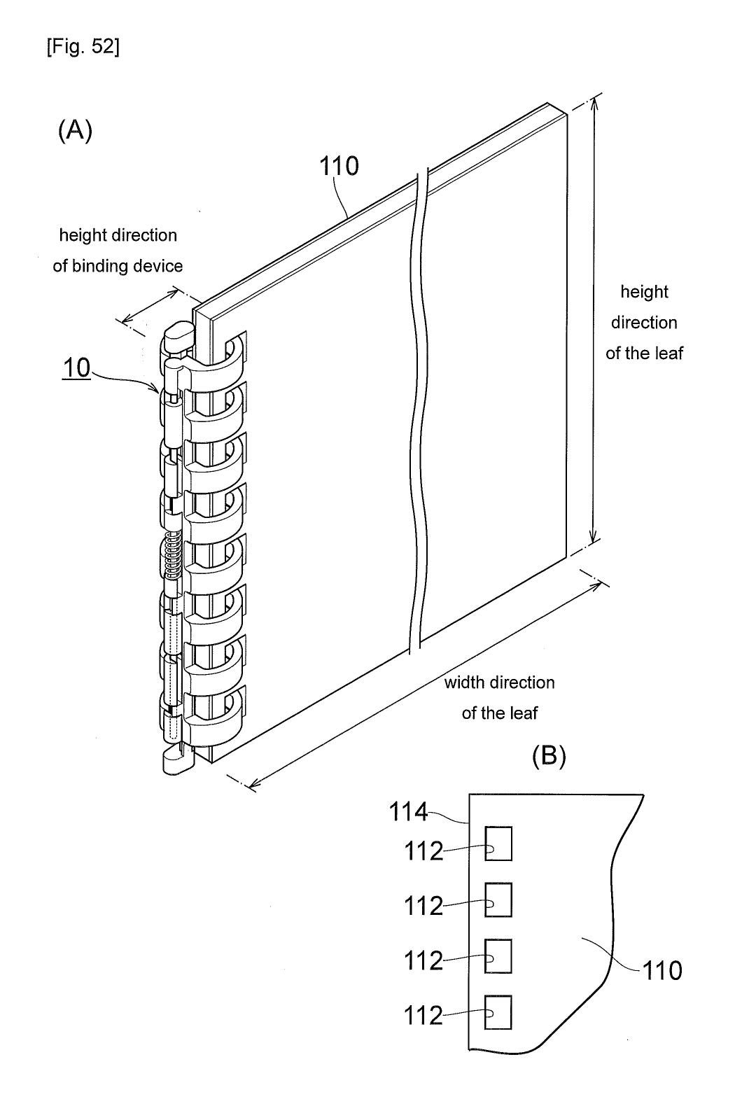

As shown in FIG. 50, the attachment portion 560 may be configured so that the operating portion for pressing the pressing portion of the 540 of the binding device 410 is not formed. In the example shown in FIG. 50, the attachment portion 560 is provided to be continued to the bearing portion 414 of the second binding device member 418B.

In the binding device 410 shown in FIG. 30, the number of the binding rods may be reduced in order to cause the first binding rods 420 and the second binding rods 430 to be easily warped to facilitate relative movement.

### INDUSTRIAL APPLICABILITY

The binding devices according to the present invention can be used by fixing the binding device to the inner side of a back cover region of a datebook, a cover composing a file, binder, or the like, or the device may be independently used.

1. A binding device comprising: a plurality of binding rod portions, a connecting region for connecting the plurality of binding rod portions, and an pivot coupling region serving as the center for opening/closing of binding rods composing the binding rod portions; wherein
the binding rods composing the binding rod portions are provided to project from the pair of connecting regions with an appropriate interval therebetween in a longitudinal direction thereof so that the binding rods of each pair are opposed to each other;
a pressing portion(s) is provided to project from the region(s) of one end or both ends of the extending direction of the center for opening/closing the binding rods; and
the pressing portion is configured to displace the plurality of opposed binding rods of one side among the binding rods to the extending direction of the center in order to disengage the binding rods of the one side from latching portions of the plurality of opposing binding rods of another side.

2. The binding device according to claim 1, wherein
the pressing portion is composed of:
a push rod provided to project from
a first binding rod and/or a second binding rod;
a first connecting portion and/or a second connecting portion;
a first bridge portion and/or a second bridge portion; or
a region of an end portion of the pivot coupling region, the end portion being an end with respect to the center extending direction.

3. The binding device according to claim 1, wherein
the binding rod portion has the binding rod latching portion for latching when the binding rods are closed, the binding rod latching portion being formed at a free end of the binding rod in a side opposite to a base portion provided continuously to the connecting region and/or the pivot coupling region;
the binding rod latching portions are formed so as to relatively move the binding rods, which are to be latched in a direction intersecting with a turning direction of the binding rods to be latched, and latch or disengage the binding rods; and
the pressing portion(s) are provided to project from the binding rod and/or the connecting region and/or the pivot coupling region toward a side opposite to the direction of disengagement in the side opposite to the direction of relatively moving the binding rods and disengaging the binding rods.

4. The binding device according to claim 1, wherein the pressing portion is configured to be pressed directly or indirectly with finger.

5. The binding device according to claim 1, wherein
the pivot coupling region has
a shaft portion and a receiving portion of the shaft portion;
the shaft portion extends in the longitudinal direction of the connecting region and couple the pair of connecting regions;
the receiving portion extends in the longitudinal direction of the connecting region, is provided continuously to the binding rod portion and/or the connecting region, and has an aperture portion to be filled with the shaft portion, the aperture portion being formed in a side surface of the receiving portion; and
the pressing portion(s)
is provided to project from the region(s) of one end or both ends of the extending direction of the pivot coupling region.

6. The binding device according to claim 1, wherein
the connecting region is composed of the pivot coupling region and a bridge portion;
the pivot coupling region includes a bearing portion coupling the binding rod portions and includes an pivot portion coupling the binding rod portions and serving as the center for opening/closing the binding rods composing the binding rod portion;
the binding rods composing the binding rod portion project from outer portions or upper portions of the bearing portions and the pivot portions with appropriate intervals in the longitudinal direction of the bearing portions coupling the binding rod portions and the pivot portion so that the binding rods of each pair face each other;
the bearing portion has a length extending in the direction orthogonal to the extending direction of the binding rod and a thickness continued in the extending direction of the binding rod, is bridged between the plurality of binding rods so as to be continued to the base portions of the binding rods and couple the plurality of binding rods, includes a side surface in which an aperture portion to be filled with the pivot portion is formed, and includes a bearing recess continued to the aperture portion and having an arc-shaped inner surface;
the pivot portion has a length extending in the direction orthogonal to the extending direction of the binding rod and a thickness continued in the extending direction of the binding rod, has a longitudinally-continued outline which is partially arc-shaped, is bridged between the plurality of biding rods so as to be continued to the base portions of the binding rods and continued to the plurality of binding rods, and, in a region of the arc shape, swingably fits in a longitudinally-extending bearing recess of which inner surface from the aperture portion to the bearing portion is arc shaped;
the pivot coupling region is configured to serve as the center of turning when tips of the binding rods are caused to meet with each other and closed and when the tips of the binding rods are separated from each other; and
the pressing portion(s) is provided to project from the region(s) of one end or both ends of the extending direction of the pivot coupling region.

7. The binding device according to claim 5, wherein a elastic member that applies tensile force or compressive force in the longitudinal direction of the shaft portion is fitted
between a housing portion of the first receiving portion and the receiving portion of a second receiving portion and/or between the housing portion of the second receiving portion and the receiving portion of the first receiving portion.

8. The binding device according to claim 6, wherein
a elastic member that is compressed in and applies spring force in the longitudinal direction of the pivot coupling region is fitted
between the housing portion of a first receiving portion provided to be continued to the base portion of the binding rod portion and a housing portion of a second receiving portion provided to be continued to the base portion of the binding rod portion; and
the first receiving portion, the second receiving portion, and the elastic member are configured so as to serve as the center of turning when tips of the binding rods are caused to meet with each other and closed and when the tips of the binding rods are separated from each other.

9. The binding device according to claim 7, wherein
the elastic member is composed of a torsion coil spring and includes a coil portion, a linear first fixing tip portion, and a linear second fixing tip portion, the tip portions continuously provided to extend from both ends of the coil portion to a direction orthogonal to or intersecting with a central axis of the coil portion, the first fixing tip portion and the second fixing tip portion project to outside of the coil portion in an original state free from torsion moment;
the first fixing tip portion of one side is supported by a support portion of the first connecting portion;
the second fixing tip portion of another side is supported by a support portion of the second connecting portion so as to face the first fixing tip portion; and,
when the binding rod latching portion of the first binding rod and the binding rod latching portion of the second binding rod latched with each other are to be disengaged from each other by pressing the pressing portion with finger, the first fixing tip portion is supported by the support portion of the first connecting portion in the side opposite to a moving direction, and the second fixing tip portion of the other side is supported by the support portion of the second connecting portion in the side opposite to the moving direction.

10. The binding device according to claim 1, wherein
the elastic member fits in the connecting region for connecting the plurality of binding rod portions; and
the elastic member includes a coil portion.

11. The binding device according to claim 1, wherein an attachment portion for attachment to a cover is provided to be continued to the binding rod and/or the connecting region and/or the receiving portion and/or the bearing portion.

12. The binding device according to claim 2, wherein
the binding rod portion has the binding rod latching portion for latching when the binding rods are closed, the binding rod latching portion being formed at a free end of the binding rod in a side opposite to a base portion provided continuously to the connecting region and/or the pivot coupling region;
the binding rod latching portions are formed so as to relatively move the binding rods, which are to be latched in a direction intersecting with a turning direction of the binding rods to be latched, and latch or disengage the binding rods; and
the pressing portion(s) are provided to project from the binding rod and/or the connecting region and/or the pivot coupling region toward a side opposite to the direction of disengagement in the side opposite to the direction of relatively moving the binding rods and disengaging the binding rods.

13. The binding device according to claim 2, wherein the pressing portion is configured to be pressed directly or indirectly with finger.

14. The binding device according to claim 3, wherein the pressing portion is configured to be pressed directly or indirectly with finger.

15. The binding device according to claim 12, wherein the pressing portion is configured to be pressed directly or indirectly with finger.

16. The binding device according to claim 2, wherein
the pivot coupling region has
a shaft portion and a receiving portion of the shaft portion;
the shaft portion extends in the longitudinal direction of the connecting region and couple the pair of connecting regions;
the receiving portion extends in the longitudinal direction of the connecting region, is provided continuously to the binding rod portion and/or the connecting region, and has an aperture portion to be filled with the shaft portion, the aperture portion being formed in a side surface of the receiving portion; and
the pressing portion(s)
is provided to project from the region(s) of one end or both ends of the extending direction of the pivot coupling region.

17. The binding device according to claim 3, wherein
the pivot coupling region has
a shaft portion and a receiving portion of the shaft portion;
the shaft portion extends in the longitudinal direction of the connecting region and couple the pair of connecting regions;
the receiving portion extends in the longitudinal direction of the connecting region, is provided continuously to the binding rod portion and/or the connecting region, and has an aperture portion to be filled with the shaft portion, the aperture portion being formed in a side surface of the receiving portion; and
the pressing portion(s)
is provided to project from the region(s) of one end or both ends of the extending direction of the pivot coupling region.

18. The binding device according to claim 12, wherein
the pivot coupling region has
a shaft portion and a receiving portion of the shaft portion;
the shaft portion extends in the longitudinal direction of the connecting region and couple the pair of connecting regions;
the receiving portion extends in the longitudinal direction of the connecting region, is provided continuously to the binding rod portion and/or the connecting region, and has an aperture portion to be filled with the shaft portion, the aperture portion being formed in a side surface of the receiving portion; and
the pressing portion(s)
is provided to project from the region(s) of one end or both ends of the extending direction of the pivot coupling region.

19. The binding device according to claim 4, wherein
the pivot coupling region has
a shaft portion and a receiving portion of the shaft portion;
the shaft portion extends in the longitudinal direction of the connecting region and couple the pair of connecting regions;
the receiving portion extends in the longitudinal direction of the connecting region, is provided continuously to the binding rod portion and/or the connecting region, and has an aperture portion to be filled with the shaft portion, the aperture portion being formed in a side surface of the receiving portion; and
the pressing portion(s)
is provided to project from the region(s) of one end or both ends of the extending direction of the pivot coupling region.

20. The binding device according to claim 13, wherein
the pivot coupling region has
a shaft portion and a receiving portion of the shaft portion;
the shaft portion extends in the longitudinal direction of the connecting region and couple the pair of connecting regions;
the receiving portion extends in the longitudinal direction of the connecting region, is provided continuously to the binding rod portion and/or the connecting region, and has an aperture portion to be filled with the shaft portion, the aperture portion being formed in a side surface of the receiving portion; and
the pressing portion(s)
is provided to project from the region(s) of one end or both ends of the extending direction of the pivot coupling region.
